(19) United States
(12) Patent Application Publication
(10) Pub. No.: US 2022/0049546 A1
(43) Pub. Date: Feb. 17, 2022

(54) ILLUMINATED ROLLER SHADE AND DRAPERY MOUNTING SYSTEM

(71) Applicant: James Daugaard, Port St. Lucie, FL (US)

(72) Inventor: James Daugaard, Port St. Lucie, FL (US)

(21) Appl. No.: 17/274,477

(22) PCT Filed: Sep. 10, 2019
(86) PCT No.: PCT/US19/50319

§ 371 Date: Mar. 9, 2021

Related U.S. Application Data
(63) Continuation-in-part of application No. 16/241,702, filed on Jan. 7, 2019, now abandoned.
(60) Provisional application No. 62/852,431, filed on May 24, 2019.
(60) Provisional application No. 62/824,384, filed on Mar. 27, 2019.
(60) Provisional application No. 62/729,688, filed on Sep. 11, 2018.

(51) Int. Cl. E06B 9/42; A47H 1/06; A47H 1/13; A47H 13/04; A47H 15/02; A47H 23/00

(52) U.S. Cl. CPC E06B 9/42; A47H 1/06; A47H 1/13; E06B 2009/247; A47H 15/02; A47H 23/00; A47H 2023/006; A47H 13/04

(57) ABSTRACT

A window shade system is presented that combines the benefits of roller shades with draperies. In one arrangement a fascia having a front plate and a bottom plate includes a track positioned in the forward lower end of the fascia. The fascia is configured to be attached to a plurality of brackets. One or more roller shades having roller shade material attached to a tube are connected to the brackets. A plurality of carriers are positioned in the track and one or more draperies are attached to the plurality of carriers in the track. This arrangement presents a dual functioning window shade wherein roller shade material may be opened and closed by raising and lowering the roller shade material by rotating the tube of the roller shades raised, and the drapery shade material may be opened and closed by sliding the drapery shade material along the length of the track.

### CROSS REFEENCE TO RELATED PATENT APPLICATIONS

This application is a 371 of international application no. PCT/US2019/050319 which was filed on Sep. 9, 2019, which claims priority to U.S. Provisional Patent Application 62/852,431 filed on May 24, 2019, which also claims priority to U.S. Provisional Patent Application 62/824,384 filed on Mar. 27, 2019, the entirety of all are hereby incorporated by reference.

This application is also a continuation in part of U.S. Utility patent application Ser. No. 16/241,702 filed on Jan. 8, 2019, which claims priority to U.S. Provisional Patent Application No. 62/729,688 filed on Sep. 11, 2018, the entirety of all are hereby incorporated by reference.

### FIELD OF THE DISCLOSURE

This disclosure relates generally to window shades. More specifically, and without limitation, this disclosure relates to window shades having multiple shade materials.

### BACKGROUND OF THE DISCLOSURE

Countless forms of window shades exist in the prior art. Two common types of window shades, that are of particular interest to this disclosure, include roller shades and draperies.

Roller Shades:

Roller shades are commonly known in the art. Conventional roller shades often include a tube (or rod) that is generally cylindrical in shape. A panel of shade material is connected at its upper end to the tube and includes a weighted bottom bar at the lower end of the shade material. The shade material is wrapped around the tube. An axle extends outward from each end of the tube. These axles are held by a bracket that is connected to a structure, such as a wall or ceiling often adjacent to a window. As the tube rotates in a first direction, an unwinding direction, the shade material is unwound from around the tube thereby lowering the shade material and bottom bar. As the tube rotates in a second direction, a winding direction, the shade material is wound-up around the tube thereby raising the shade material and bottom bar. In this way, the shade material moves between a fully closed (or fully lowered) position and a fully open (or fully raised) position.

Roller shades are aesthetically pleasing and provide many benefits. However, roller shades suffer from many disadvantages. That is, when using a single roller shade as a window covering the shade material must be carefully selected. That is the opacity/transparency, or how much light the shade material allows to pass through the shade material, must be carefully considered.

If the shade material is too transparent, the shade material will let too much light into the room during the day thereby reducing or eliminating the roller shade's ability to reduce light and glare inside the building. In addition, if the shade material is too transparent, it will also allow people to see into the building through the shade material at night when it is dark outside but lights are on inside the building.

In contrast, if the shade material is too opaque, the shade material will block too much light into the room during the day thereby making the inside of the building too dark and eliminating too much desirable natural light. In addition, if the shade material is too opaque, it will not allow people inside of the building to adequately see through the shade material to see what is outside, which is less than desirable.

In view of these limitations, when using a single roller shade to cover a window, users are often forced to select a shade material that works sub optimally in all situations. That is, on one hand, if they select a black-out material, or a highly opaque material, the shade material would be too dark and/or opaque at times, it would not let enough light into the building at times, and it would not allow people inside the building to adequately see outside through the shade material. On the other hand, if they select a sheer material, or a highly transparent material, the shade material would be too transparent at times, it would let too much light into the building at times, and it would allow people outside the building at night to see into the building through the sheer material when the lights are on.

To split the difference between, users often select a shade material with an opacity somewhere in-between these two extremes, meaning that the roller shade does not block enough light at times, blocks too much light at times, is too transparent at times and is not transparent enough at times.

As such, using a single roller shade with a single panel of shade material provides a sub-optimal window shade.

Draperies:

Draperies are commonly known in the art. Conventional draperies often include a track (or rail) that receives and guides a carrier of some form. A panel of shade material is connected at its upper end to the carriers which hangs vertically down from the track and carriers. The shade material is opened and closed by sliding the shade material along the lateral length of the track. In this way, the shade material moves between a fully closed (or fully deployed) position and a fully open (or fully retracted) position.

Draperies are aesthetically pleasing and provide many benefits. However, like roller shades, draperies suffer from many disadvantages. That is, when using a drapery as a window covering the shade material must be carefully selected. That is the opacity/transparency, or how much light the shade material allows to pass through the shade material, must be carefully considered.

If the shade material is too transparent, the shade material will let too much light into the room during the day thereby reducing or eliminating the drapery's ability to reduce light and glare inside the building. In addition, if the shade material is too transparent, it will also allow people to see into the building through the shade material at night when it is dark outside but lights are on inside the building.

In contrast, if the shade material is too opaque, the shade material will block too much light into the room during the day thereby making the inside of the building too dark and eliminating too much desirable natural light. In addition, if the shade material is too opaque, it will not allow people inside of the building to adequately see through the shade material to see what is outside, which is less than desirable.

In view of these limitations, when using a single drapery to cover a window, users are often forced to select a shade material that works sub optimally in all situations. That is, on one hand, if they select a black-out material, or a highly opaque material, the shade material would be too dark and/or opaque at times, it would not let enough light into the building at times, and it would not allow people inside the building to adequately see outside through the shade material. On the other hand, if they select a sheer material, or a highly transparent material, the shade material would be too transparent at times, it would let too much light into the building at times, and it would allow people outside the building at night to see into the building through the sheer material when the lights are on.

To split the difference between, users often select a shade material with an opacity somewhere in-between these two extremes, meaning that the drapery does not block enough light at times, blocks too much light at times, is too transparent at times and is not transparent enough at times.

As such, using a single drapery with a single panel of shade material provides a sub-optimal window shade.

Therefore, for all of the reasons stated above, and all of the reasons stated below, there is a need in the art for an improved window shade system that cures the deficiencies of roller shades and draperies.

As such, an objective of the disclosure is to provide a window shade system that improves upon the prior art.

Another objective of the disclosure is to provide a window shade system that provides the benefits of a roller shade.

Yet another objective of the disclosure is to provide a window shade system that does not suffer from the disadvantages of a roller shade.

Another objective of the disclosure is to provide a window shade system that provides the benefits of a drapery.

Yet another objective of the disclosure is to provide a window shade system that does not suffer from the disadvantages of a drapery.

Another objective of the disclosure is to provide a window shade system that combines the benefits of a roller shade and a drapery.

Yet another objective of the disclosure is to provide a window shade system that eliminates the deficiencies of roller shades and draperies.

Another objective of the disclosure is to provide a window shade system that is easy to install.

Yet another objective of the disclosure is to provide a window shade system that is easy to use.

Another objective of the disclosure is to provide a window shade system that that is simple to install.

Yet another objective of the disclosure is to provide a window shade system that is simple to use.

Another objective of the disclosure is to provide a window shade system that is relatively inexpensive.

Yet another objective of the disclosure is to provide a window shade system that can be used with practically any roller shade.

Another objective of the disclosure is to provide a window shade system that can be used with practically any brackets.

Yet another objective of the disclosure is to provide a window shade system that can be used with practically any window.

Another objective of the disclosure is to provide a window shade system that is aesthetically pleasing.

Yet another objective of the disclosure is to provide a window shade system that provides improved functionality.

Another objective of the disclosure is to provide a window shade system that facilitates the selection of optimum shade material for use with the window shade system.

Yet another objective of the disclosure is to provide a window shade system that has a small and unobtrusive stature when installed.

Another objective of the disclosure is to provide a window shade system that has a sleek appearance.

Yet another objective of the disclosure is to provide a window shade system that is safe to use.

Another objective of the disclosure is to provide a window shade system that allows for use of a drapery with a roller shade but does not require use of a drapery with a roller shade.

Yet another objective of the disclosure is to provide a window shade system that allows for use of a roller shade with a drapery but does not require use of a roller shade with a drapery.

Another objective of the disclosure is to provide a window shade system that can be used to modify existing roller shades to include add a drapery.

Yet another objective of the disclosure is to provide a window shade system that efficiently allows for the use of a sheer material as well as an opaque material in a single window shade system.

Another objective of the disclosure is to provide a window shade system that is intuitive to use.

Yet another objective of the disclosure is to provide a window shade system that strong and robust.

Another objective of the disclosure is to provide a window shade system that can be used in many applications.

Yet another objective of the disclosure is to provide a window shade system that provides unique functionality.

Another objective of the disclosure is to provide a window shade system that saves time.

Yet another objective of the disclosure is to provide a window shade system that is pleasing to use.

Another objective of the disclosure is to provide a window shade system that has a compact size.

Yet another objective of the disclosure is to provide a window shade system that can be used in any length.

Another objective of the disclosure is to provide a window shade system that can be used in any height.

Yet another objective of the disclosure is to provide a window shade system that has a long useful life.

Another objective of the disclosure is to provide a window shade system that is high quality.

Yet another objective of the disclosure is to provide a window shade system that can be used with practically any shade material.

Another objective of the disclosure is to provide a window shade system that eliminates the need to install two separate window shades.

These and other objects, features, or advantages of the disclosure will become apparent from the specification, figures and claims

### BRIEF DESCRIPTION OF THE DRAWINGS:

The disclosure will be better understood and objects other than those set forth above will become apparent when consideration is given to the following detailed description thereof. Such description makes reference to the annexed drawings wherein:

FIG. 1 is a front elevational view of a roller shade/drapery mounting system constructed in accordance with the principles of the present disclosure.

FIG. 2 is an enlarged showing of a portion of the system taken at circle 2 of FIG. 1

FIG. 3 is an end elevational view taken at line 3-3 of FIG. 2.

FIG. 4 is an enlarged exploded view of an end support and fascia of the prior figures.

FIG. 5 is a bottom view of the fascia taken at line 5-5 of FIG. 4.

FIG. 6 is an end elevational view of the fascia taken at line 6-6 of FIG. 5.

FIG. 7 is a rear-top-right side perspective view of a roller shade and drapery window shade system, the view showing a pair of brackets positioned in opposing spaced alignment and forming a hollow interior that faces one another, the view showing a center bracket positioned between the opposing brackets, the view showing a roller shade assembly positioned within the hollow interior of brackets and center bracket and attached to the brackets, the view showing a fascia attached to the forward side and bottom side of the brackets and center bracket, the fascia having a track positioned at the forward lower side of the fascia at the intersection of the front plate and bottom plate of the fascia, the view showing a plurality of carriers positioned within the track that are attached to a drapery shade material that hangs down from the plurality of carriers.

FIG. 8 is a right side elevation view of the roller shade and drapery window shade system shown in FIG. 7, the view showing the fascia installed onto the bracket with the upper connection member of the front plate of the fascia installed within the groove of the upper receiver of the bracket, the view showing the interior surface of the front plate of the fascia in flat and flush engagement with the forward face of the front wall of the bracket, the view showing the lower connection member of the bottom plate of the fascia installed within the groove of the lower receiver of the bracket, the view showing the upper surface of the bottom plate of the fascia in a flat and flush engagement with the bottom surface of the bottom wall of the bracket, the view showing the track of the fascia positioned within the cut out section on the forward lower side of the bracket, the view showing carriers positioned within the hollow interior of the track with a roller assembly positioned within the hollow interior, an arm extending through the slot and a connector connecting to the upper edge of the drapery shade material, the view showing a center bracket installed between the end brackets that are positioned adjacent the outward ends of the fascia.

FIG. 9 is a right side elevation section view of the roller shade and drapery window shade system shown FIG.8, the view additionally showing the tube of the roller shade assembly positioned within the hollow interior of the bracket, the view showing roller shade material wrapped around the tube of the roller shade material, the view showing the roller shade material in a deployed or lowered or closed state.

FIG. 10 is a right side rear exploded perspective view of the roller shade and drapery window shade system shown in FIGS. 7-9, the view showing the fascia installed onto the bracket, the view showing a plurality of carriers exploded out from the hollow interior of the track with a roller assembly, an arm and a connector connecting to the upper edge of the drapery shade material, the view showing the drapery shade material in a deployed or closed position with the plurality of carriers spaced along the upper edge of the drapery shade material, the view showing the roller shade assembly exploded out of the hollow interior of the bracket, the view showing roller shade material wrapped around the tube of the roller shade material, the view showing the roller shade material in a deployed or lowered or closed state, the view showing the axle holder positioned in the interior surface of the end wall of the bracket.

FIG. 11 is a rear-top-right side perspective view of a roller shade and drapery window shade system shown in FIG. 7 with the carriers and drapery shade material removed.

FIG. 12 is a top elevation view of the fascia shown in FIGS. 7-11.

FIG. 13 is a rear elevation view of the fascia shown in FIGS. 7-11.

FIG. 14 is a bottom elevation view of the fascia shown in FIGS. 7-11.

FIG. 15 is a front elevation view of the fascia shown in FIGS. 7-11.

FIG. 16 is a right side elevation view of the fascia shown in FIGS. 7-11.

FIG. 17 is a left side elevation view of the fascia shown in FIGS. 7-11.

FIG. 18 is a top-right-rear perspective view of the fascia shown in FIGS. 7-11.

FIG. 19 is a rear-top-right side perspective view of a roller shade and drapery window shade system shown in FIG. 11 with the tube of the roller shade assembly removed, the view showing the bottom wall of the bracket positioned just forward of the lower connection member in the upper surface of the bottom plate of the fascia.

FIG. 20 is a rear-top-right side exploded perspective view of a roller shade and drapery window shade system shown in FIG. 19.

FIG. 21 is a top elevation view of a bracket shown in FIGS. 7-11.

FIG. 22 is a rear elevation view of a bracket shown in FIGS. 7-11.

FIG. 23 is a bottom elevation view of a bracket shown in FIGS. 7-11.

FIG. 24 is a front elevation view of a bracket shown in FIGS. 7-11.

FIG. 25 is an interior side elevation view of a bracket shown in FIGS. 7-11.

FIG. 26 is an exterior side elevation view of a bracket shown in FIGS. 7-11.

FIG. 27 is a perspective view of the interior side of a bracket shown in FIGS. 7-11.

FIG. 28 is a top elevation view of a center bracket shown in FIGS. 7-11.

FIG. 29 is a rear elevation view of a center bracket shown in FIGS. 7-11.

FIG. 30 is a bottom elevation view of a center bracket shown in FIGS. 7-11.

FIG. 31 is a front elevation view of a center bracket shown in FIGS. 7-11.

FIG. 32 is a right side elevation view of a center bracket shown in FIGS. 7-11.

FIG. 33 is a left side elevation view of a center bracket shown in FIGS. 7-11.

FIG. 34 is a top-right-rear perspective view of a center bracket shown in FIGS. 7-11;

FIG. 35 is a perspective demonstrative view of an illuminated roller shade system having a fascia with a track therein and a light assembly positioned within the track, the view showing the roller shade material in a deployed state and the light assembly illuminated showing the light generated by the light assembly passing out of the slot in the track and illuminating the area below the fascia as well as illuminating a portion of the roller shade material, the view showing the light assembly illuminating a white color of light;

FIG. 36 is another perspective demonstrative view of an illuminated roller shade system having a fascia with a track therein and a light assembly positioned within the track, the view showing the roller shade material in a deployed state and the light assembly illuminated showing the light generated by the light assembly passing out of the slot in the track and illuminating the area below the fascia as well as illuminating a portion of the roller shade material, the view showing the light assembly illuminating a yellow color of light;

FIG. 37 is another perspective demonstrative view of an illuminated roller shade system having a fascia with a track therein and a light assembly positioned within the track, the view showing the roller shade material in a deployed state and the light assembly illuminated showing the light generated by the light assembly passing out of the slot in the track and illuminating the area below the fascia as well as illuminating a portion of the roller shade material, the view showing the light assembly illuminating a teal color of light;

FIG. 38 is another perspective demonstrative view of an illuminated roller shade system having a fascia with a track therein and a light assembly positioned within the track, the view showing the roller shade material in a deployed state and the light assembly illuminated showing the light generated by the light assembly passing out of the slot in the track and illuminating the area below the fascia as well as illuminating a portion of the roller shade material, the view showing the light assembly illuminating a blue color of light;

FIG. 39 is perspective view of an end of a fascia with a track therein and a light assembly positioned within the track, the view showing the fascia in a standalone manner, the view showing the electrical lead extending into the hollow interior of the track, the view showing the light assembly illuminating a pink color of light;

FIG. 40 is another perspective view of an end of a fascia with a track therein and a light assembly positioned within the track, the view showing the fascia in a standalone manner, the view showing the electrical lead extending into the hollow interior of the track, the view showing the light assembly illuminating a pink color of light;

FIG. 41 is another perspective view of an end of a fascia with a track therein and a light assembly positioned within the track, the view showing the fascia in a standalone manner, the view showing the light assembly positioned within the hollow interior of the track;

FIG. 42 is another perspective view of an end of a fascia with a track therein and a light assembly positioned within the track, the view showing the fascia in a standalone manner, the view showing the light assembly positioned within the hollow interior of the track; the view showing a carrier positioned within the track;

FIG. 43 is another perspective view of an end of a fascia with a track therein and a light assembly positioned within the track, the view showing the fascia in a standalone manner, the view showing the light assembly positioned within the hollow interior of the track; the view showing a the electrical lead extending through an opening in the track;

FIG. 44 is a demonstrative perspective view of a motorized drapery assembly that is to be used with a fascia with a track therein presented herein, the view showing a head having a gear assembly connected to a track and a plurality of carriers positioned in the track;

FIG. 45 is a demonstrative perspective view of a head and gear assembly of a motorized drapery assembly that is to be used with a fascia with a track therein presented herein, the view showing a head having a gear assembly connected to a track;

FIG. 46 is a demonstrative perspective of a track of a motorized drapery assembly that is to be used with a fascia with a track therein presented herein, the view showing a the track having a pair of divided chambers, the view showing a belt positioned within the divided chambers of the track;

FIG. 47 is a demonstrative perspective of a motor assembly of a motorized drapery assembly that is to be used with a fascia with a track therein presented herein;

FIG. 48 is a demonstrative perspective of a gear assembly and belt of a motorized drapery assembly that is to be used with a fascia with a track therein presented herein;

FIG. 49 is another demonstrative perspective view of a motorized drapery assembly that is to be used with a fascia with a track therein presented herein, the view showing a head having a gear assembly connected to a track and a plurality of carriers positioned in the track, the view showing a motor assembly connected to the head and gear assembly;

FIG. 50 is another demonstrative perspective view of a motorized drapery assembly that is to be used with a fascia with a track therein presented herein, the view showing a drapery shade material connected to a plurality of carriers connected to the track;

FIG. 51 is a modified version of the exploded rear perspective view of FIG. 10, the view showing the addition of a light assembly that is to be installed within the track of the fascia, the view showing a battery tube that houses a plurality of batteries that is to be installed onto the fascia using a pair of holders that hold the battery tube and connect it to the fascia, the view showing an electrical lead that connects the battery tube to the light assembly;

FIG. 52 is a modified version of the side elevation view of FIG. 9, the view showing a light assembly installed within the hollow interior of the track, the view showing the light assembly adhered to the lower surface of the top wall of the track, the view showing a plurality of carriers installed within the hollow interior of the track below the light assembly;

FIG. 53 is a close up version of the side elevation view of FIG. 52, the view showing a light assembly installed within the hollow interior of the track, the view showing the light assembly adhered to the lower surface of the top wall of the track, the view showing a plurality of carriers installed within the hollow interior of the track below the light assembly;

FIG. 54 is another modified version of the side elevation view of FIG. 9, the view showing a second track formed in the fascia, view showing the second track positioned just rearward of the first track, the view showing a light assembly installed within the hollow interior of the second track, the view showing the light assembly adhered to the lower surface of the top wall of the second track, the view showing a plurality of carriers installed within the hollow interior of the first track, the view showing the second track being of a substantially smaller height than the first track which compliments the thin thickness of the light assembly in addition the thin vertical height of the second track does not interfere with the diameter of the roller shade assembly;

FIG. 55 is a close up version of the side elevation view of FIG. 54, the view showing a second track formed in the fascia, view showing the second track positioned just rearward of the first track, the view showing a light assembly installed within the hollow interior of the second track, the view showing the light assembly adhered to the lower surface of the top wall of the second track, the view showing a plurality of carriers installed within the hollow interior of the first track, the view showing the second track being of a substantially smaller height than the first track which compliments the thin thickness of the light assembly in addition the thin vertical height of the second track does not interfere with the diameter of the roller shade assembly;

FIG. 56 is a side elevation view of a fascia having a modified track with a center divider that extends downward from the top wall of the track and a pair of opposed horizontal dividers that extend inward from the forward and rearward walls of the track that separate the upper portion of the track into a pair of chambers that are configured to receive oppositely moving portions of a belt of a motorized drapery assembly while the lower portion of the hollow interior is configured to receive a plurality of carriers that are moved by the motorized drapery assembly;

FIG. 57 is a plan view of the electronic components of the illuminated roller shade and drapery mounting system, the view showing a control assembly electrically connected to and configured to control operation of any one of or all of a light assembly, a roller shade assembly and/or a motorized drapery assembly, the view showing the control assembly having a microprocessor, memory, a receiver or transceiver, and an antenna, the view showing a switch electrically connected to the control assembly that is configured to provide control signals to the control assembly, the view showing a wireless control wirelessly connected to the control assembly and configured to provide control signals to the control assembly;

FIG. 58 is an end perspective view of a headbox having an bottom plate assembly installed onto the headbox, the view showing the bottom plate assembly in a fully installed position on the headbox, the view showing a track positioned within the bottom plate assembly, the view showing the bottom plate assembly having a connection member that is in locked and mating engagement with a connection member of the headbox;

FIG. 59 is another end perspective view of a headbox having an bottom plate assembly installed onto the headbox, the view showing the bottom plate assembly in a fully installed position on the headbox, the view showing a track positioned within the bottom plate assembly, the view showing the bottom plate assembly having a connection member that is in locked and mating engagement with a connection member of the headbox;

FIG. 60 is another perspective view of a headbox having an bottom plate assembly installed onto the headbox, the view showing a bottom-side view of an end of the headbox with installed bottom plate assembly, the view showing the bottom plate assembly in a fully installed position on the headbox, the view showing a track positioned within the bottom plate assembly, the view showing the bottom plate assembly having a connection member that is in locked and mating engagement with a connection member of the headbox;

FIG. 61 is perspective view of an end of a bottom plate assembly that is configured to be installed onto a headbox, the view showing the bottom plate assembly having a track positioned within the bottom plate assembly that is configured to receive a light assembly, a lens, and/or a drapery assembly, the view showing the bottom plate assembly having a connection member that is configured to engage and lock with a connection member of the headbox;

FIG. 62 is another perspective view of an end of a bottom plate assembly that is configured to be installed onto a headbox, the view showing the bottom plate assembly having a track positioned within the bottom plate assembly that is configured to receive a light assembly, a lens, and/or a drapery assembly, the view showing the bottom plate assembly having a connection member that is configured to engage and lock with a connection member of the headbox;

FIG. 63 is another end perspective view of a headbox having an bottom plate assembly in a partially installed state on the headbox, the view showing a connection member of the bottom plate assembly partially engaged with a connection member of the headbox, the view showing the rearward end of the bottom plate assembly raised or tilted upward so as to facilitate installation of the connection member of the bottom plate assembly with the connection member of the headbox;

FIG. 64 is an end perspective view of a demonstrative lens positioned within a track along with a light assembly positioned within the track, the view showing the lens having a rounded exterior surface that protrudes outward and downward from the slot in the track in a rounded manner so as to facilitate directing light generated by the light in a dispersed manner, the view showing the lens having a pair of opposing arms that engage the slot thereby holding the lens to the track, the view showing the light assembly positioned above the lens, the view showing the light assembly and lens being separate components;

FIG. 65 is an end perspective view of another demonstrative lens positioned within a track along with a light assembly positioned within the track, the view showing the lens having a flat exterior surface that is generally flat and flush and in planar alignment with the lower surface of the slot and track so as to facilitate directing light generated by the light assembly toward the ground, the view showing the lens having a pair of opposing arms that engage the slot thereby holding the lens to the track, the view showing the light assembly positioned above the lens, the view showing the light assembly and lens being separate components;

FIG. 66 is an end perspective view of another demonstrative lens positioned within a track along with a light assembly positioned within the track, the view showing the lens having a flat exterior surface that is angled with respect to the lower surface of the slot and track so as to facilitate directing light generated by the light assembly toward the shade material, the view showing the lens having a pair of opposing arms that engage the slot thereby holding the lens to the track, the view showing the light assembly positioned above the lens, the view showing the light assembly and lens being separate components.

FIG. 67 is a top-right-rear perspective view of a bottom plate assembly having a track therein that is configured to connect to a headbox, the view showing a track positioned at the intersection of a front wall and the bottom plate;

FIG. 68 is a top-right-rear perspective view of a bottom plate assembly having a track therein that is configured to connect to a headbox, the view showing a track positioned at the intersection of a front wall and the bottom plate, the view showing the bottom plate assembly installed into a headbox;

FIG. 69 is a top-right-rear perspective view of a bottom plate assembly having a track therein that is configured to connect to a headbox, the view showing a track positioned at the intersection of a front wall and the bottom plate, the view showing the bottom plate assembly exploded from a headbox;

FIG. 70 is a top elevational view of a bottom plate assembly having a track therein that is configured to connect to a headbox;

FIG. 71 is a bottom elevational view of a bottom plate assembly having a track therein that is configured to connect to a headbox;

FIG. 72 is a front elevational view of a bottom plate assembly having a track therein that is configured to connect to a headbox;

FIG. 73 is a rear elevational view of a bottom plate assembly having a track therein that is configured to connect to a headbox;

FIG. 74 is a right elevational view of a bottom plate assembly having a track therein that is configured to connect to a headbox;

FIG. 75 is a left elevational view of a bottom plate assembly having a track therein that is configured to connect to a headbox;

FIG. 76 is a right elevation view of a bottom plate assembly having a track therein that is configured to connect to a headbox, the view showing a track positioned at the intersection of a front wall and the bottom plate, the view showing the bottom plate assembly installed into a headbox, the view showing a roller shade assembly installed in the headbox, the view showing carriers positioned within the track of the bottom plate assembly, the view showing drapery shade material installed onto the carriers installed into the track;

FIG. 77 is a left elevation view of a bottom plate assembly having a track therein that is configured to connect to a headbox, the view showing a track positioned at the intersection of a front wall and the bottom plate, the view showing the bottom plate assembly installed into a headbox, the view showing carriers positioned within the track of the bottom plate assembly, the view showing drapery shade material installed onto the carriers installed into the track.

### SUMMARY OF THE DISCLOSURE

A window shade system is presented that combines the benefits of roller shades with draperies.

In one arrangement a fascia having a front plate and a bottom plate includes a track positioned in the forward lower end of the fascia. The fascia is configured to be attached to a plurality of brackets. One or more roller shades having roller shade material attached to a tube are connected to the brackets. A plurality of carriers are positioned in the track and one or more draperies are attached to the plurality of carriers in the track. This arrangement presents a dual functioning window shade wherein roller shade material may be opened and closed by raising and lowering the roller shade material by rotating the tube of the roller shades raised, and the drapery shade material may be opened and closed by sliding the drapery shade material along the length of the track.

In an alternative arrangement, a light assembly is placed in the track positioned in the fascia, and a battery pack or battery tube is connected to the light assembly that powers the light assembly. In another arrangement, a motorized drapery assembly is used in association with the fascia to open and close drapery shade material using motorization.

### DETAILED DESCRIPTION

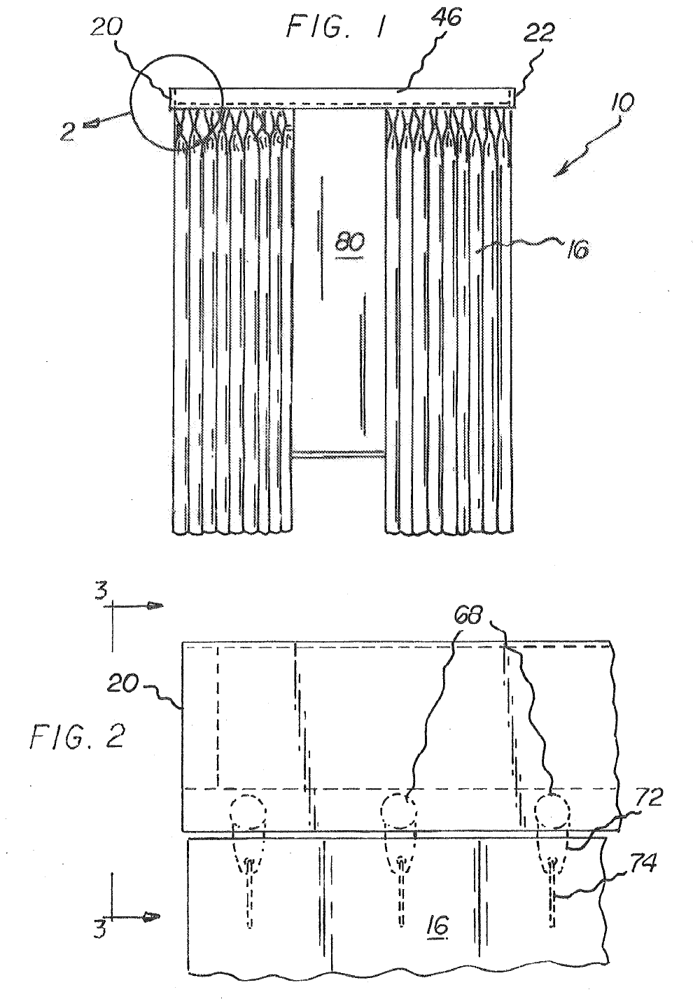

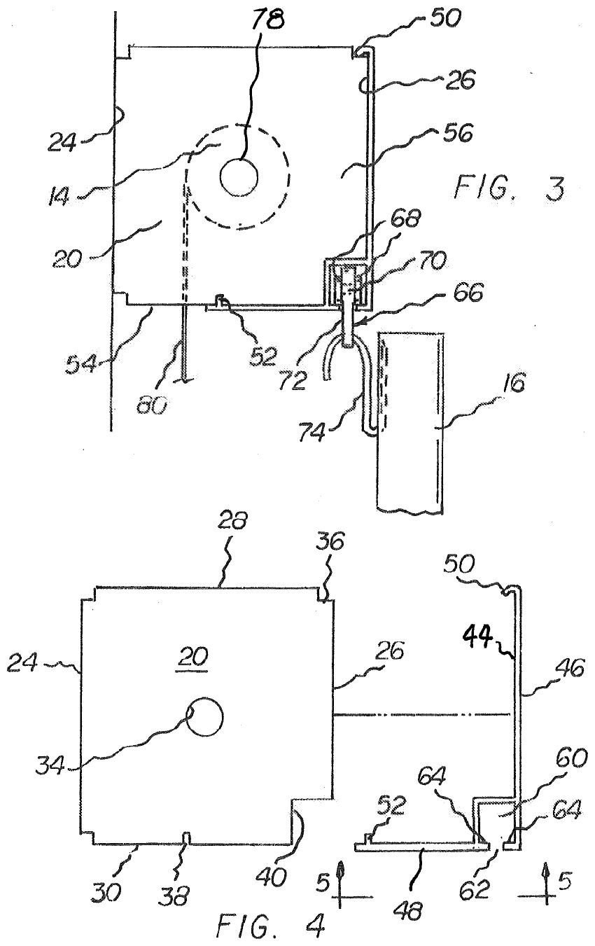

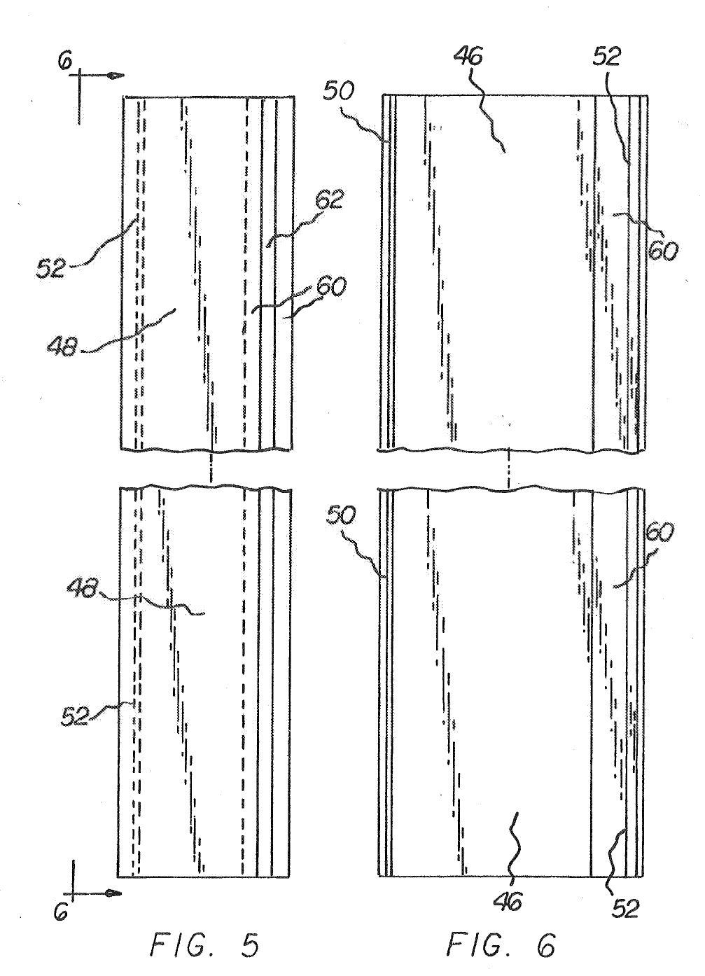

FIGS. 1-6:

With reference to FIGS. 1-6, in view of the disadvantages inherent in the known types of mounting systems for roller shades and drapery now present in the prior art, the disclosure provides an improved roller shade/drapery mounting system 10 integrating both components into one uniform system. As such, the general purpose of the disclosure, which will be described subsequently in greater detail, is to provide a new and improved roller shade/drapery mounting system 10 and method which has all the advantages of the prior art and none of the disadvantages.

To attain this, from a broad perspective, two support plates 20, 22 are provided. Each support plate 20, 22 has an interior edge 24, an exterior edge 26, an upper edge 28, and a lower edge 30. An upper recess 36 is formed in an upper exterior region of each of the support plates 20, 22. A lower recess 38 is formed in a central region of the lower edge 30 of each of the support plates 20, 22. A cutout 40 is formed in a lower exterior region of each of the support plates 20, 22.

A fascia 44 with front plate 46 and bottom plate 48 is next provided. The fascia 44 has ends at the support plates 20, 22. The front plate 46 has an upper projection 50 positioned in the upper recess 36 of each support plate 20, 22. The bottom plate 48 has a lower projection 52 positioned in the lower recess 38 of each support plate 20, 22 spaced from the interior edge 24 to form a major passageway 54. A major chamber 56 is formed rearwardly of the front plate 46 and upwardly of the bottom plate 48.

Next provided is a minor chamber 60 formed rearwardly of the front plate 46 and upwardly of the bottom plate 48. A minor passageway 62 is formed in the minor chamber 60 bounded by tracks 64.

In this respect, before explaining at least one embodiment of the disclosure in detail, it is to be understood that the disclosure is not limited in its application to the details of the construction shown and to the arrangements of the components set forth in the following description or illustrated in the drawings. The disclosure is capable of other embodiments and of being practiced and carried out in various and additional ways. Also, it is to be understood that the phraseology and terminology employed herein are for the purpose of descriptions and should not be regarded as limiting. As such, those skilled in the art will appreciate that the conception, upon which this disclosure is based, may readily be utilized as a basis for the designing of other structures, methods and systems for carrying out the several purposes of the disclosure. It is important, therefore, that the disclosure be regarded as including such equivalent constructions insofar as they do not depart from the spirit and scope of the disclosure.

With reference now to the drawings FIGS. 1-6, and in particular to FIG. 1 thereof, the new and improved roller shade/drapery mounting system 10 embodying the principles and concepts of the disclosure and generally designated by the reference numeral 10 will be described.

In the arrangement shown, as one example, roller shade/drapery mounting system 10 is comprised of a plurality of components. In their broadest context such include two support plates 20, 22, a fascia 44, a major chamber 56, and a minor chamber 60. Such components are⁻individually configured and correlated with respect to each other so as to attain the desired objectives.

In the arrangement shown, as one example, roller shade/drapery mounting system 10 is a system 10 for supporting and repositioning both a roller shade 14 and drapery 16. A left support plate 20 and a similarly configured right support plate 22 are provided. The left support plate 20 and right support plate 22 are laterally spaced a fixed distance in vertical planes. The left support plate 20 and right support plate 22 each have an interior edge 24 and a parallel exterior edge 26. The left support plate 20 and right support plate 22 each have an upper edge 28 and a parallel lower edge 30.

A circular hole 34 is formed in a central region of each of the support plates 20, 22. An upper recess 36 is formed in an upper exterior region of each of the support plates 20, 22. A lower recess 38 is formed in a central region of the lower edge 30 of each of the support plates 20, 22. A square cutout 40 is formed in a lower exterior region of each of the support plates 20, 22.

Next provided is a fascia 44 in an L-shaped configuration with a front plate 46 and a bottom plate 48. The fascia 44 is elongated and has a left end positioned at the left support plate 20. The fascia 44 has a right end positioned at the right support plate 22. The front plate 46 is positioned in contact with the exterior edges 26 of the left support plate 20 and right support plate 22. The front plate 46 has an upper projection 50 positionable in the upper recesses 36 of each support plate 20, 22. The bottom plate 48 has a lower projection 52 positionable in the lower recesses 38 of the support plates 20, 22 at a location spaced from the interior edge 24 to form a major passageway 54. A major chamber 56 is formed rearwardly of the front plate 46 and upwardly of the bottom plate 48.

A minor chamber 60 is formed in the major chamber 56 rearwardly of the front plate 46 and upwardly of the bottom plate 48. The minor chamber 60 is bounded exteriorly by the front plate 46. The minor chamber 60 is bounded below by the bottom plate 48. A minor passageway 62 is formed in the minor chamber 60. The minor passageway 62 is bounded by tracks 64.

In the arrangement shown, as one example, a plurality of roller assemblies 66 are positioned within the minor chamber 60. Each of the plurality of roller assemblies 66 have two rollers 68 with an axle 70 there between. A plurality of couplers 72 have an upper end above the bottom plate 48 rotatably receiving an associated axle 70. Each coupler 72 has a lower end with an aperture beneath the bottom plate 48. A plurality of hooks 74 are further provided. Each hook 74 has a first end coupled to an associated aperture of an associated coupler 72. Each hook 74 has a second end coupled to an associated region of the drapery 16.

In the arrangement shown, as one example, roller shade 14 has a spool 78 with opposed ends supported in the support plates 20, 22. The roller shade 14 has a depending section 80 extending downwardly through the major passageway 54.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

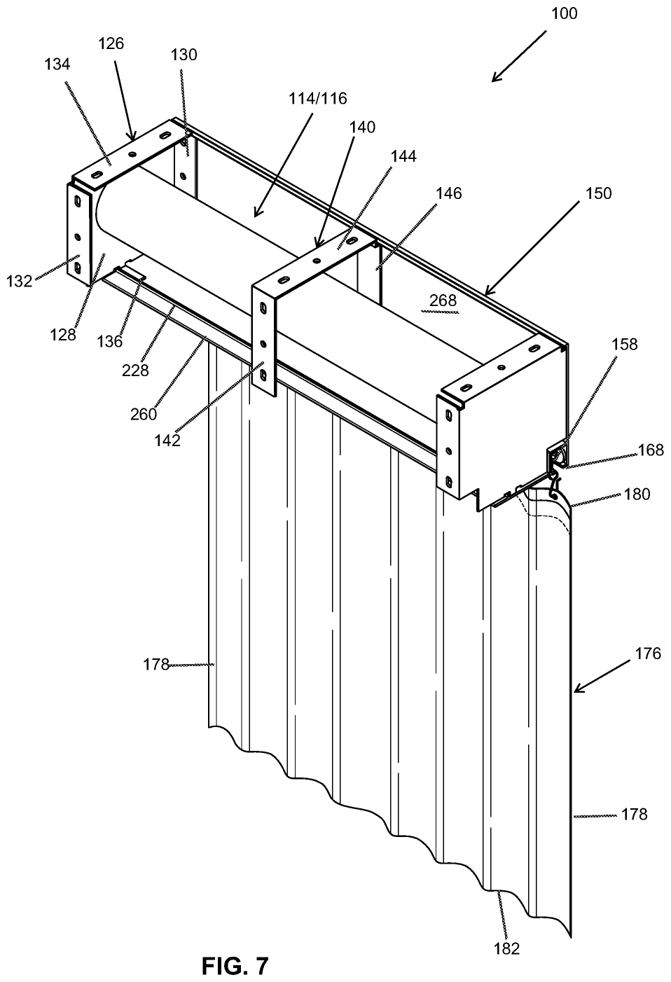

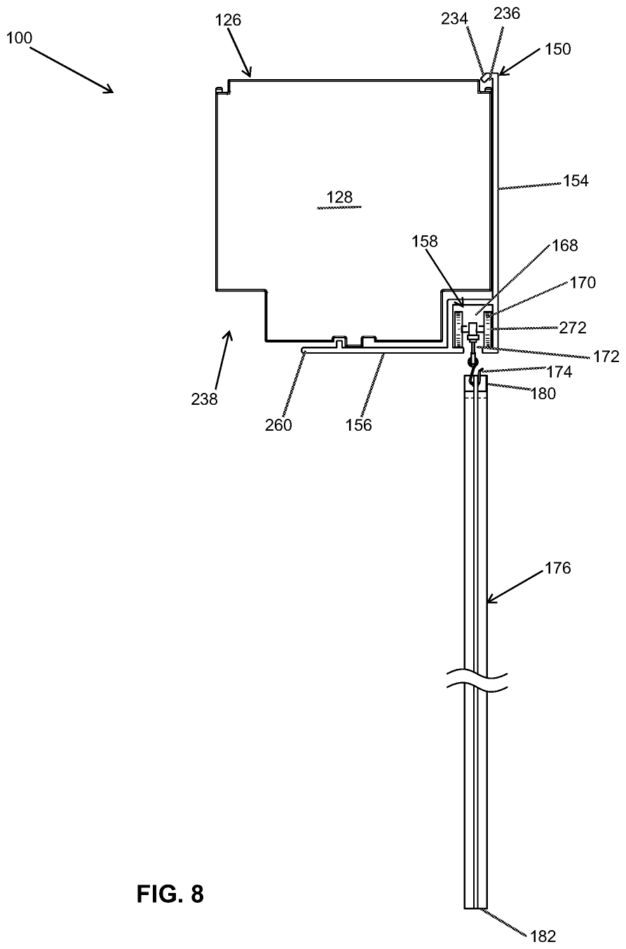

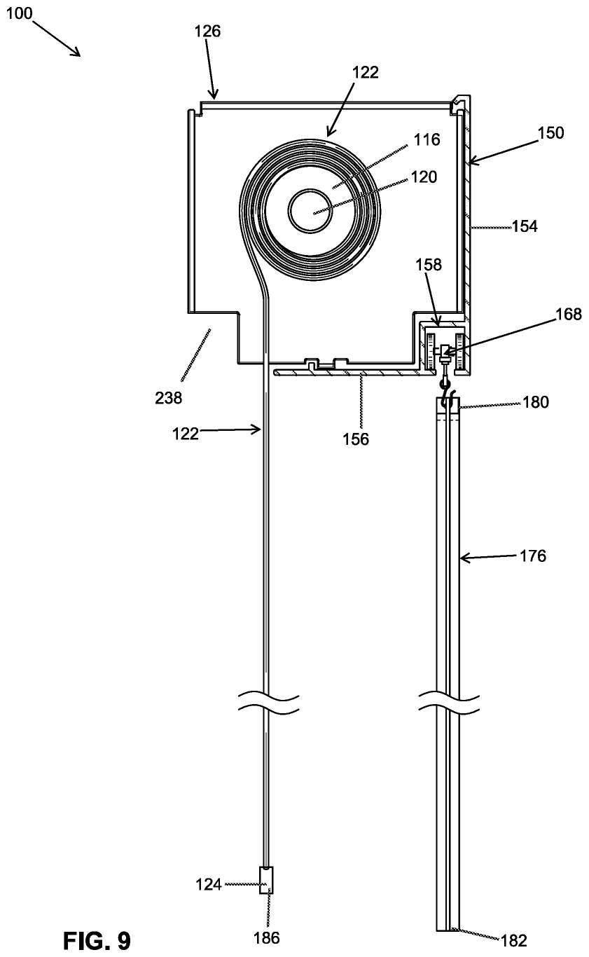

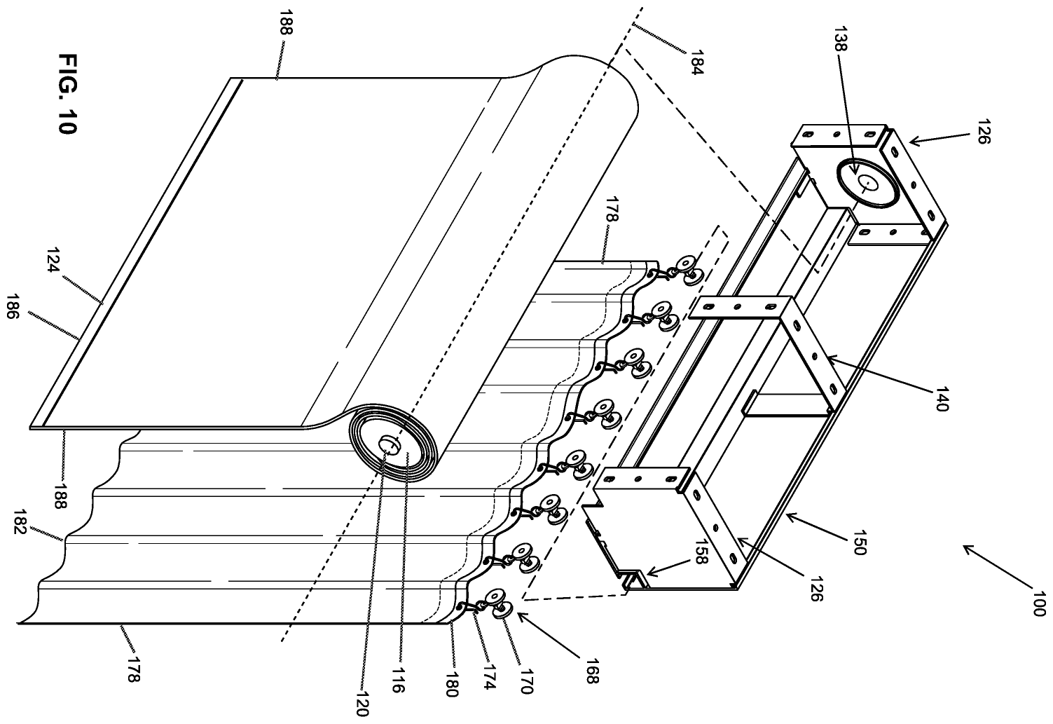

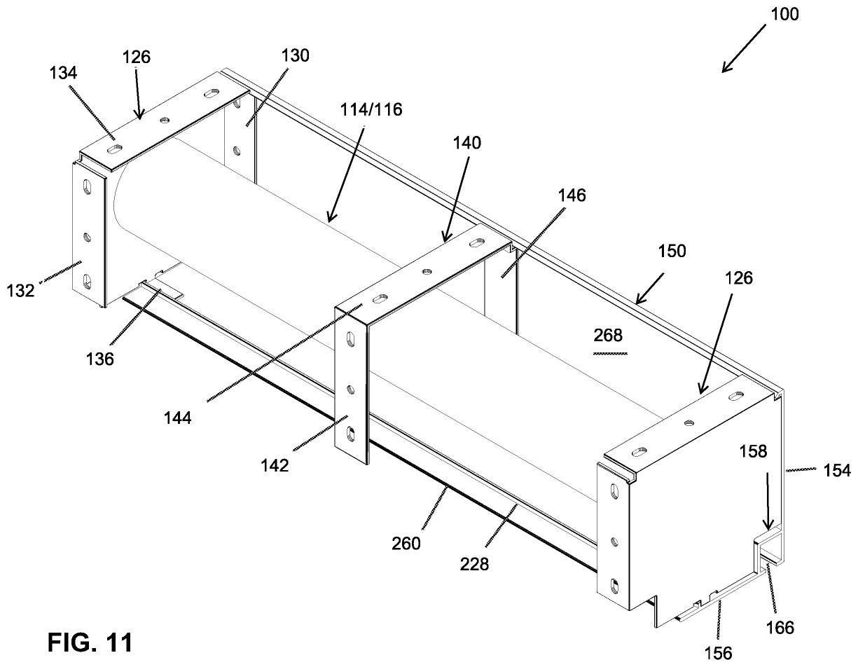

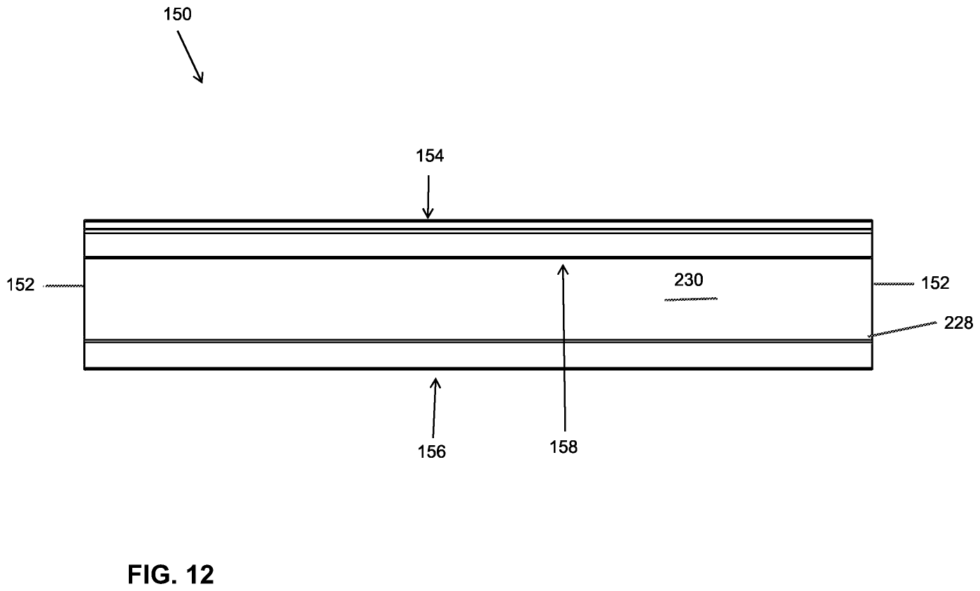

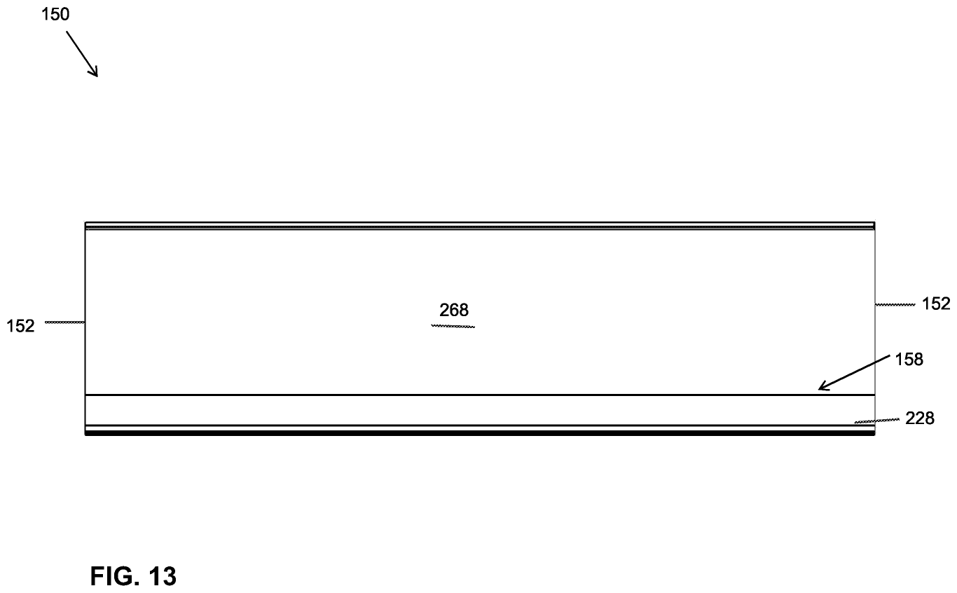

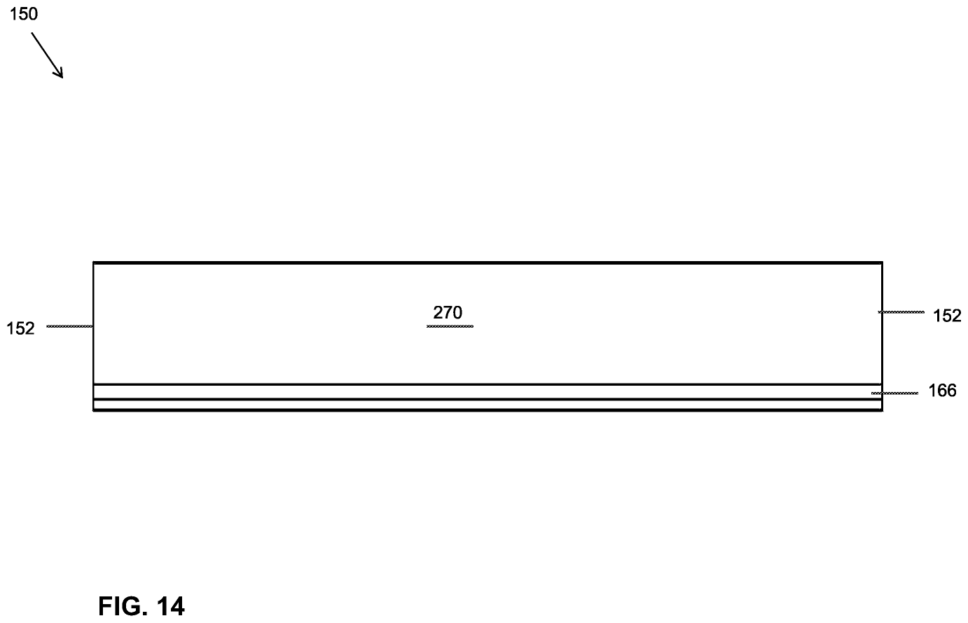

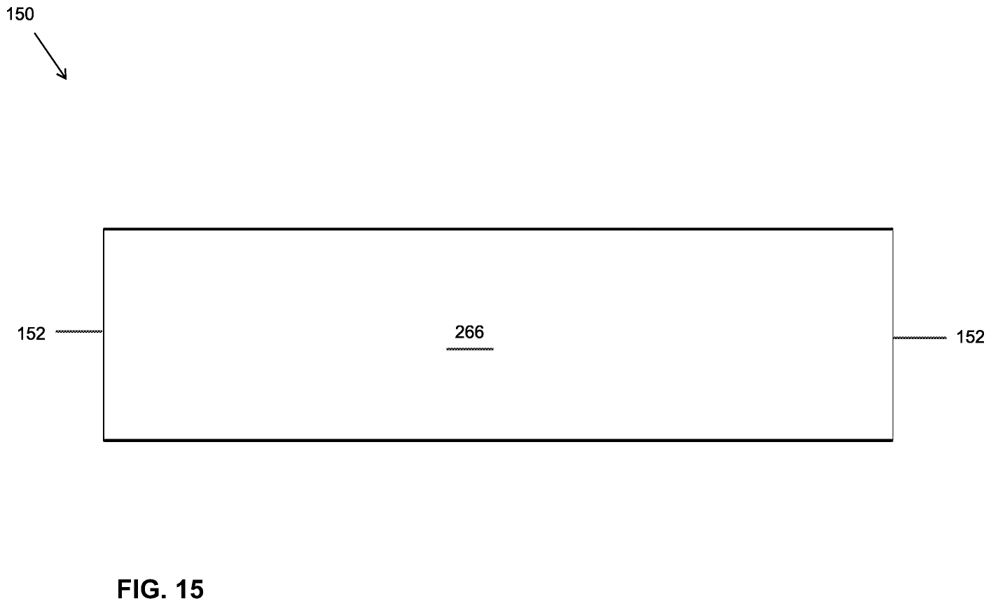

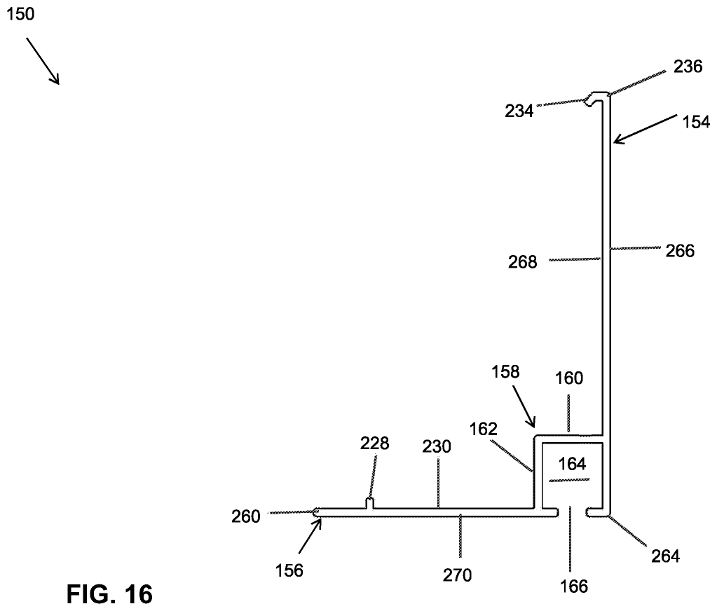

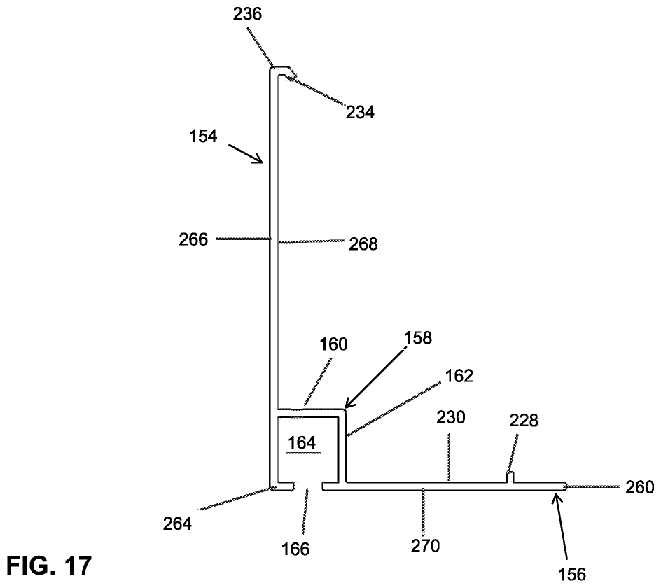

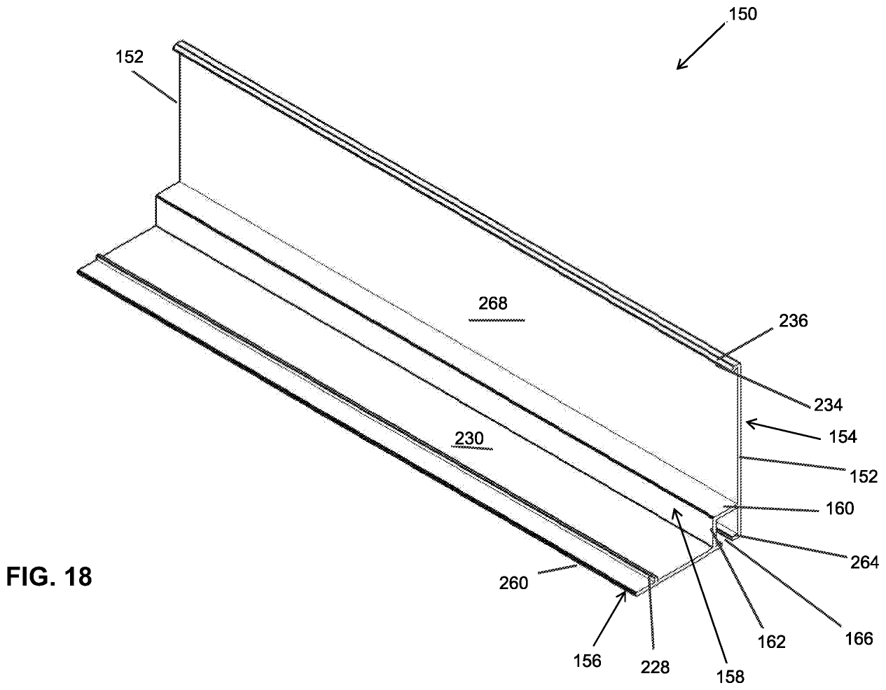

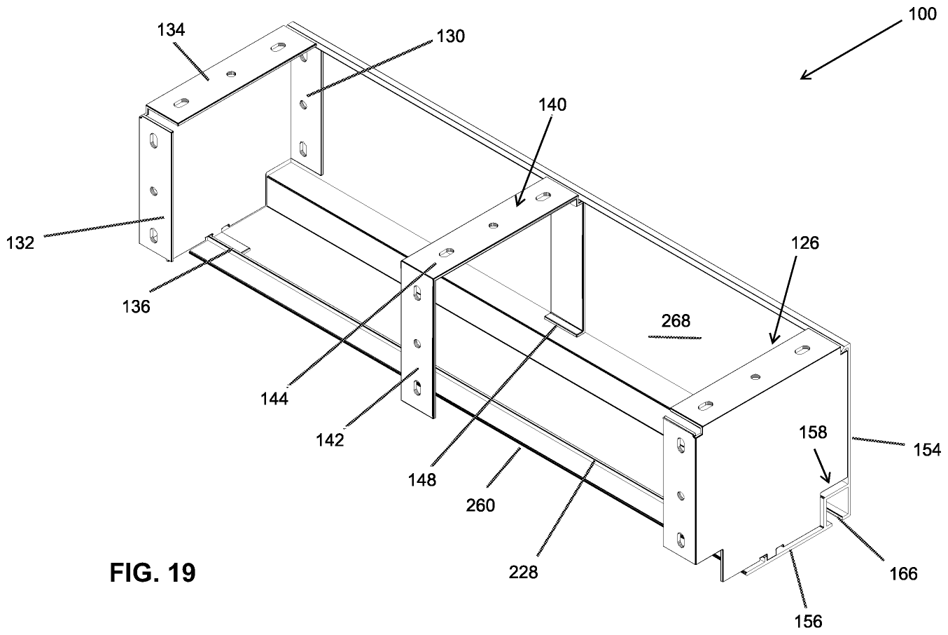

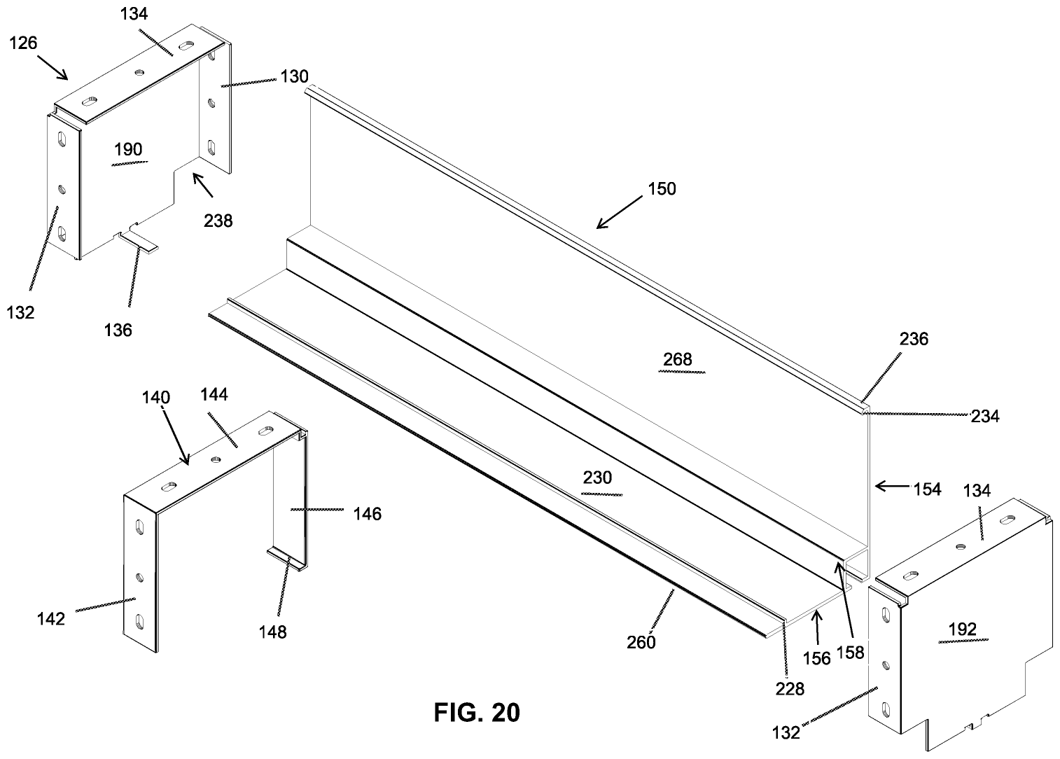

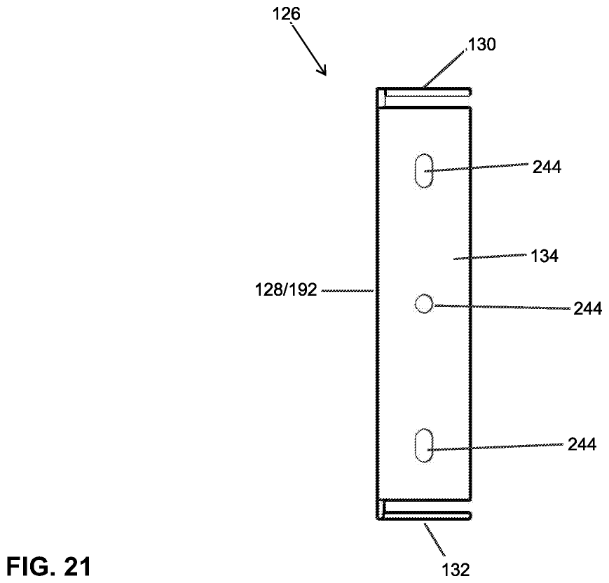

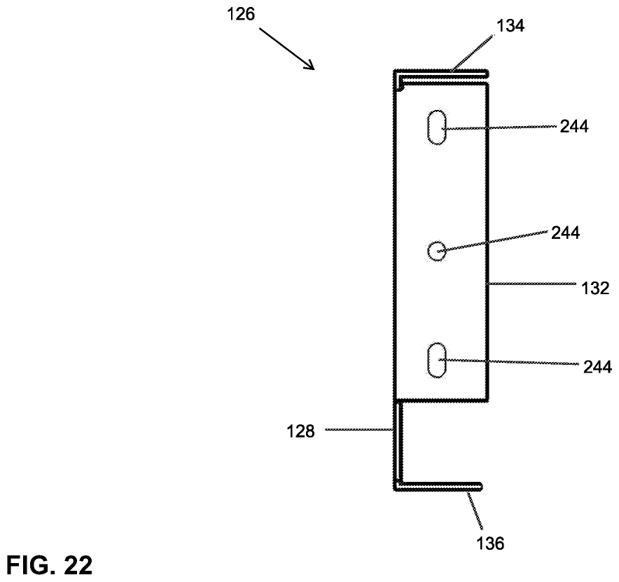

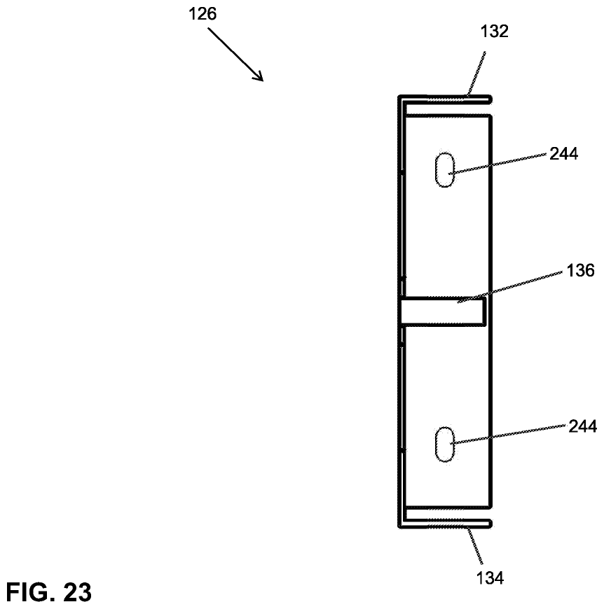

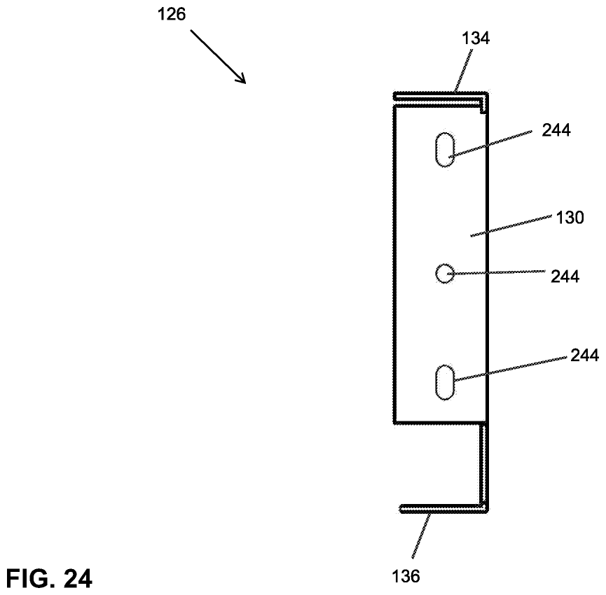

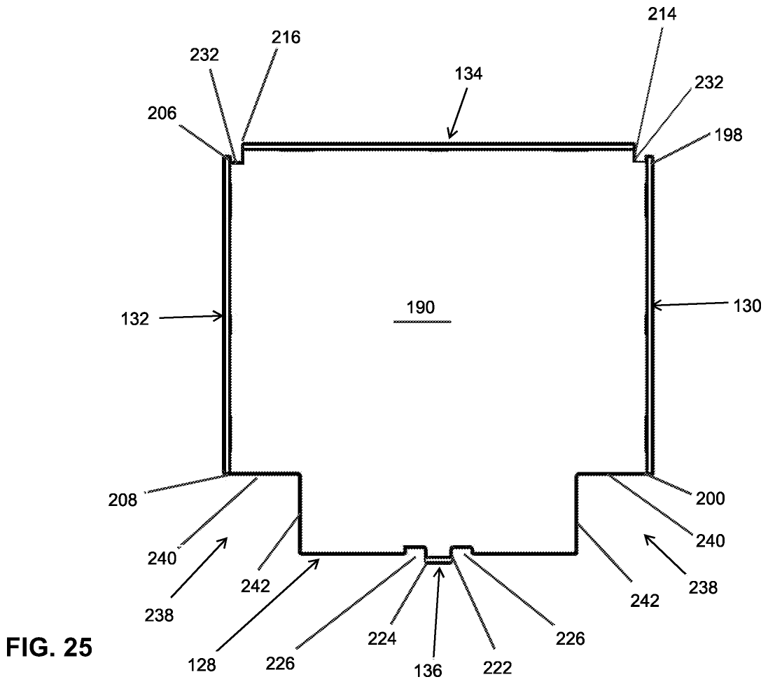

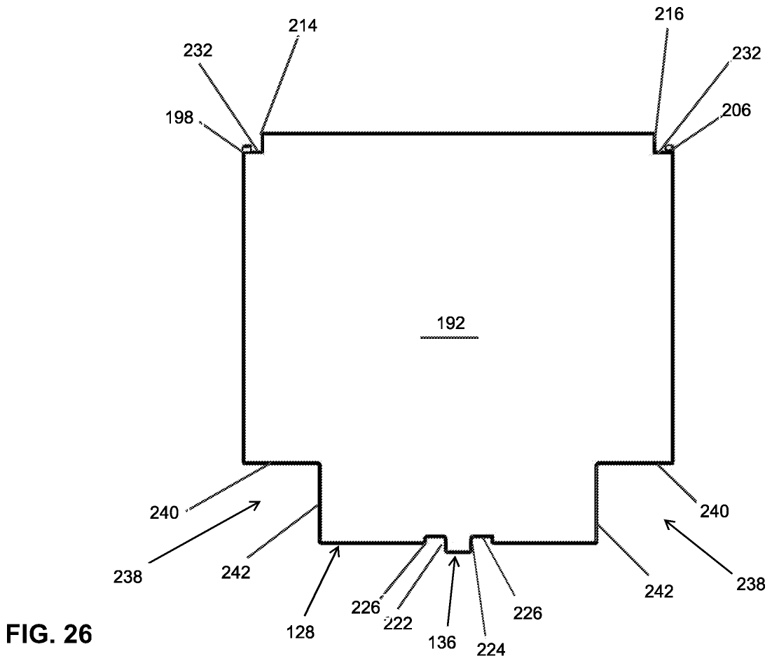

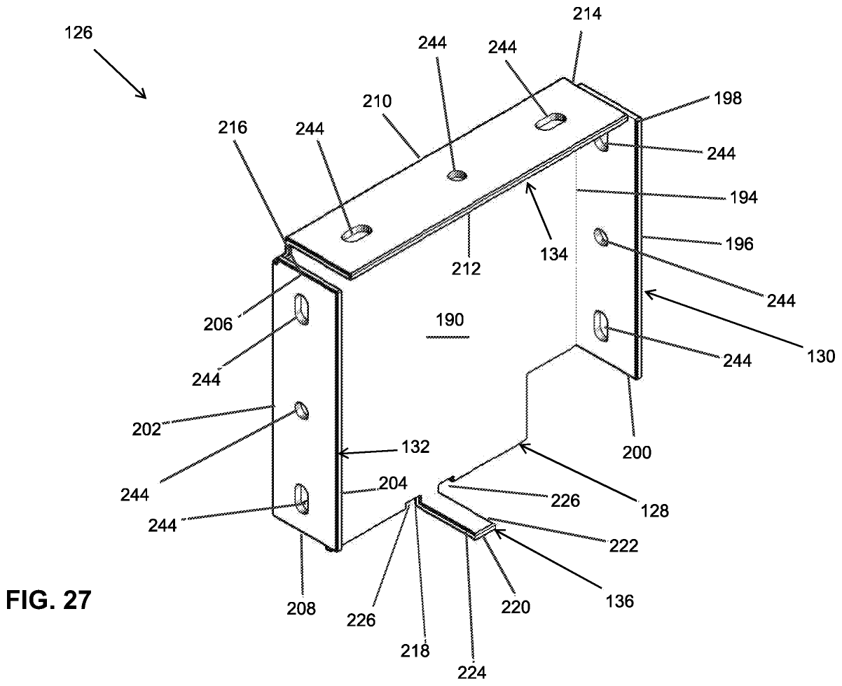

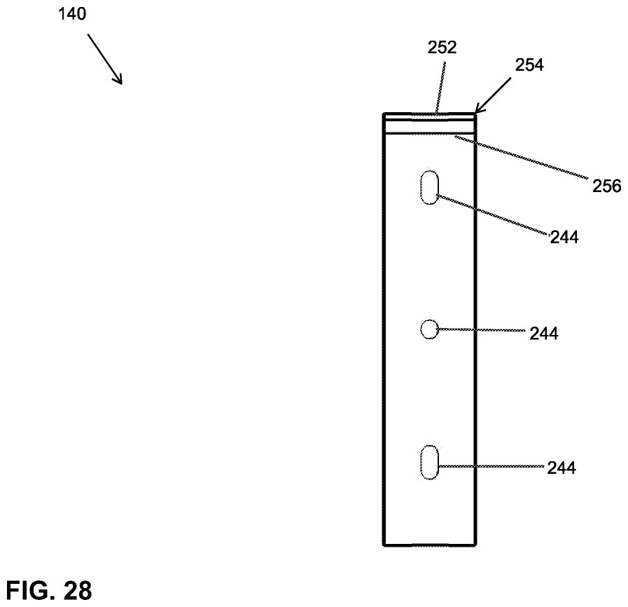

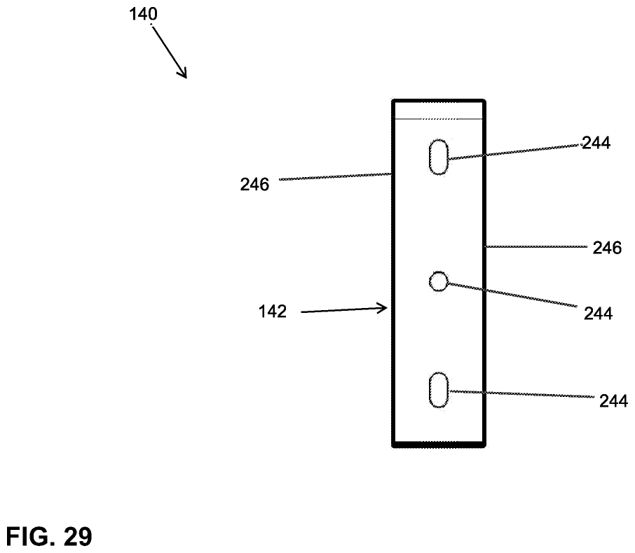

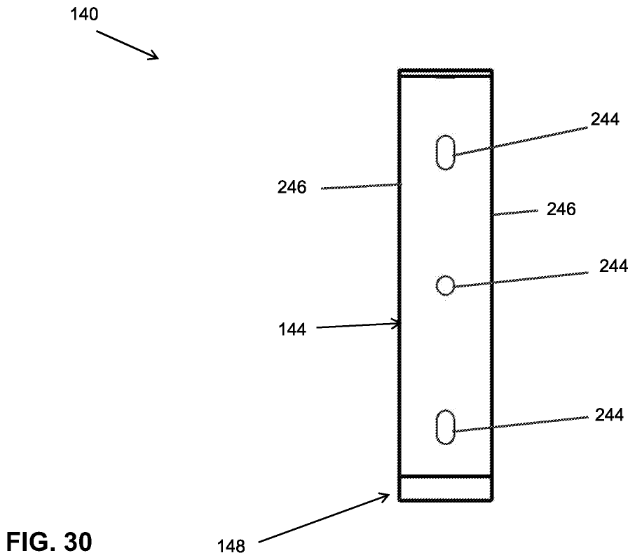

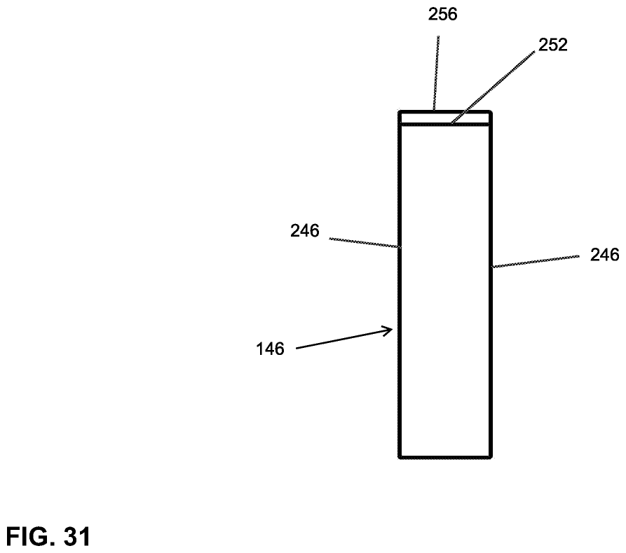

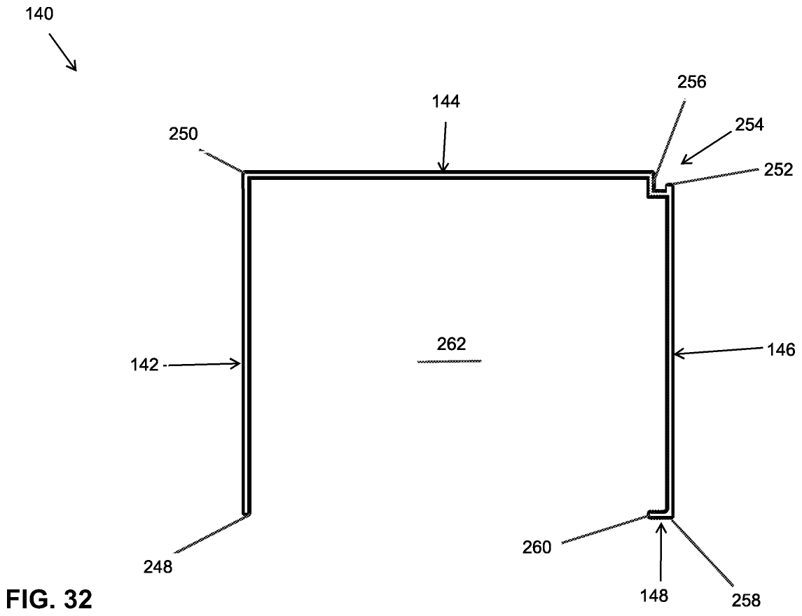

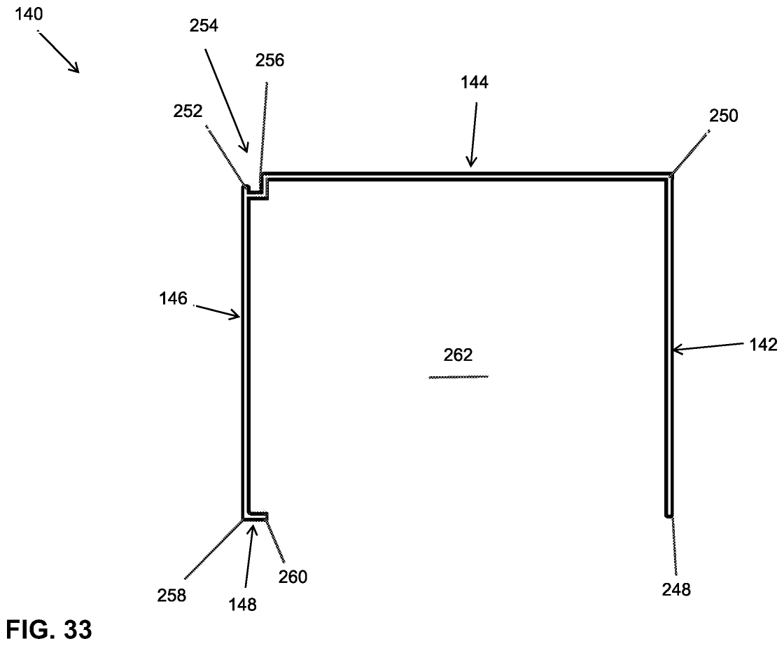

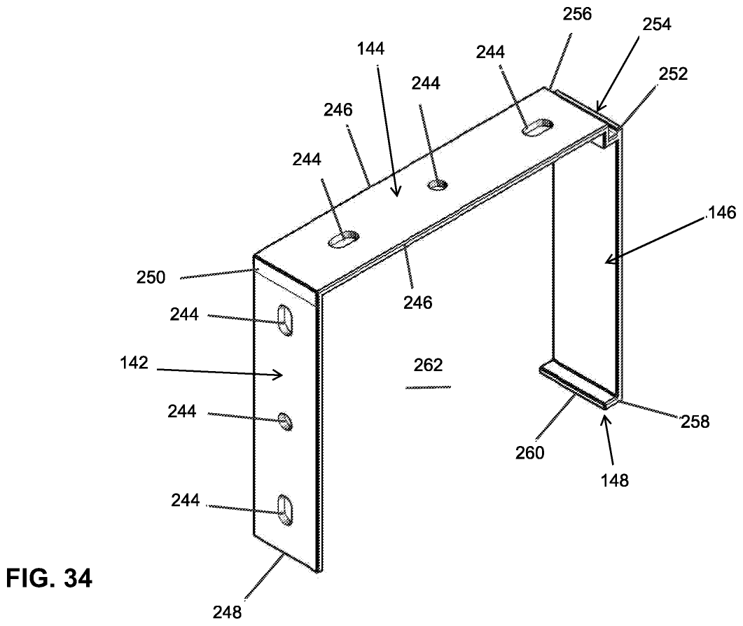

FIGS. 7-34:

With reference to FIGS. 7-34, in the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the disclosure.

System:

With reference to FIGS. 7-34, a roller shade and drapery window shade system 100 (or simply system 100) is presented. The roller shade and drapery window shade system 100 is formed of any suitable size, shape and design and is configured to facilitate the incorporation of the benefits of roller shades and draperies in a single system in a convenient, compact, easy to use, safe, aesthetically pleasing and relatively inexpensive package. In the arrangement shown, as one example, the roller shade and drapery window shade system 100 has a front side 102, a back side 104, a left side 106, a right side 108, a top side 110, a bottom side 112. In the arrangement shown, as one example, roller shade and drapery window shade system 100 includes a roller shade assembly 114 having a tube 116 that extends a length between an opposing ends 118, an axle 120 connected to each end 118, roller shade material 122 connected to the tube 116 and a bottom bar 124 connected to the roller shade material 122, among other components and features. In the arrangement shown, as one example, roller shade and drapery window shade system 100 include a pair of opposing brackets 126 having an end wall 128, a front wall 130, a rear wall 132, a top wall 134, a bottom wall 136, and an axle holder 138, among other components and features. In the arrangement shown, as one example, roller shade and drapery window shade system 100 include a center bracket 140 having a rear wall 142, a top wall 144, a front wall 146 and a bottom wall 148, among other components and features. In the arrangement shown, as one example, roller shade and drapery window shade system 100 includes a fascia 150 extending a length between opposing ends 152 and having a front plate 154, a bottom plate 156 and a track 158 having a top wall 160, a rear wall 162, a hollow interior 164 and a slot 166, among other components and features. In the arrangement shown, as one example, roller shade and drapery window shade system 100 includes a plurality of carriers 168 having a roller assembly 170, an arm 172 and a connector 174, among other components and features. In the arrangement shown, as one example, roller shade and drapery window shade system 100 includes a drapery shade material 176 extending a width between opposing sides 178 and extending a height between an upper end 180 and a lower end 182, among other components and features.

Roller Shade Assembly:

In the arrangement shown, as one example, roller shade and drapery window shade system 100 includes one or more roller shade assemblies 114. Roller shade assembly 114 is formed of any suitable size, shape and design and is configured to facilitate the vertical opening and closing of roller shade material 122 by rotation of a tube 116.

In the arrangement shown, as one example, roller shade assembly 114 includes a tube 116. Tube 116 is formed of any suitable size, shape and design and is configured to facilitate support of roller shade material 122 as well as facilitate opening and closing of roller shade material 122 by rotation of tube 116. In the arrangement shown, as one example, tube 116 is formed of a generally cylindrical member having a generally cylindrical exterior surface. Tube 116 may be a solid rod or alternatively tube 116 may have a hollow interior.

In the arrangement shown, as one example, tube 116 extends a lateral length between opposing ends 118. In the arrangement shown, as one example, an axle 120 is connected to each end 118 of tube 116. Axles 120 themselves are formed of any suitable size, shape and design and are configured to connect to brackets 126 adjacent each end 118 of tube 116. In this way, connection of axles 120 to brackets 126 facilitates support of tube 116. In the arrangement shown, tube 114 rotates around an axis of rotation 184 that extends through the approximate middle of tube 114 from end 118 to end 118 and through the approximate center of axles 120.

In the arrangement shown, as one example, roller shade assembly 114 includes roller shade material 122. Roller shade material 122 is formed of any suitable size, shape and design and is configured to be raised and lowered, opened and closed, by rotation of tube 116 while providing an aesthetically pleasing visual appearance while allowing a desirable amount of light into the building. In the arrangement shown, as one example, roller shade material 122 is a generally flat panel of fabric or material that extends a vertical height from an upper end, which is attached to tube 116, and a lower end 186, and extends a lateral width between opposing sides 188. In the arrangement shown, as one example, roller shade material 122 is cut to the approximate width of tube 116 and ins installed such that the sides 188 of roller shade material 122 align with the ends 118 of tube 116.

In the arrangement shown, as one example, a bottom bar 124 is connected at or adjacent to the lower end 186 of roller shade material 122. Bottom bar 124 is formed of any suitable size, shape and design and is configured provide weight to the lower end 186 of roller shade material 122 so as to facilitate opening and closing of the roller shade material 122 while also maintaining the panel of fabric in a generally flat and straight manner. In one arrangement, bottom bar 124 is a plastic or metallic tube or rod that is connected to the lower end 186 of roller shade material 122 or is wrapped within a loop of roller shade material 122 at the lower end 186.

In one arrangement, roller shade assembly 114 may either be a manual shade, which opens or closes by manual operation, or a motorized shade, which opens or closes by operation of a motor. In one arrangement, wherein when roller shades assembly 114 is a manual shade, in one arrangement a pull cord or other manual operation mechanism is operatively connected to tube 116 that facilitates rotation of tube 116. In one arrangement a clutch mechanism is connected to tube 116 adjacent an end118 and/or is positioned inside a hollow interior of the tube 116 that facilitates manual operation. In one arrangement, roller shade assembly 114 may be manually operated using a spring assist assembly that may be positioned within tube 116 that facilitates operation by pulling directly on the roller shade material 122.

In one arrangement, wherein when roller shade assembly 114 is a motorized shade, in one arrangement a motor, motor controller assembly, spring counterbalance assembly, and/or any other component necessary is positioned within the hollow interior of tube 116. When roller shade assembly 114 is motorized, the roller shade assembly 114 may be powered by an internal power source, such as one or more batteries positioned within the tube 116, or by an external power source such as one or more batteries positioned outside the tube 116, external line power, a solar cell, or any other form of or source of power external to the tube 116 that is electrically connected to the motor.

Regardless of whether roller shade assembly 114 is a manual shade or a motorized shade, the roller shade material 122 is opened or raised by rotating tube 116 in a first rotational direction. As tube 116 rotates upon its axis of rotation 184 that extends through the approximate center of tube 116 and axles 120, roller shade material 122 wraps around the cylindrical exterior surface of tube 116 and eventually around itself thereby raising the lower end 186 of roller shade material 122 and bottom bar 124.

Regardless of whether roller shade assembly 114 is a manual shade or a motorized shade, the roller shade material 122 is closed or lowered by rotating tube 116 in a second rotational direction, which is opposite the first rotational direction. As tube 116 rotates upon its axis of rotation 184 that extends through the approximate center of tube 116 and axles 120, roller shade material 122 to unwraps wraps from around the cylindrical exterior surface of tube 116 thereby lowering the lower end 186 of roller shade material 122 and bottom bar 124.

In this way, roller shade material 122 moves between a fully opened, or fully raised position wherein the lower end 186 and bottom bar 124 are positioned at, near, in, adjacent or as near as possible to the tube 116, brackets 126 and/or fascia150; and a fully closed, or fully lowered position wherein the lower end 186 and bottom bar 124 are positioned away from or as far away from the tube 116, brackets 126 and/or fascia150 as possible.

In this arrangement, as tube rotates 116 rotates, axles 120 are held by brackets 126 in a manner that constrains axles 120 while facilitating rotation of tube 116.

Any other configuration of roller shade assembly 114 is hereby contemplated for use. Alternatively, any other form of a window shade is hereby contemplated for use instead of and to replace roller shade assembly 114 in system 10, such as a roman shade, a venetian shade, a honeycomb shade, a vertical shade, a mini-blind, or any other form of a window shade. It is also worth noting that while only a single roller shade assembly 114 is shown in use with the system 10 (that is, one tube 116 and one roller shade material 122 is shown in use with a single fascia 150) any number of roller shade assemblies 114 are hereby contemplated for use with a single fascia 150. That is, two, three, four, five, six or more roller shade assemblies 114 may be used with a single fascia 150. In this way, multiple roller shade materials 122 may be independently raised and lowered independent of movement of opening or closing any drapery shade material 176 connected to the track 158 of fascia 150.

Brackets:

In the arrangement shown, as one example, roller shade and drapery window shade system 100 includes one or more brackets 126. Brackets 126 are formed of any suitable size, shape and design and are configured to hold axles 120 of roller shade assembly 114 while facilitating rotation of tube 116, as well as to facilitate attachment to a structure such as a wall or ceiling adjacent a window, as well as to facilitate attachment of fascia 150 to the system 10, among other features and functionalities.

In the arrangement shown, as one example, brackets 126 include an end wall 128. End wall 128 is formed of any suitable size, shape and design and is configured to be a central structural component of brackets 126 and facilitate strong and rigid connection to other components of bracket 126. In the arrangement shown, as one example, end wall 128 is a generally flat and planar member that when viewed from a side is generally square or rectangular in shape, however any other shape is hereby contemplated for use. In the arrangement shown, as one example, end wall 128 has an interior surface 190 and an opposing exterior surface 192.

In the arrangement shown, as one example, brackets 126 include a front wall 130. Front wall 130 is formed of any suitable size shape and design and is configured to facilitate connection of the front plate 154 of fascia 150 to bracket 126. In the arrangement shown, as one example, front wall 130 is a generally square or rectangular member that is connected to the front edge of end wall 128 and extends inward a distance therefrom in a generally flat and planar manner. In the arrangement shown, as one example, the plane of front wall 130 extends in a generally perpendicular manner to the plane formed by end wall 128. More specifically, in the arrangement shown, as one example, the outward edge 194 of front wall 130 connects to the forward edge of end wall 128, and the inward edge 196 of front wall 130 terminates in a free edge a distance inward from end wall 128. In the arrangement shown, as one example, the upper edge 198 of front wall 130 terminates in a free edge a short distance below the upper edge of end wall 128, and the lower edge 200 of front wall 130 terminates in a free edge a distance above the lower edge of end wall 128.

In the arrangement shown, as one example, brackets 126 include a rear wall 132. In the arrangement shown, as one example, rear wall 132 is similar if not identical to front wall 130, albeit connected to the rear edge of end wall 128 so as to facilitate reversible use of bracket 126. With that said, rear wall 132 is formed of any suitable size shape and design and is configured to facilitate connection of bracket 126 to a wall or other structural member in a rear mount application. In the arrangement shown, as one example, rear wall 132 is a generally square or rectangular member that is connected to the rear edge of end wall 128 and extends inward a distance therefrom in a generally flat and planar manner. In the arrangement shown, as one example, the plane of rear wall 132 extends in a generally perpendicular manner to the plane formed by end wall 128, and in a generally parallel manner to the plane formed by front wall 130. More specifically, in the arrangement shown, as one example, the outward edge 202 of rear wall 132 connects to the rearward edge of end wall 128, and the inward edge 204 of rear wall 132 terminates in a free edge a distance inward from end wall 128. In the arrangement shown, as one example, the upper edge 206 of rear wall 132 terminates in a free edge a short distance below the upper edge of end wall 128, and the lower edge 208 of rear wall 132 terminates in a free edge a distance above the lower edge of end wall 128.

In the arrangement shown, as one example, brackets 126 include a top wall 134. In the arrangement shown, as one example, top wall 134 is similar if not identical to front wall 130 and/or rear wall 132, albeit connected to the upper edge of end wall 128. With that said, top wall 134 is formed of any suitable size shape and design and is configured to facilitate connection of bracket 126 to a wall or ceiling or other structural member in a top mount application. In the arrangement shown, as one example, top wall 134 is a generally square or rectangular member that is connected to the upper edge of end wall 128 and extends inward a distance therefrom in a generally flat and planar manner. In the arrangement shown, as one example, the plane of top wall 134 extends in a generally perpendicular manner to the plane formed by end wall 128, as well as the planes of front wall 130 and rear wall 132. More specifically, in the arrangement shown, as one example, the outward edge 210 of top wall 134 connects to the upper edge of end wall 128, and the inward edge 212 of top wall 134 terminates in a free edge a distance inward from end wall 128. In the arrangement shown, as one example, the forward edge 214 of top wall 134 terminates in a free edge a short distance inward of the front edge of end wall 128, and the rearward edge 216 of top wall 134 terminates in a free edge a distance inward of the rear edge of end wall 128.

In the arrangement shown, as one example, brackets 126 include a bottom wall 136. In the arrangement shown, as one example, bottom wall 136 is formed of any suitable size shape and design and is configured to facilitate connection of the bottom plate 156 of fascia 150 to bracket 126. In the arrangement shown, as one example, bottom wall 136 is a generally square or rectangular member that is connected to the lower edge of end wall 128 and extends inward a distance therefrom in a generally flat and planar manner. In the arrangement shown, as one example, the plane of bottom wall 136 extends in a generally perpendicular manner to the plane formed by end wall 128, as well as the planes of front wall 130 and rear wall 132, and extends in a generally planar manner to the plane formed by top wall 134. More specifically, in the arrangement shown, as one example, the outward edge 218 of bottom wall 136 connects to the lower edge of end wall 128, and the inward edge 220 of bottom wall 136 terminates in a free edge a distance inward from end wall 128. In the arrangement shown, as one example, the forward edge 222 of bottom wall 136 terminates in a free edge a distance inward of the front edge of end wall 128, and the rearward edge 224 of bottom wall 136 terminates in a free edge a distance inward of the rear edge of end wall 128. In the arrangement shown, as one example, bottom wall 136 is a generally narrow member that is generally centrally positioned on the lower edge of end wall 128 so as to facilitate connection of fascia 150 thereto while also allowing roller shade assembly 114 to fit into brackets 126 from their bottom side.

In the arrangement shown, as one example, a lower receiver 226 is positioned on the forward side and rearward side of bottom wall 136. In the arrangement shown, as one example, lower receiver 226 is formed of a notch positioned at the intersection of the outward edge of 218 of bottom wall 136 and the forward edge 222 as well as the rearward edge 224 of bottom wall 136. In the arrangement shown, as one example, the notch of lower receiver 226 extends a distance upward into end wall 128 a distance from bottom wall 136. The lower receiver 226 on each side of bottom wall 136 is configured to receive a lower connection member 228 of similar size and shape positioned in the upper surface 230 of bottom plate 156 of fascia 150. In the arrangement shown, as one example, when viewed from the side lower receiver 226 is a generally square or rectangular shaped notch in end wall 128.

In the arrangement shown, as one example, an upper receiver 226 is positioned on inward side of the upper edge 198 of front wall 130 as well as on the inward side of the upper edge 206 of rear wall 132. In the arrangement shown, as one example, the forward upper receiver 232 is formed of a notch positioned at the intersection of the outward edge of 194 and upper edge 198 of front wall 130 and end wall 128. In the arrangement shown, as one example, the rearward upper receiver 232 is formed of a notch positioned at the intersection of the outward edge of 202 and upper edge 206 of rear wall 132 and end wall 128. In the arrangement shown, as one example, the notch of upper receiver 232 extends a distance downward into end wall 128 a distance from upper edge 198, 206. The upper receiver 232 on the inward side of front wall 130 and rear wall 132 is configured to receive an upper connection member 234 of similar size and shape connected to the upper edge 236 front plate 154 of fascia 150.

In the arrangement shown, as one example, end wall 128 of brackets 126 have a cut out section 238 positioned in the lower forward and lower rearward corners of end wall 128. In the arrangement shown, as one example, when viewed from the side, cut out sections 238 are generally square or rectangular with a generally flat and straight upper edge 240 that extends in a generally perpendicular manner to a generally flat and straight side edge 242. In the arrangement shown, as one example, upper edge 240 extends in a generally horizontal manner whereas side edge 242 extends in a generally vertical manner. In the arrangement shown, as one example, the lower end 200 of front wall 130 terminates at the upper edge 240 of the forward positioned cut out section 238, and the lower edge 208 of rear wall 132 terminates at the upper edge 240 of the rearward positioned cut out section 238. In the arrangement shown, as one example, the size and shape of cut out section 238 is configured to receive the interior peripheral shape of track 158 in fascia 150 as is further described herein.

In the arrangement shown, as one example, front wall 130, rear wall 132 and top wall 134 have a plurality of holes 244 therein. Holes 244 are formed of any suitable size, shape and design and are configured to facilitate the passage of fasteners through bracket 126 so as to facilitate installation of bracket 126 into a wall, ceiling or other structure. In the arrangement shown, as one example, front wall 130, rear wall 132 and top wall 134 each have three holes 244 therein, with the outward positioned holes 244 having a slot-shape to them that extends a length parallel to the length of the front wall 130, rear wall 132 or top wall 134 so as to facilitate a limited amount of fine adjustment, and a centrally positioned hole 244 that is generally circular in shape.

In the arrangement shown, brackets 126 are generally symmetric along a vertically extending line about the middle of end wall 128 equally spaced between front wall 130 and rear wall 132, and extending through the approximate middle of top wall 134 and bottom wall 136. In this way, brackets 126 are reversible in nature, meaning the same bracket 126 may be used on a left side or right side of a roller shade assembly 114.

In one arrangement, brackets 126 include an axle holder 138. Axle holder 138is formed of any suitable size, shape and design and is configured to receive and hold axle 120 of roller shade assembly 120 therein. As stated herein, there are countless forms of roller shade assemblies 114 manufactured by countless entities, many of which have unique configurations of axles 120. System 10 is useful with all of these makes and models of roller shade assemblies 114. To facilitate this functionality, in one arrangement, brackets 126 are what are known as “universal” brackets meaning that they are compatible with all makes and models of roller shade assemblies 114. To facilitate this, in one arrangement, brackets 126 and/or more specifically end walls 128 are configured to receive removable axle holders 138 that are compatible with various makes and models of roller shade assemblies 114. In one arrangement, these axle holders 138 are attached to the end wall 128 of brackets 126 by screws, bolts or any other fastening member or method. In this way, a single bracket 126 may be used with all roller shade assemblies 114 by merely swapping out the axle holder 138. Once axle holder 138is installed on the interior surface 190 of end wall 128, axle holder 138 receives and holds an axle 120 of roller shade assembly 114.

Center Bracket:

In the arrangement shown, as one example, roller shade and drapery window shade system 100 includes one or more center brackets 140. Center brackets 140 are formed of any suitable size, shape and design and are configured to hold and provide additional support for fascia 150 at positions between brackets 126, especially in applications where a longer fascia 150 is used with longer roller shade assemblies 114.

In the arrangement shown, as one example, center brackets 140 are formed of a generally flat and narrow member that includes a rear wall 142 that connects to a top wall 144 that connects to a front wall 146 that connects to a bottom wall 148. Center brackets 140 extend a width between opposing sides 246.

In the arrangement shown, as one example, center brackets 140 include a rear wall 142. Rear wall 132 is formed of any suitable size, shape and design and is configured to facilitate connection of center bracket 140 to a wall or other structural member in a rear mount application. In the arrangement shown, as one example, rear wall 142 is a generally square or rectangular member that has a free lower end 248 that connects at its upper end 250 to the rearward edge of top wall 144. In the arrangement shown, as one example, rear wall 142 extends between sides 246 and between lower end 248 and upper end 250 in a generally flat and planar manner. In the arrangement shown, as one example, the plane of rear wall 142 extends in a generally perpendicular manner to the plane formed by top wall 144 and bottom wall 148, and extends in a generally parallel manner to the plane formed by front wall 146. In the arrangement shown, as one example, rear wall 142 includes a plurality of holes 244 similar to if not identical to holes 244 in rear wall 132 of bracket 126.

In the arrangement shown, as one example, center brackets 140 include a top wall 144. Top wall 144 is formed of any suitable size shape and design and is configured to facilitate connection of center bracket 140 to a wall or other structural member in a top mount application. In the arrangement shown, as one example, top wall 144 is a generally square or rectangular member that connects at its rearward end to the upper end 250 of rear wall 142 and connects adjacent its forward end to the upper end 252 of front wall 146.

More specifically, in the arrangement shown, as one example, an upper receiver 254 is positioned between the forward end 256 of the top wall 144 and the upper end 252 of front wall 146. In the arrangement shown, as one example, the upper receiver 254 is formed of a notch positioned at the intersection of the forward end 256 of the top wall 144 and the upper end 252 of front wall 146. In the arrangement shown, as one example, when viewed from the side, upper receiver 254 forms a generally square or rectangular shaped notch or groove. In the arrangement shown, as one example, the peripheral shape of upper receiver 254 of center bracket 140 is similar to if not identical to the upper receiver 232 in brackets 126 in size, shape, design and placement. In this way, when brackets 126 and center brackets 140 are installed in alignment with one another the grooves of upper receiver 232 of brackets 126 and the grooves of upper receiver 254 of center brackets 140 are aligned such that fascia 150 may be installed across all brackets 126 and center brackets 140.

In the arrangement shown, as one example, top wall 144 extends between sides 246 and between its rearward end and forward end 256 in a generally flat and planar manner. In the arrangement shown, as one example, the plane of top wall 144 extends in a generally perpendicular manner to the plane formed by rear wall 142 and front wall 146, and extends in a generally parallel manner to the plane formed by bottom wall 148. In the arrangement shown, as one example, top wall 144 includes a plurality of holes 244 similar to if not identical to holes 244 in of bracket 126.

In the arrangement shown, as one example, center brackets 140 include a front wall 146. Front wall 146 is formed of any suitable size shape and design and is configured to facilitate connection of front plate 154 of fascia 150 to center bracket 140. In the arrangement shown, as one example, front wall 146 is a generally square or rectangular member that connects adjacent its upper end 252 to the forward end 256 of top wall 144 at upper receiver 254. The lower end 258 of front wall 146 connects to the forward end of bottom wall 148. In the arrangement shown, as one example, front wall 146 extends between sides 246 and between its upper end 252 and its lower end 258 in a generally flat and planar manner. In the arrangement shown, as one example, the plane of front wall 146 extends in a generally perpendicular manner to the plane formed by top wall 144 and bottom wall 148, and extends in a generally parallel manner to the plane formed by rear wall 142. In the arrangement shown, as one example, front wall 146 does not include any holes 244 like rear wall 142 and top wall 144, however it is hereby contemplated to include a plurality of holes 244 in front wall 146 as well. In the arrangement shown, the distance between the upper end 252 of front wall 146 and the lower end 258 of front wall 146 is approximately equal to the length of the interior surface of front plate 154 of fascia 150 between its upper edge and the top of the track 158, such that when fascia 150 is installed on center bracket 140 the forward facing surface of front wall 146 is in generally flat and flush alignment to the rearward facing surface of the front plate 154 of fascia 150, as is further described herein.

In the arrangement shown, as one example, center brackets 140 include a bottom wall 148. Bottom wall 148 is formed of any suitable size shape and design and is configured to facilitate connection of fascia 150 to center bracket 140 by serving as a stop surface and engagement point for fascia 150 upon installation. In the arrangement shown, as one example, bottom wall 148 is a generally square or rectangular member that connects adjacent its forward end to the lower end 258 of front wall 146. Bottom wall 148 extends rearward from its connection to the lower end 258 of front wall 146 and terminates in a free rearward end 260. In the arrangement shown, as one example, bottom wall 148 extends between sides 246 and between its forward end and rearward end 260 in a generally flat and planar manner. In the arrangement shown, as one example, the plane of bottom wall 148 extends in a generally perpendicular manner to the plane formed by rear wall 142 and front wall 146, and extends in a generally parallel manner to the plane formed by top wall 144. In the arrangement shown, as one example, bottom wall 148 does not include any holes 244 like rear wall 142 and top wall 144 due to its substantially shorter length between its forward end and rearward end 260, however it is hereby contemplated to include a one or a plurality of holes 244 in bottom wall 148 as well. In the arrangement shown, the length between its forward end and rearward end 260 of bottom wall 148 is short so as to not have bottom wall 148 protrude substantially into the hollow interior 262 formed within the center of center bracket 140 as this could interfere with the bottom-up installation of roller shade assemblyl14. In the arrangement shown, as one example, when fascia 150 is installed on center bracket 140, the bottom surface of bottom wall is in generally flat and flush alignment to upper interior surface of the track of fascia 150, as is further described herein.

In the arrangement shown, as one example, center bracket 140 is formed of a single, continuous, solid and monolithic member that must then be installed as a single member. In some arrangements, installing center bracket 140 as a single solid member poses problems as the roller shade assembly 114 needs to be installed after the center bracket 140 is installed. That is, the rearward extension of bottom wall 148 of center bracket 140 can interfere with and/or prevent the upward installation of roller shade assembly 114 into the hollow interior of center bracket 140.

As such, in an alternative arrangement, to alleviate this problem, center bracket 140 is formed of multiple parts that join together to form center bracket 140 that perform the functionality of center bracket 140 as is described herein. In one arrangement, center bracket 140 is formed of a rear section that includes rear wall 142 and at least a portion of a top wall 144, and a front section that includes at least a portion of a top wall 144 as well as front wall 146 and bottom wall 148. In one arrangement, center bracket 140 is formed of a rear section that includes rear wall 142, top wall 144, and at least a portion of front wall 146, and a front section that includes at least a portion of a front wall 146 as well as bottom wall 148. In this arrangement, the rear section and front section of this multi-part center bracket 140 connect to one another in a manner that allows the rear section to be installed into the wall or structure, then the roller shade assembly 114 is installed, then the front section of the center bracket 140 is installed onto and/or moved into place on the rear section. In this arrangement, the rear section and front section of center bracket 140 may be locked onto one another and fixed in place by a locking arrangement such as a spring loaded member, a set screw, a bolt, or any other locking or affixing arrangement. In one arrangement, the front section and rear section of the multi-part center bracket 140 connect to one another in a sliding rail and groove arrangement wherein one of the rear section and front section slides over the other of the rear section and front section.

In another arrangement, multi-part center bracket 140 is formed of any number of parts, such as three, four, or more parts that connect together to form the whole of center bracket 140. In another arrangement, center bracket 140 may include one or more hinges that facilitate movement of portions of center bracket 140 out of the way while roller shade assembly 114 is installed. In this arrangement, center bracket 140 may be locked in a closed positon by way of a spring loaded member, a set screw, a bolt, or any other locking or affixing arrangement after the roller shade assembly 114 is installed.

Any other arrangement or configuration of center bracket 140 is hereby contemplated for use.

Fascia & Track:

In the arrangement shown, as one example, roller shade and drapery window shade system 100 includes a fascia 150. Fascia 150 is formed of any suitable size, shape and design is configured to enclose the roller shade assembly 114 and in doing so provide an improved aesthetic appearance to the system 10, fascia 150 also serves to provide for an attachment point for drapery shade material 176 in track 158.

In the arrangement shown, as one example, fascia 150 is formed of a single extruded member that extends a length between opposing ends 152 in a monolithic and solid and consistent manner from end 152 to end 152. In the arrangement shown, as one example, fascia 150 has a front plate 154 and a bottom plate 156. In the arrangement shown, as one example, front plate 154 and bottom plate 156 are generally flat and straight members with the plane formed by the front plate 154 extending at approximately a perpendicular manner to the plane formed by bottom plate 156.

Front plate 154 extends a length from upper edge 236 to lower edge 264 and has a generally flat and straight front surface 266 that extends in approximate parallel alignment to a generally flat and straight rear surface 268. Upper connection member 234 is connected to the upper edge 236 of front plate 154. In the arrangement shown, as one example, when viewed from the side, upper connection member 234 is a generally hook shaped member that extends rearward and downward at an angle. Upper connection member 234 is configured to be hooked onto, or engaged with, upper receiver 232 of brackets 126 as well as upper receiver 254 of center brackets 140. That is, as is shown in the figures, upper connection member 234 is configured to reach over and around the upper edge 198 of front wall 130 of brackets 126 with the lower end of upper connection member 234 being received within the groove formed by the upper receiver 232; similarly, upper connection member 234 is configured to reach over and around the upper edge 252 of front wall 146 of center brackets 140 with the lower end of upper connection member 234 being received within the groove formed by the upper receiver 254. In this way, upper connection member 234 secures the upper end of fascia 150 to brackets 126 and center brackets 140 in a quick, easy and secure manner.

Bottom plate 156 extends a length from the lower edge 264 of front plate 154 rearward to the rearward end 260 and has a generally flat and straight upper surface 230 that extends in approximate parallel alignment to a generally flat and straight lower surface 270. Lower connection member 228 is connected to the upper surface 230 of bottom plate 156 a distance inward from rearward end 260 of bottom plate. In the arrangement shown, as one example, when viewed from the side, lower connection member 228 is a generally square or rectangular shaped member that extends upward a distance from the upper surface 230 of bottom plate 156 in a generally square and perpendicular manner to the plane formed by bottom plate 156. Lower connection member 228 is configured to be received within, snapped into, or engaged with, lower receiver 226 of brackets 126. That is, as is shown in the figures, lower connection member 228 is configured to naturally fit upward and into the downward facing groove of lower receiver 226 with close and tight tolerances. In this way, lower connection member 228 secures the rearward end 260 of bottom plate 156 of fascia 150 to brackets 126 in a quick, easy and secure manner.

In the arrangement shown, as one example, track 158 is positioned at the intersection of front plate 154 and bottom plate 156. In the arrangement shown, when viewed from the side, track 158 includes a top wall 160 that connects to and extends rearward from the rear surface 268 of front plate 154. The rearward end of top wall 160 connects to the upper end of rear wall 162 of track 158. Rear wall 162 of track 158 extends downward from its connection to the rearward end of top wall 160 until it engages the upper surface 230 of bottom plate 156. In the arrangement shown, as one example, the planes formed by top wall 160 and rear wall 162 extend in a generally perpendicular alignment to one another, and the plane formed by top wall 160 extends in a generally perpendicular manner to the plane of front plate 154 and in generally parallel manner to the plane formed by bottom plate 156, and the plane formed by rear wall 162 extends in a generally perpendicular manner to the plane formed by bottom plate 156 and in a generally parallel manner to the plane formed by front plate 154. In this way, with the combination of the front plate 154 and bottom plate 156 of fascia 150 and the top wall 160 and rear wall 162 of track 158 a generally square or rectangular hollow interior 164 is formed. In the arrangement shown, as one example, a slot 166 is generally centrally positioned with the hollow interior 164 of track 158. Any other shape or form of tracks 158 is hereby contemplated for use. In addition, while only a single track 158 is shown in fascia 150 any number of tracks 158 are hereby contemplated for use in fascia 150 such as two, three, four, five, six or more.

Carriers and Drapery Shad Material:

In the arrangement shown, as one example, roller shade and drapery window shade system 100 includes a plurality of carriers 168. Carriers 168 are formed of any suitable size, shape and design are configured to connect drapery shade material 176 to track 158 and facilitate sliding opening and closing motion of the drapery shade material 176 within track 158.

In the arrangement shown, as one example, carriers 168 include a roller assembly 170 that is configured to roll within the hollow interior 164 of track 158. Roller assembly 170 is formed of any suitable size, shape and design. In the arrangement shown, as one example, roller assembly 170 includes a pair of wheels spaced apart from one another by an axle 272 that extends between and connects to the wheels. Roller assembly 170 is configured to fit within the hollow interior 164 of track 158 and rolls along a length of track 158 to facilitate opening and closing of the drapery shade material. In the arrangement shown, as one example, the wheels of roller assemblies roll on the upper surface of the bottom plate 156 adjacent each side of slot 166. In the arrangement shown, as one example, the exterior sides of wheels of roller assemblies 170 are in flat and flush alignment to the interior surface of front plate 154 on one side and the interior surface of rear wall 162 on the opposite side. In this way, the close tolerances between roller assemblies 170 and the sides of track 158 maintain alignment of roller assemblies 170 within track 158. In the arrangement shown, as one example, carriers 168 include an arm 172 that is configured to connect to roller assembly 170 to connector 174. Arm 172 is formed of any suitable size, shape and design. In the arrangement shown, as one example, arm 172 is an elongated member that connects at its upper end to approximate middle of roller assembly 170 at or around axle 272 and extends downward therefrom and connects at or around the lower end of arm 172 to connector 174. In this way, arm 172 connects roller assembly 170 to connector 174. Arm 172 also helps to maintain alignment of carrier 168 as arm 172 extends through slot 166 thereby preventing rotation or misalignment of carrier 168 with respect to track 158 as carrier 168 slides along track 158. In the arrangement shown, as one example, carriers 168 include a connector 174 that is configured to connect carrier 168 to drapery shade material 176. Connector 174 is formed of any suitable size, shape and design. In the arrangement shown, as one example, connector 174 is formed of hook member that connects at its upper end to the lower end of arm 172 and connects at its lower end to drapery shade material 176.

In the arrangement shown, as one example, roller shade and drapery window shade system 100 includes at least one drapery shade material 176. Drapery shade material 176 is formed of any suitable size, shape and design and is configured to be opened and closed, sliding movement along the length of fascia 150 while providing an aesthetically pleasing visual appearance while allowing a desirable amount of light into the building. In the arrangement shown, as one example, drapery shade material 176 is a panel of fabric or material that extends a lateral width between opposing sides 178 and extends a vertical height between an upper end 180 and a lower end 182. In the arrangement shown, as one example, the upper end 180 of drapery shade material 176 is connected to connectors 174 of carriers 168 which are spaced a distance along the length of drapery shade material 176.

Drapery shade material 176 may be what is known as a ripple fold drapery, a pinch pleat drapery, a tailored pleat drapery, an inverted pleat drapery, a goblet drapery, a grommet drapery, a pocket drapery, a cubicle drapery or any other form of a drapery.

A single drapery shade material 176 may be attached to fascia 150 and in this arrangement system 10 is a side opening and closing drapery. In this arrangement, drapery shade material 176 opens and closes by sliding one side of 178 of drapery shade material 176 toward or away from an end 152 of fascia 150. In this way, in a closed state, carriers 168 are spaced away from one another along the length of fascia 150 as the drapery shade material 176 covers the length of fascia 150 with drapery shade material 176 in an expanded configuration, and in an open state, carriers 168 are compressed against one another toward one end 152 of fascia 150 as the drapery shade material 176 covers only a small portion of the length of fascia 150.

A pair of drapery shade material 176 may be attached to fascia 150 and in this arrangement system 10 is a center opening or center closing drapery. In this arrangement the opposing drapery shade material 176 open and close by sliding one side of 178 of drapery shade material 176 toward or away from one another and toward or away from an end 152 of fascia 150. In this way, in a closed state, carriers 168 are spaced away from one another along the length of fascia 150 as the drapery shade materials 176 cover the length of fascia 150 with drapery shade materials 176 in an expanded configuration, and in an open state, carriers 168 are compressed against one another toward one end or the center 152 of fascia 150 as the drapery shade materials 176 covers only a small portion of the length of fascia 150.

Installation of Brackets and Center Brackets:

In the arrangement shown, as one example, brackets 126 are installed in a wall or ceiling or other structural member by passing fasteners through holes 144 in either the end wall 128, rear wall 132 and/or top wall 134. Installed brackets 126 are configured to be placed at the desired distance away from each other that suits the length of the corresponding roller shade assembly 114. Any number of brackets 126 and roller shade assemblies 114 may be installed for use with a single fascia 150. When there are long expansions of fascia 150 and/or for additional strength and rigidity, center brackets 140 are installed between opposing brackets 126 at desired positions. Center brackets 140 may be installed by passing fasteners through holes 244 in the rear wall 142 and/or the top wall 144. Center brackets 140 may be installed before or after fascia 150 is attached to brackets 126.

Installation of Roller Shade Assemblies:

In the arrangement shown, as one example, once brackets 126 are installed, roller shade assemblies 114 are installed between opposing brackets 126. In the arrangement shown, as one example, this is accomplished by inserting axles 120 positioned at each end of tube 116 into the axle holder 138 in the end wall 128 of brackets 126. In this way, brackets 126 hold axles 120 while supporting and allowing for rotation of tube 116 to open and close the roller shade material 122 connected to tube 116. This installation is repeated for each roller shade assembly 114.

Installation of Fascia on Brackets and Center Brackets:

In the arrangement shown, as one example, upper connection member 234 of fascia 150 is easily installed into the grooves formed by upper receiver 232 of brackets 126 and the upper receiver 254 of center brackets 140. To facilitate this installation, the fascia 150 is raised up to brackets 126 and center brackets 140, which are already installed in the wall or ceiling of a structure. The rear surface 268 of front plate 152 is angled slightly toward brackets 126 and center brackets 140 as the upper edge 236 of front plate 154, or interior edge of upper connection member 234 is slid upward along the front surface of front wall 130 of brackets 126 and the front wall 146 of center brackets 140. Once the lower end of upper connection member 234 passes the upper edge 198 of brackets 126 and the upper edge 252 of center brackets 140, fascia 150 is pushed rearward toward brackets 126 and center brackets 140 thereby causing upper connection member 234 to be received within the groove of upper receiver 232 of brackets 126 and the upper receiver 254 of center brackets 140 thereby securing the upper end 236 of fascia 150 to brackets 126 and center brackets 140.

Once the upper end 236 of front plate 154 of fascia 150 is secured to brackets 126 and center brackets 140, next the bottom plate 156 is secured to brackets 126 and center brackets 140. This is accomplished in the following manner. With the upper connection member 234 received within the groove of upper receiver 232 of brackets 126 and the upper receiver 254 of center brackets 140, the bottom plate 156 is rotated toward brackets 126 and center brackets 140. In doing so, the upper edge of lower connection member 228 slides over and past the bottom surface of bottom wall 136 of brackets 126 until the lower connection member 228 of bottom plate 156 slides past the rearward edge 224 at which point the lower connection member 228 naturally snaps into the groove of lower receiver 226 under the bias of fascia 150.

That is, fascia 150 and brackets 126 are sized and shaped to fit snugly and frictionally with one another in a tight and locking arrangement. When fascia 150 is installed on brackets 126 the upper connection member 234 is snugly received within the groove of upper receiver 232 of brackets 126, the rear face 268 of front plate 154 of fascia 150 is in flat and flush engagement with the forward face of front wall 130 of brackets 126, the track 158 is received within cutout section 238 in the forward side of brackets 126 with the upper surface of top wall 160 of track 158 engaged with the upper edge 240 of cut out section 238 and the rear wall 162 of track 158 engaged with the side edge 242 of cut out section 238, and the upper surface 230 of bottom plate 156 is in flat and flush engagement with the lower surface of bottom wall 136 of brackets 126. In this position, there is a tension, or spring bias, forcing the lower connection member 228 into the groove of lower receiver 226. Or, said another way, the front plate 154 and bottom plate 156 of fascia 150 are sized and shaped to have to elastically stretch or bend in order to facilitate installation onto brackets 126. As such, when fascia 150 is installed onto brackets 126, fascia 150 securely attaches and holds onto brackets 126. This prevents rattling and relative motion between brackets 126 and fascia 150 and provides a secure and strong connection. To install fascia 150 onto brackets 126 force must be applied when bottom plate 156 is rotated onto brackets 126 that overcomes the spring bias of the fascia. In this way, fascia 150 is quickly and easily installed on brackets 126 in a secure manner without the use of any tools.

In the arrangement shown, as one example, when fascia 150 is installed on to brackets 150, the lower end of upper connection member 234 engages the upper surface of the groove of upper receiver 232 of brackets 126 under tension and/or the lower surface of upper connection member 234 engages the upper surface of upper edge 198 of front wall 130 of brackets 126 under tension. Similarly, in the arrangement shown, as one example, when fascia 150 is installed on to brackets 150, the upper end of lower connection member 228 engages the upper surface of the groove of lower receiver 226 of brackets 126 under tension and/or the forward facing surface of lower connection member 228 engages the rearward edge 224 of bottom wall 136 of brackets 126 under tension. In this way, and with the engagement of these components, fascia 150 is securely held in place on brackets 126 thereby preventing fascia 150 from unintentionally coming off of brackets 126, even under extreme conditions.

Similarly, to remove fascia 150 from brackets 126, force is applied to the rearward end 260 of bottom plate 156 pulling the bottom plate 156 downward. As bottom plate 156 is pulled downward, the natural spring bias of fascia 150 is overcome thereby pulling lower connection member 228 of bottom plate 156 out of the groove of lower receiver 226 of brackets 126. Once lower connection member 228 of bottom plate 156 is free from lower receiver 226, the bottom plate 156 of fascia 150 is rotated away from brackets 126 while upper connection member 234 remains in upper receiver 232 of brackets 126. In doing so, bottom plate 156 clears brackets. Once bottom plate 156 clears brackets 126, fascia 150 may be raised slightly thereby removing upper connection member 234 from upper receiver 232 of brackets 126 and the fascia 150 may be fully removed from engagement with brackets 126. In this way, fascia 150 is quickly and easily removed from its strong and secure connection to brackets 126 by hand without the use of tools.

Fascia 150 is similarly installed onto and removed from center brackets 140 in a similar if not identical manner. In the arrangement shown, as one example, one difference is that when fascia 150 is installed upon center brackets 140 the bottom surface of bottom wall 148 of center brackets 140 engages the upper surface of top wall 160 of track 158. In this way, the engagement between bottom wall 148 of center brackets 140 with the upper surface of top wall 160 of track 158 serves as a stop surface. That is, the engagement between bottom wall 148 of center brackets 140 with the upper surface of top wall 160 of track 158 causes a tension between upper connection member 234 and track 158 helping to securely hold fascia 150 onto center brackets 140, much in the same way that spring bias of fascia 150 forces lower connection member 228 into the groove of lower receiver 226.

Installation of Drapery Shade Material:

Drapery shade material 176 may be installed on fascia 150 either before or after installation of fascia on brackets 126 and/or center brackets 140. In the arrangement shown, as one example, a plurality of carriers 168 are installed into the hollow interior 164 of track 158 by aligning the roller assembly 170 of carriers 168 with an open end 152 of track 158 and inserting the roller assembly 170 within the hollow interior 164 while the lower end of arm 172 protrudes through slot 166 in the lower end of track 158. Once the desired number of carriers 168 are installed to match the length of the track 158, in one arrangement the ends 152 of track 158 is closed or stopped by the insertion of a cover or other stop member that prevents the carriers 168 from rolling out the end 152 of track 158. In one arrangement, wherein when two drapery shade materials 176 are used a stop member may be inserted at the center of track 158, or at any portion along track 158 to stop one drapery shade material 176 from engaging the other drapery shade material 176.

Carriers 168 may be connected to drapery shade material 176 before or after carriers 168 are installed into track 158. In the arrangement shown, as one example, carriers 168 are connected to drapery shade material 176 by inserting the lower end of connector 174, which in the arrangement shown is a hook, through the material itself or through a hole or grommet in the drapery shade material 176 at or near its upper end 180.

Strength of System:

One benefit of the system 10 is that it is configured to be extremely strong and prevents unintentional separation of fascia 150 from brackets 126 even under the most extreme conditions, such as a child pulling downward on the drapery shade material 176. This is because there is no moment, or practically no moment, on the fascia 150 when the drapery shade material 176 is pulled on. This is because the upper connection member 234 of fascia 150 is hooked onto and over the upper edge 198 of front wall 130 of brackets 126 and the interior surface 268 of front plate 154 extends in flat and flush alignment to the forward surface of front wall 130 of brackets 126. This is while the lower connection member 228 of bottom plate 156 is securely held in the lower receiver 226 of brackets 126, thereby holding fascia 150 in a manner that prevents rotation of fascia 150 upon brackets 126. There is no way, or practically no way to make the lower connection member 228 of bottom plate 156 come out of the lower receiver 226 of brackets 126 by pulling on or otherwise interacting with drapery shade materia1176 which is attached to track 158. This is because pulling down on the drapery shade material 176 causes an increase in strength in the connection between upper connection member 234 and upper receiver 232, and pulling forward on the drapery shade material 176 causes an increase in strength in the connection between the forward facing surface of lower connection member 228 and the rearward edge 224 of bottom wall 136. As such, pulling downward and/or forward on the drapery shade material 176 acts to strengthen the connection between brackets 126 and fascia 150. The strength of this connection is further aided by the long rearward extension of bottom plate 156. Again, to remove lower connection member 228 from lower receiver 226 due to the natural bias of fascia 150 a downward force must be applied at or near the rearward end 260 of bottom plate 156 which is impossible or practically impossible to accomplish by pulling on drapery shade material 176. As such, fascia 150 of the system 10 presented cannot unintentionally be dislodged from brackets 126 which increases the safety of the system 10. That is, a great benefit in strength and safety is provided by positioning the upper connection member 234 a great and/or maximum distance above the track 158, and a great benefit in strength and safety is provided by simultaneously positioning the lower connection member 228 a great and/or maximum distance rearward of track 158.

In practice, even the strongest drapery shade materials 176 will tear, or alternatively carriers 168 will fail, before effecting the engagement between fascia 150 and brackets 126. The security of this attachment is enhanced by the addition of one or more center brackets 140.

In Operation:

Once roller shade and drapery window shade system 10, 100 is assembled the system 10, 100 facilitates endless ways of limiting light into a room and setting an aesthetically pleasing appearance by raising or lowering the roller shade material 122 of roller shade assemblies 114 by rotating tube 116, and by laterally opening and closing drapery shade materials 176 by sliding carriers 168 along a length of track 158.

By providing both roller shade materials 122 as well as drapery shade materials 176 in a single, compact, easy to install, strong, safe, convenient, easy to operate and aesthetically pleasing configuration, the a better window shade is presented as users may select the optimum material for roller shade material 122 and the optimum material for drapery shade material 176. That is, because the user gets to select two shade materials for use in a single window shade system 10, 100 the user may select an opaque material and a sheer material meaning the user does not have to sacrifice. Then, the user may adjust these two shade materials to the optimum positions depending on the conditions at the time. In this way, the system 10, 100 presented herein provides a substantially improved window shade system 10.

One of the benefits of the system 10, 100 presented herein is that the track 158 occupies “dead space” in the brackets 126. That is, with roller shade assembly 114 inherently having a circular cross-sectional shape, and with the brackets 126 having a generally square or rectangular shape, track 158 occupies the “dead space” at the forward lower corner of the brackets 126. In this way, the addition of track 158 does not interfere with operation of the roller shade assembly 114. In this way, the addition of track 158 does not make the system 10, 100 dimensionally larger. In this way, the addition of track 158 does not require additional parts or pieces. In this way, the addition of track 158 does not require additional assembly. In this way, the addition of track 158 is a seamless addition that does not increase complexity of the system, does not substantially increase cost, and does not substantially affect the overall appearance of the system 10. 100. In fact, there is no need or requirement to install drapery shade material 176 to track 158. In fact, when no drapery shade material 176 is installed, the presence of track 158 is practically unnoticeable as all that is visible is the narrow and unnoticeable slot 166 in the bottom plate 156.

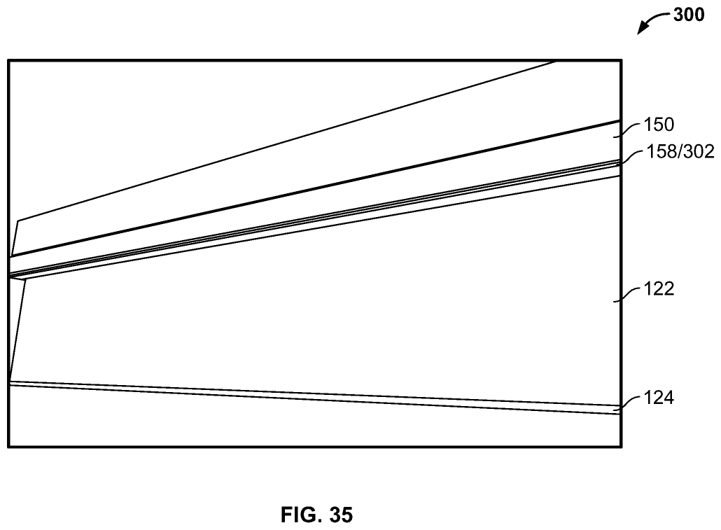

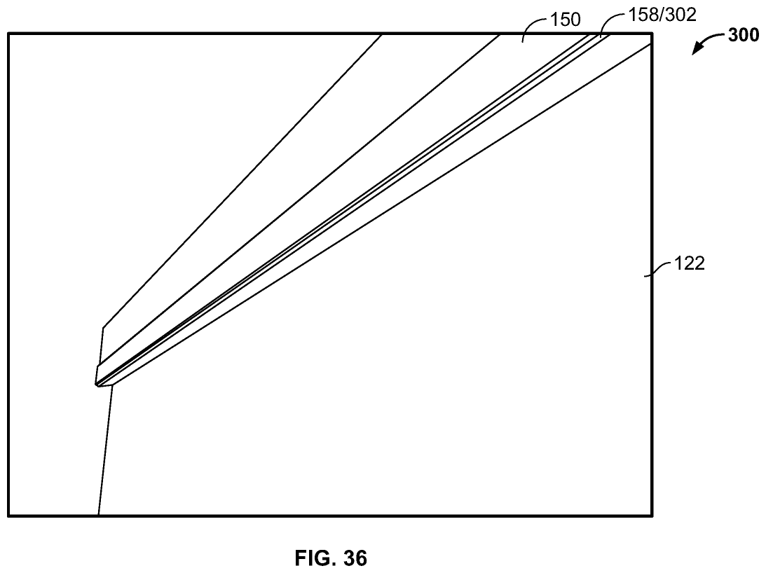

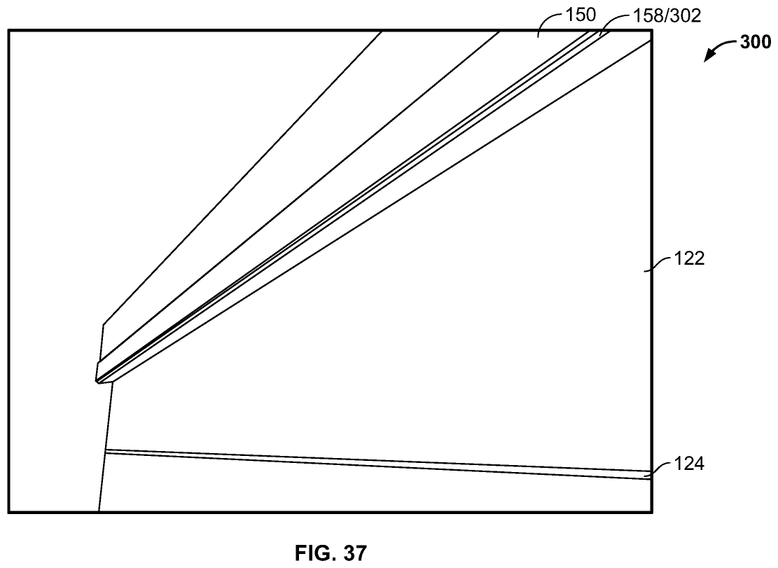

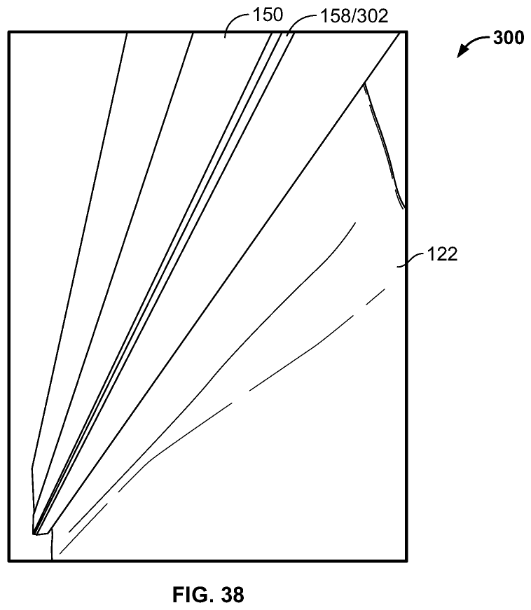

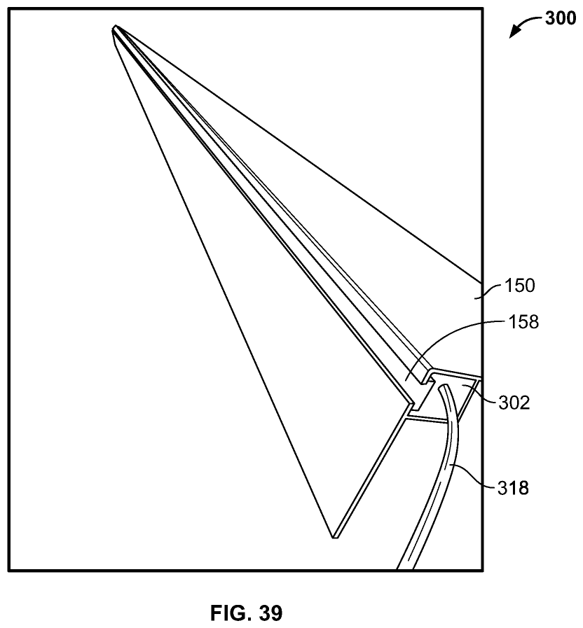

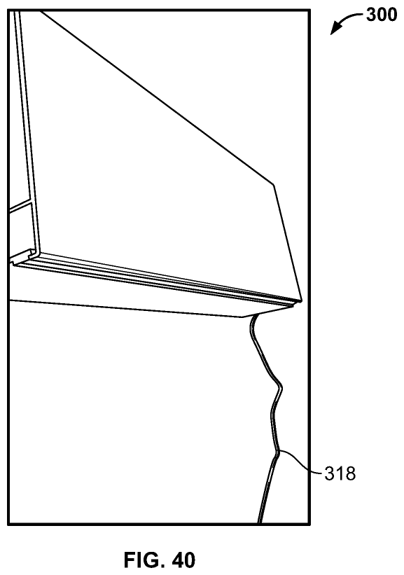

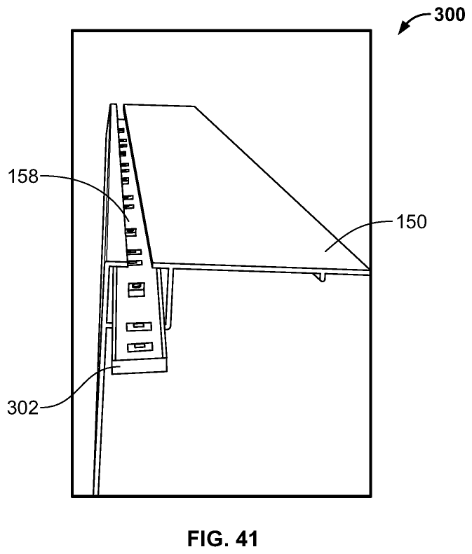

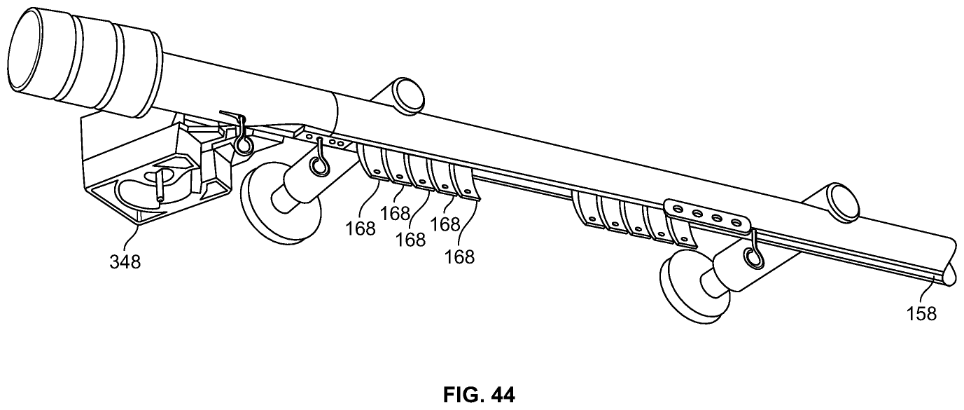

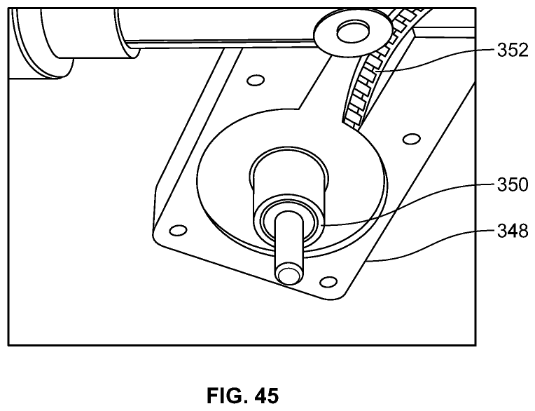

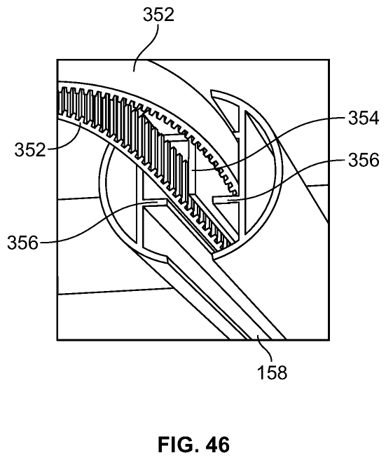

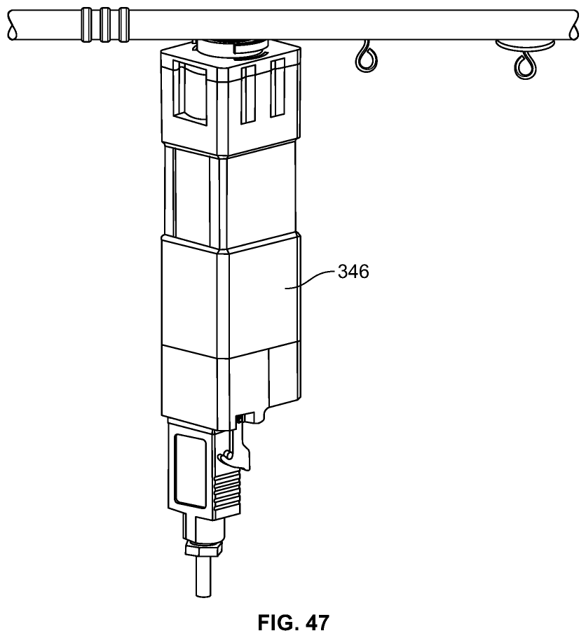

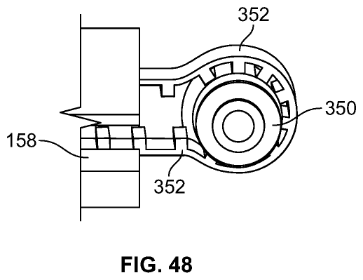

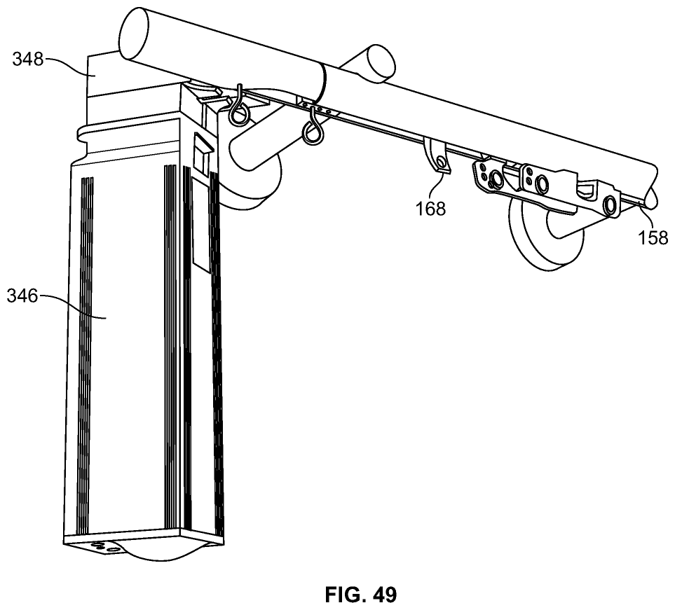

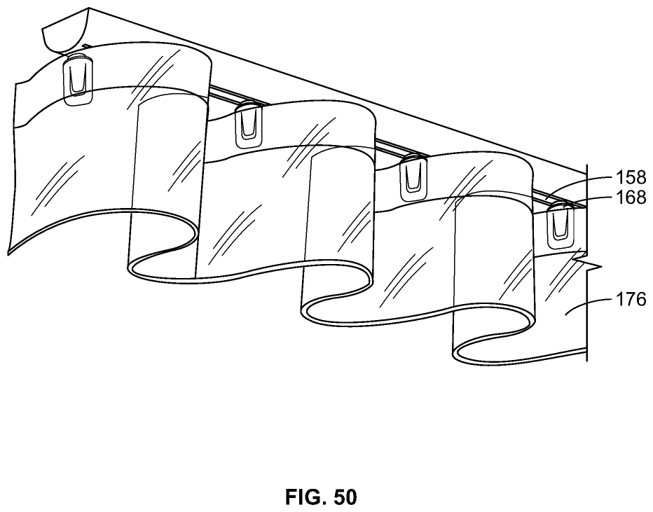

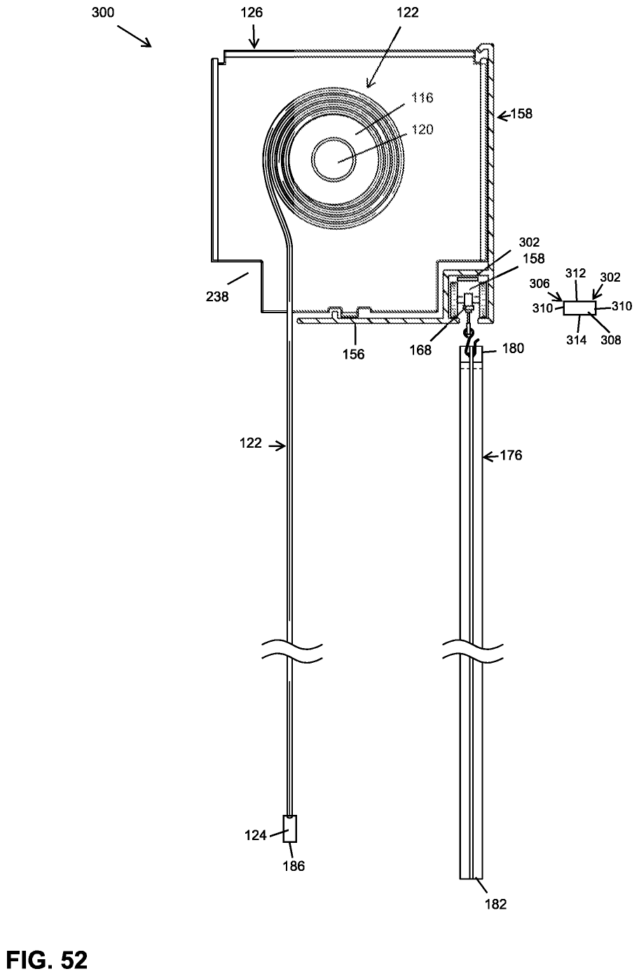

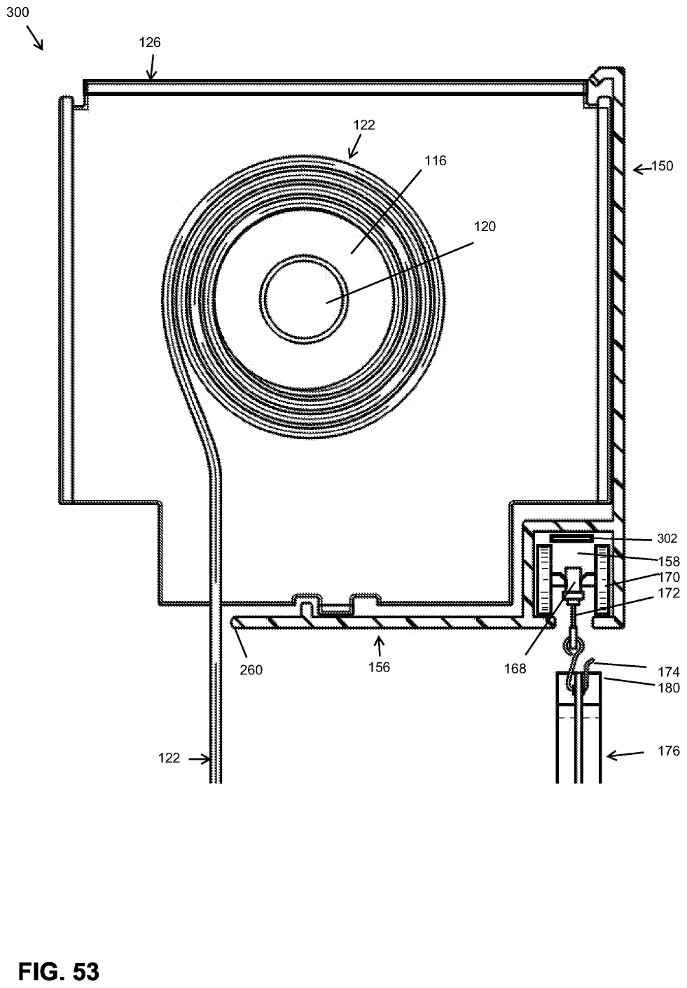

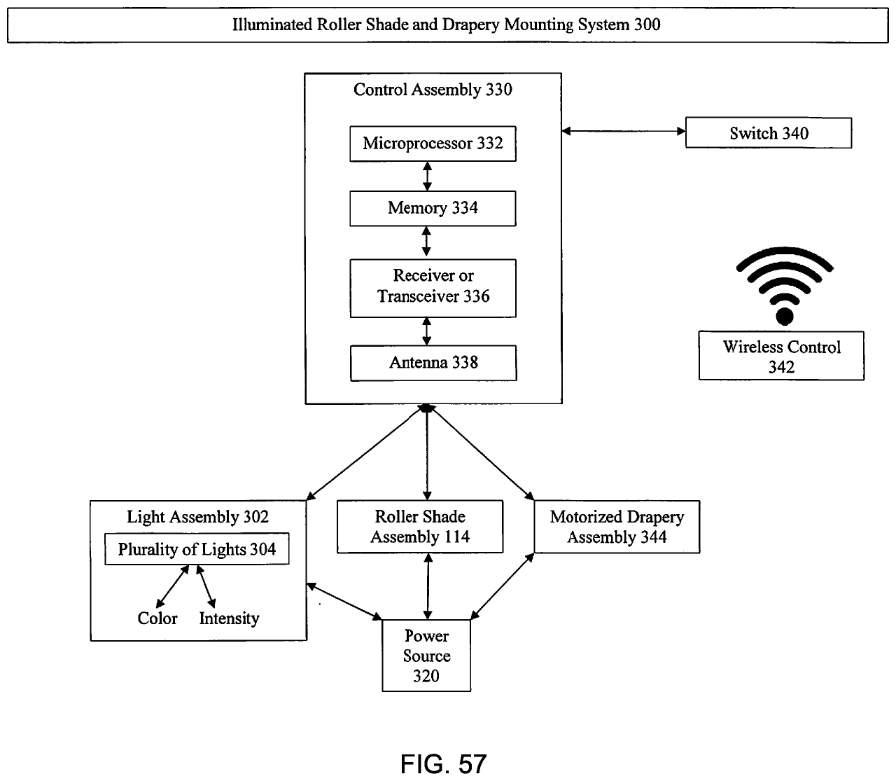

FIGS. 35-57:

Alternative Arrangement: Illuminated Roller Shade and Drapery Mounting System:

With Reference to FIGS. 35-57, demonstrative alternative embodiments are presented that include one or both of the modifications and improvements of illumination as well as motorization of the drapery shade material 176. These embodiments may be referred to as illuminated roller shade and drapery mounting system 300, or simply system 300. It is intended that all of the teaching presented previously with respect to other embodiments applies to the alternative embodiments presented in FIGS. 35-57, unless specifically stated otherwise.

Light Assembly: In the arrangement shown, as one example, illuminated roller shade and drapery mounting system 300 includes a light assembly 302. Light assembly 302 is formed of any suitable size, shape and design and is configured to illuminate and project light from system 300. Any form of a light emitting and/or light generating device is hereby contemplated for use as light assembly 302.

In the arrangement shown, as one example, light assembly 302 is formed of a plurality of lights 304 that are electrically connected together. In the arrangement shown, as one example, the plurality of lights 304 are held together by, and/or contained within, a housing 306. In the arrangement shown, as one example, light assembly 302 is a light strip. This light strip of light assembly 302 may be rigid in nature, such as housing 306 being a rigid plastic housing or the like. Alternatively, this light strip of light assembly 302 may be flexible in nature, such as housing 306 being formed of a flexible plastic or fabric material or the like. In an alternative arrangement, no housing 306 is used and instead the plurality of lights 304 are used that are unconstrained by a housing 306. Although, the use of a housing 306 to constrain a plurality of lights 304 may make installation of the plurality of lights 304 quicker, easier and more repeatable, may protect the plurality of lights 304 from damage, may increase the durability and longevity of the system 300, as well as provide many other benefits.

In the arrangement shown, as one example, housing 306 extends a length between opposing ends 308 and extends a width between opposing sides 310. In the arrangement shown, as one example, light assembly 302 has a relatively narrow depth between an opposing upper surface 312 and a lower surface 314. In the arrangement shown, as one example, light assembly 302 is formed of a single housing 306 that extends most of the length of fascia 150, if not all of the length of fascia 150. In an alternative arrangement, it is hereby contemplated that two or more housings 306 may be used or two or more light strips may be used, that may be placed in end-to-end or side-to-side alignment to one another and may be electrically connected to one another or electrically isolated from one another.

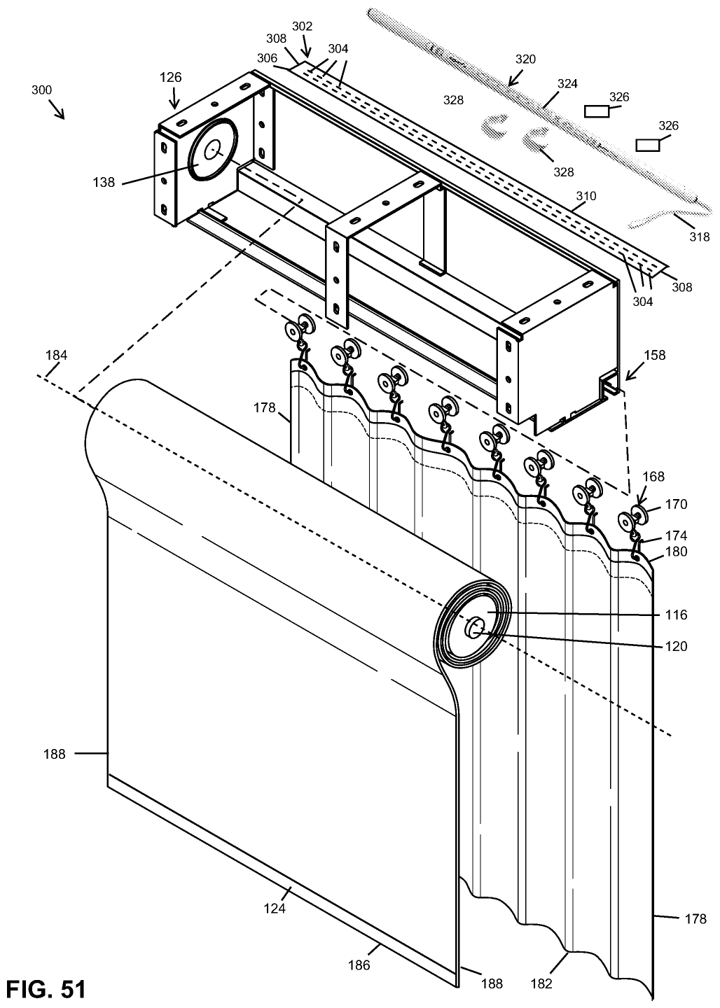

In the arrangement shown, as one example, a plurality of lights 304 are positioned in spaced relation to one another along the length of light assembly 302 thereby providing generally consistent and continuous illumination along the length of light assembly 302. The lights may be aligned in a single row that extends along the length of light assembly 302, or the lights may be aligned in multiple rows that extend along the length of light assembly 302. In the demonstrative embodiment shown in FIG. 51, the plurality of lights 304 are separated into two rows that extend the length of light assembly 302, however any number of rows of lights 304 are hereby contemplated for use such as one, two, three, four, five, six, seven, eight, nine, ten or more rows. Any other arrangement, spacing or positioning of lights 304 is hereby contemplated within light assembly 302.

Any form of light is hereby contemplated for use as plurality of lights 304 of light assembly 302. In one arrangement, the plurality of lights 304 are formed of what are known as light emitting diodes (“LEDs”). LEDs are a semiconductor light source that emits light when current flows through the LED. Electrons in the semiconductor recombine with electron holes, releasing energy in the form of photons. LED's have many advantages including low energy consumption, long life, physical robustness, small size, fast switching, low heat generation, among many other advantages. Any other form of light is hereby contemplated for use as plurality of lights 304 such as incandescent lights, florescent lights, neon lights, halogen lights, metal halide lights, or any other form of a light or any combination thereof.

In one arrangement, plurality of lights 304 are configured to illuminate only one color of light, such as white light, yellow light, purple light, green light, blue light, violet light, red light, orange light or any other color of light. In another arrangement, plurality of lights 304 are configured to illuminate a variety of colors of light and/or a range of colors of light. In yet another arrangement, a combination of lights are used as plurality of lights 304, some of which are configured to illuminate only one color of light and others that are configured to illuminate a variety of colors of light or a range of colors of light. In one arrangement, plurality of lights 304 may be infinitely controlled to illuminate any color within a range of colors.

In one arrangement, plurality of lights 304 are non-dimmable. In another arrangement, plurality of lights 304 may be dimmable. In one arrangement, plurality of lights 304 may be infinitely controlled to illuminate to any illumination level within a range of illumination levels.

Providing a plurality of lights 304 that may be selectively controlled to produce light in a wide range of colors as well as at a wide range of illumination levels provides the user with a great amount of control to choose an aesthetically pleasing setting to fit the mood of the room and set the appropriate ambiance for the intended use. In one setting, light assembly 302 is configured to slowly move through the range of colors of light the plurality of lights 304 are capable of producing.

In the arrangement shown, as one example, light assembly 302 is sized and shaped to fit within the hollow interior 164 of track 158 of fascia 150 such that when the light assembly 302 is illuminated, light shines downward out of fascia 150 through slot 166 in track 158.. However it is hereby contemplated that light assembly 302 may be installed on and/or connected to any other portion of system 300.

In the arrangement shown, as one example, a single light assembly 302 is installed within the hollow interior 164 of track 158 of fascia 150. In the arrangement shown, as one example, the upper surface 312 of light assembly 302 is adhered to the lower surface of top wall 160 of track 158. In this arrangement a layer of glue, a double sided tape, a double sided foam tape or any other form of an adhesive may be use that adheres light assembly 302 to fascia 150. However any other manner, method or means of installation and/or attaching light assembly 302 to fascia 150 is hereby contemplated for use. In an alternative arrangement, light assembly 302 is screwed, bolted, snap-fitted, friction-fitted, glued, adhered, welded, potted, or connected in any other way or by any combination thereof to track 158 of fascia 150.

In an alternative arrangement, light assembly 302 may be held in place within hollow interior 164 of track 158 by one or more clips, holders or other installation components or features that may be installed onto fascia 150 or formed as part of fascia 150, or alternatively these components may be formed as part of end caps installed onto fascia 150 or formed or installed onto any other part of the system 300. In one arrangement, light assembly 302 may be sized and shaped such that it may be inserted within the hollow interior 164 of track 158 in such a way that light assembly 302 does not fall out of the hollow interior 164 of light assembly 158 due to its size and shape, such as the light assembly 302 being wider than the width of slot 166. Alternatively, instead of installing light assembly 302 into track 158, light assembly 302 is formed as an integral part into fascia 150 as fascia 150 is manufactured.

In one arrangement, light assembly 302 may be sized and shaped such that it may only be installed into the hollow interior 164 of track 158 from an open end of track 158 as light assembly 302 is too large to fit through slot 166 in the lower end of track 158. In an alternative arrangement, light assembly 302 may be installed into the hollow interior 164 of track 158 through slot 166.

Lights Only: In the arrangement shown, in FIGS. 35-41, light assembly 302 is installed within the hollow interior 164 of track 158 without any other components installed in track 158. That is, in these figures, and in this arrangement, light assembly 302 is installed in track 158 without a plurality of carriers 168 positioned within the track 158. Subsequently, in these figures, and in this arrangement, no drapery shade material 176 is attached to fascia 150. Instead, fascia 150 only houses light assembly 302 as well as being attached to brackets 126 which holds at least one roller shade assembly 114. In a manner of speaking, in this arrangement fascia 150 is a lights-only fascia 150.

Notably, and it is worth repeating, that while in the arrangements shown, in these figures, a roller shade assembly 114 is shown in use, it is hereby contemplated that fascia 150 may be used with any other form of a shade assembly, which may include roller shades, but is not limited to roller shades, and may include honeycomb shades, venetian shades, transition shades, mini-blinds, vertical shades, vertical panel shades, a drapery, a drapery track shade, or any other form of a shade.

In this arrangement, light assembly 302 may be installed to the bottom surface of top wall 160 by adhesive, screwing, bolting, snap fitting, mechanically fastening, friction fitting, or by any other manner, method or means. Or, as no other items are installed within the hollow interior 164 of track 158, light assembly 302 may simply be placed within the hollow interior 164 of track 158. In this arrangement, light assembly 302 will not fall out of the hollow interior 164 of track 158 due to the narrow opening formed by slot 166 combined with the width of light assembly 302 between opposing sides 310 being wider than the width of slot 166, which holds light assembly 302 therein.

In this arrangement, when light assembly 302 is illuminated, light is projected downward from light assembly 302 which is held within the hollow interior 164 of track 158. This light projects outward through slot 166 in track 158. When the roller shade material 122 is deployed, or in a closed position, when light assembly 302 is illuminated, which is often the case when light assembly 302 is illuminated, a portion of this light engages and illuminates as well as reflects off of the deployed roller shade material 122 thereby providing an aesthetically pleasing appearance.

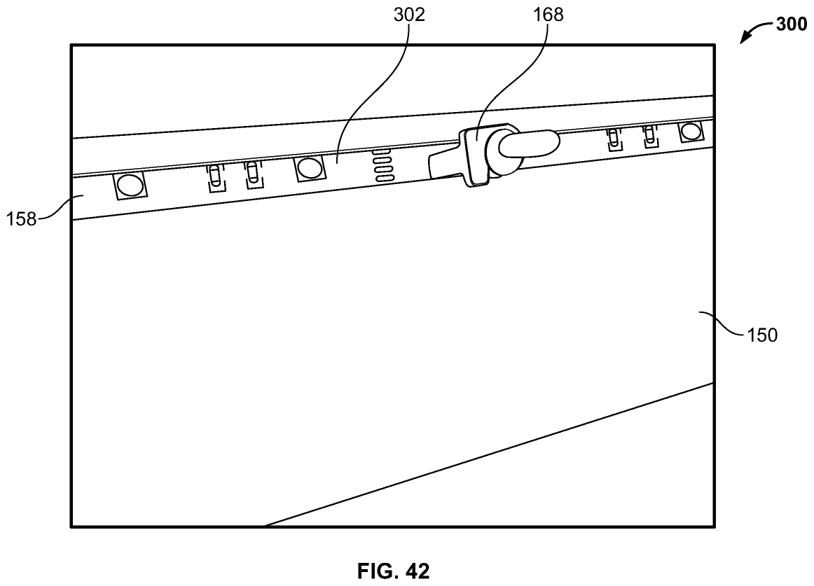

Lights & Drapery: In the arrangement shown, as one example, in FIGS. 42, 51, 52 and 53, light assembly 302 is installed within the hollow interior 164 of track 158 as well as the plurality of carriers 168 being installed within the hollow interior 164 of track 158. That is, in these figures, and in this arrangement, light assembly 302 is installed in track 158 at the same time a plurality of carriers 168 positioned within the track 158. Subsequently, in these figures, and in this arrangement, drapery shade material 176 is also attached to fascia 150. In a manner of speaking, in this arrangement fascia 150 is a lights and drapery fascia 150. Or, said another way, in this arrangement, fascia 150 houses and holds light assembly 302 as well as drapery shade material 176.

In this arrangement, as one example, light assembly 302 is installed to the bottom surface of top wall 160 of track 158 by adhesive, screwing, bolting, snap fitting, mechanically fastening, friction fitting, or by any other manner, method or means. By installing light assembly on the bottom surface of top wall 160, combined with the low-profile thickness between upper surface 312 and lower surface 314 of light assembly 302, this leaves ample space below the lower surface 314 of light assembly 302 within the hollow interior 164 of track 158 before slot 166.

Once light assembly 302 is installed within track 158, a plurality of carriers 168 are installed in the track 158. These carriers 168 are installed in the space between the upper surface of bottom plate 230 and the lower surface 314 of light assembly 302. In this arrangement, when carriers 168 are installed within the hollow interior 164 of track 158 the presence of light assembly 302 does not hinder, engage or obstruct the operation of the carriers 168. As such, in one arrangement, the plurality of carriers 168 are able to slide along the length of track 158 and move between a fully opened position and a fully closed position uninhibited by the presence of light assembly 302 within track 158. When the plurality of carriers 168 are installed within track 158 drapery shade material 176 may then be installed onto the plurality of carriers 168.

In this arrangement, when light assembly 302 is illuminated, light is projected downward from light assembly 302 which is held within the hollow interior 164 of track 158. This light passes around the plurality of carriers 168 which does not meaningfully inhibit light produced by light assembly 302 from passing out of track 158 due to the generally low-profile nature of carriers 168. This light projects outward through slot 166 in track 158. In places where drapery shade material 176 is below the track 158, this light shines down upon the drapery shade material 176. In many cases, drapery shade material 176 is what is known as a sheer material that is generally known for being light and airy and allows most light to pass through the sheer material. When the light from light assembly 302 shines down upon the sheer material of drapery shade material 176 this light tends to have the effect of brightly illuminating the upper portion of the sheer material which provides a pleasing aesthetic appearance. In places where the drapery shade material 176 is not deployed, but the roller shade material 122 is deployed, or in a closed position, when light assembly 302 is illuminated, which is often the case when light assembly 302 is illuminated, a portion of this light engages and illuminates as well as reflects off of the deployed roller shade material 122 thereby providing an aesthetically pleasing appearance.

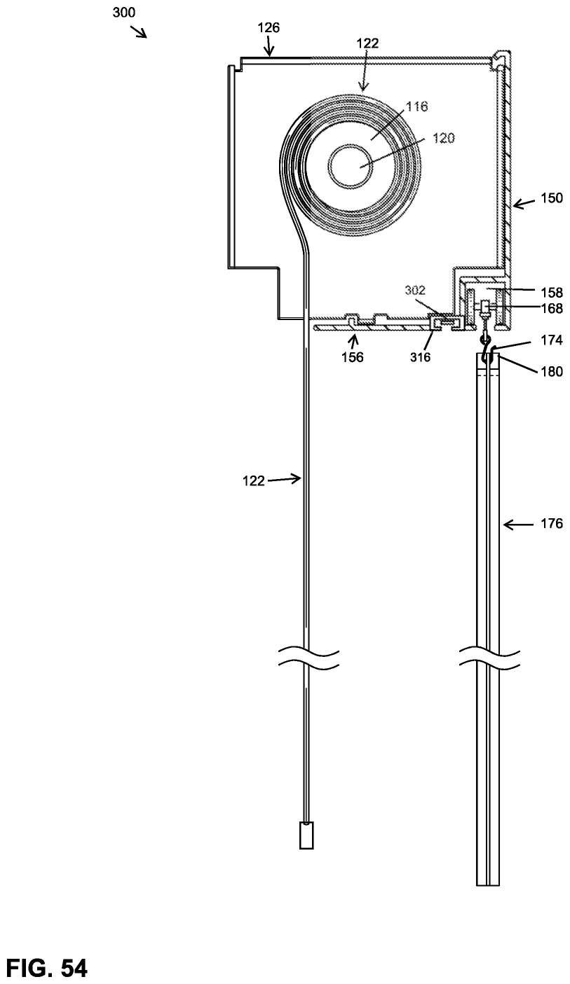

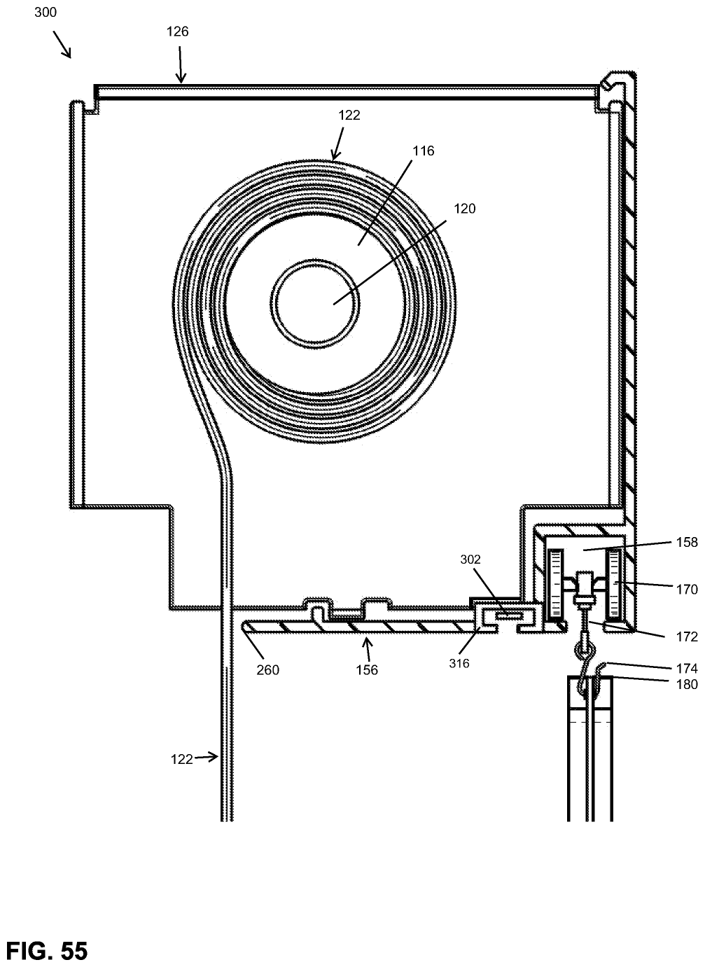

Second Track: In an alternative arrangement, with reference to FIGS. 54 and 55, an alternative arrangement of fascia 150 is presented that includes a second track 316. In some arrangements it may be undesirable to have both light assembly 302 as well as a plurality of carriers 168 positioned within the same track 150. When this is the case, a second track 316 is placed in fascia 150.

Second track 316 may be formed of any suitable size, shape and design. In one arrangement, second track 316 has the identical size, shape and design as track 158.

In the arrangement shown, as one example in FIGS. 54 and 55, second track 316 is formed of a similar same size, shape and design as track 158, with a slightly narrower height, which is due to the narrow height of light assembly 302 between upper surface 312 and lower surface 314. In either arrangement, the disclosure presented herein with respect to track 158 applies to second track 316, including top wall 160, rear wall 162, hollow interior 164, slot 166 and all other features, as well as the manner in which light assembly 302 is installed within track 150.

In an alternative arrangement, second track 316 is a recess in the bottom plate 156 and does not include slot 166. Instead, in this arrangement, the front and rear walls of second track 316 extend downward and do not include overhanging lips that form slot 166. This arrangement allows light assembly 302 to be installed directly upward into the hollow interior 164 of second track 316. In one arrangement, light assembly 302 is configured to fit within second track 316 with close and tight tolerances such that the light assembly 302 fills all or practically all of the space or hollow interior 164 of second track 316. In this arrangement, light assembly 302 may be friction fitted within second track 316.

In the arrangement shown, as one example, second track 316 is positioned just rearward of the rear wall 162 of track 158. In this arrangement, the rear wall 162 of track 158 serves as the front wall of second track 316. However any other placement of second track 316 in fascia 150 is hereby contemplated for use as is any other configuration of second track 316.

Notably, any number of additional tracks such as three, four, five, six or more are hereby contemplated for use for housing and/or holding additional components, systems, and the like or for any other purpose. When multiple light assemblies 302 are used, a corresponding number of tracks 158 may be used. As one example, when three light assemblies 302 are used, three tracks 158 may be used, wherein each track 158 extends across the bottom surface of fascia 150 one next to each other.

Recessed v. Flush: In one arrangement, whether light assembly 302 is installed in track 158 or second track 136, the lower surface 314 of light assembly 302 is recessed slightly to the lower surface of track 158 or second track 316. This slight recession of light assembly 302 within track 158 or second track 316 causes the light generated by light assembly to be directed or focused or filtered by the size, shape and design of track 158 or second track 316. This can have the effect of producing a softer and less direct or glaring light from light assembly 302 as the light must filter through the hollow interior 164 as well as the narrower slot 166 in the lower side of track 158 or second track 302.

In an alternative arrangement, the lower surface 314 of light assembly 302 is positioned in flat and flush alignment with the lower surface 270 of bottom plate 156. This arrangement provides the benefit of a finished look to fascia 150 as there are no gaps or spaces in fascia 150. This arrangement also provides the benefit that light generated by light assembly 302 efficiently passes out of track 158 or second track 316 without being trapped or caught within track 158 or second track 316. However, this may come at the cost of generating a sharper or harsher or more-direct light as compared to recessing light assembly 302 within track 158 or second track 316.

Installation: In one arrangement, light assembly 302 is installed by inserting light assembly 302 into the hollow interior 164 of track 158 through an open end of fascia 150. Alternatively, In another arrangement, light assembly 302 is installed by inserting light assembly 302 into the hollow interior 164 of track 158 through slot 166, which may require rotating the light assembly 302 slightly so as to angle a side through the slot 166 and once the light assembly 302 has passed the narrow slot 166, the light assembly 302 can be rotated back to a horizontal arrangement. Once light assembly 302 is positioned within the hollow interior 164 of track 158, light assembly 302 may be simply left in place and the dimensions of the wider light assembly 302 will be retained by the narrower slot 166. Alternatively, the light assembly 302 may be affixed to the fascia 150 by adhering the upper surface 312 of light assembly 302 to the lower surface of top wall 160 of track 158 using an adhesive, or by affixing light assembly 302 fascia 150 by any other manner, method or means, such as passing fasteners through fascia 150 and through a portion of light assembly 302 or by clipping light assembly 302 to fascia 150 or by friction fitting light assembly 302 to fascia 150 or the like.

Electrical Lead & Power Source: In one arrangement, light assembly 302 is connected to an electrical lead 318 that electrically connects to a power source 320 and/or other electrical components of the system. Electrical lead 318 is formed of any suitable size, shape and design and is configured to carry power and/or control signals to and from light assembly 302. In one arrangement, electrical lead 318 is a wire or a plurality of wires. In one arrangement, electrical lead 318 is what is known as a Cat-5 or Cat-6 Ethernet cable, or any other version of an Ethernet cable, that provides power as well as control signals in an arrangement known as power-over-Ethernet (“POE”). However any other form or configuration of a wire, cable or any other electrical lead is hereby contemplated for use.

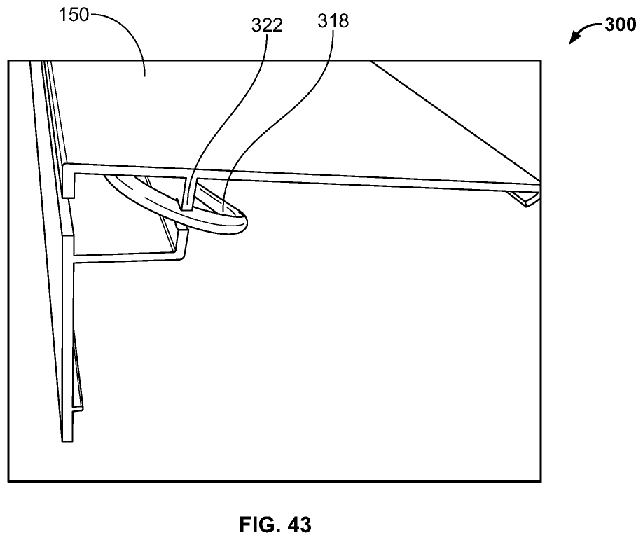

In the arrangement shown, as one example, electrical lead 318 extends through an opening 322 in track 158 so as to facilitate the passage of electrical lead 318 from inside of the hollow interior 164 of track 158 to the space or area behind front plate 154 and bottom plate 156 but external to track 158. In the arrangement shown, in FIG. 43, opening 322 in track 158 is a notch, hole, or cut-out section positioned in an end of the top wall 160 of track 158 that is sized and shaped to allow electrical lead 318 to pass there through. However, any other size, shape and position of opening 322 is hereby contemplated for use. In this way, electrical lead 318 carries power and control signals from outside of the hollow interior 164 of track 158 to the light assembly 302 positioned within the hollow interior 164 of track 158.

Power source 320 is formed of any suitable size, shape and design and is configured to provide ample power to light assembly 302. Power source 320 may be any form of power. Power source 320 may be an electrical connection to an external unlimited power source such as line power, such as through hard-wiring to the wiring system of a home or building. Alternatively, power source 320 may be a solar panel, a battery, a plurality of batteries, a battery pack, or any combination thereof, or to a combination of an on-board power source, such as a solar panel, a battery, a plurality of batteries, a battery pack, as well as a connection to line power.

In the arrangement shown, as one example, power source 320 is formed of a battery tube 324 that houses a plurality of conventional batteries 326 therein. In the arrangement shown, as one example, battery tube 324 is a generally elongated cylindrical member with a hollow interior that houses cylindrical batteries 326, however any other size, shape and design is hereby contemplated for use.

In the arrangement shown, as one example, battery tube 324 is connected to fascia 150 and/or brackets 126 or any other component of the system 300 by one or more holders 328. In the arrangement shown, as one example, holders 328 are generally C-shaped clips or brackets that receive and frictionally hold battery tube 324 with a spring bias when battery tube 324 is inserted within the hollow interior of the holders 328. In the arrangement shown, as one example, a pair of holders 328 are shown that are attached to the rear surface 268 of front plate 154 of fascia 150 out of the way of roller shade assembly 114. However any other configuration of holders 328 and placement of holders 328 are hereby contemplated for use.

This arrangement, with holders 328 and an on-board power source 320 allows for light assembly 302 and its power source 320 to be installed onto fascia 150. In this way, when the batteries 326 need to be changed, which is infrequent due to the low power draw of LED lights 304, the fascia 150 may be removed from brackets 126 and then the battery tube 324 may be removed from the holders 328 and the batteries 326 may be easily replaced. Once the battery tube 324 is installed in holders 328 again, the fascia 150 may be reinstalled onto brackets 126.

This arrangement allows for on-board power source 320 to be completely hidden behind fascia 150. This creates a sleek and stylish appearance that is also highly functional as well as easy to maintain.

Control Assembly: In the arrangement shown, as one example, illuminated roller shade and drapery mounting system 300 includes a control assembly 330. Control assembly 330 is formed of any suitable size, shape and design and is configured to facilitate controlled operation of system 300.

In the arrangement shown, as on example, control assembly 330 is electrically connected to light assembly 302 and includes a microprocessor 332, memory 334, a receiver or transceiver 336, and an antenna 338, among other electronic components and features that facilitate controller operation of system 300. System 300 may be connected by a switch 340, which is hard wired to system 300 which provides control signals to system 300 and/or control assembly 330 through wired communication, and/or to a wireless control 342 which provides control signals to system 300 and/or control assembly 330 through wireless communication.

In the arrangement shown, as one example, microprocessor 332 is any computing device that receives and processes information and outputs commands according to instructions stored in memory 334. Memory 334 is any form of information storage that selectively receives and stores information and provides this information on command such as flash memory, ram memory, a hard drive, or any other form of memory or information storage. Memory 334 may be included as a part of or operably connected to microprocessor 332. Microprocessor 332 and memory 334 may be formed of a single component or of multiple components that are electrically connected together and operate in concert with one another. A receiver or transceiver 336 is connected to microprocessor 332. A receiver is used if one-way communication is utilized, whereas a transceiver is used if two-way communication is utilized. Receiver or transceiver 336 is connected with an antenna 338 such as a monopole antenna, a loop antenna, a fractal antenna, or any other form of an antenna. Antenna 338 receives wireless signals from a wireless control 342 which may be any device which transmits wireless control signals to receiver or transceiver 336 which processes these signals and then transmits these processed signals to microprocessor 332 which processes these signals according to instructions stored in memory 334.

Wireless control 342 is any form of a remote control device that transmits wireless signals over the air such as a conventional remote control, a cell phone, a wireless device, an internet connected device, a hard-wired device, a repeater, or any other device capable of transmitting remote control signals. In one arrangement each system 300 itself may be a wireless control 342 when the system 300 is in a repeating mode that repeats control signals that it receives. Wired control or switch 340 is any form of a remote control device that transmits control signals through wired connection to system 300.

In Operation: In operation, when a user operates wireless control 342, a control signal is sent over-the-air to system 300. This control signal is received by control assembly 330. More specifically, this control signal is received by antenna 338 which transmits the control signal to receiver or transceiver 336 which initially processes the control signal. The receiver or transceiver 336 then transmits the initially processed control signal to microprocessor 332 which further processes the control signal according to instructions stored in memory 334. In response, microprocessor 332 outputs commands that controls operation of the system 300. Similarly, when a user operates switch 340, a control signal is transmitted to control assembly 330 through wired communication. The control signal is received by microprocessor 332 which processes the control signal according to instructions stored in memory 334. In response, microprocessor 332 outputs commands that controls operation of the system 300. This may include turning on or turning off the light assembly 302, adjusting the intensity of the light assembly 302, adjusting the color of light produced by light assembly 302 or by controlling any other aspect of light assembly 302. This may also include opening and closing roller shade assembly 114. This may also include opening and closing motorized drapery assembly 344.

In one arrangement control assembly 330 is connected to only light assembly 302. In another arrangement, control assembly 330 is connected to light assembly 302 as well as motorized drapery assembly 344 (as is further described herein) and controls operation of both. In another arrangement, control assembly 330 is connected to light assembly 302 as well as motorized drapery assembly 344 as well as motorized shade assembly 114 and controls operation of all three components. In another arrangement, control assembly 330 is connected to light assembly 302 as well as motorized shade assembly 114 and controls operation of both.

Similarly, in one arrangement power source 320 is connected to only light assembly 302. In another arrangement, power source 320 is connected to light assembly 302 as well as motorized drapery assembly 344 and provides power to both. In another arrangement, power source 320 is connected to light assembly 302 as well as motorized drapery assembly 344 as well as motorized shade assembly 114 and provides power to all three components. In another arrangement, power source 320 is connected to light assembly 302 as well as motorized shade assembly 114 and provides power to both.

As is described herein, a single control assembly 330 as well as a single power source 320 may be used to control and/or power all electronic components of the system 300.

Motorized Drapery Assembly: In one arrangement, drapery shade material 176 is operated by manual operation. That is, a user manually pulls the drapery shade material 176 along a length of track 158 thereby moving the drapery shade material 176 to move between an open position and a closed position. As the user pulls the drapery shade material 176 the plurality of carriers 168 slide or roll within the hollow interior 164 of track 158.

In an alternative arrangement, illuminated roller shade and drapery mounting system 300 includes a motorized drapery assembly 344. Motorized drapery assembly 344 is formed of any suitable size, shape and design and is configured to facilitate motorized movement and control of drapery shade material 176. Said another way, motorized drapery assembly 344 is configured to open and control drapery shade material 176 using motorization. In this way, the addition of motorized drapery assembly 344 for the first time provides motorized movement of a drapery associated with a fascia 150 which provides countless benefits.

In the arrangement shown, as one example, motorized drapery assembly 344 includes a motor assembly 346 that connects to a head 348 positioned adjacent an end 152 of fascia. Head 348 connects motor assembly 346 to a gear assembly 350 that engages a portion of a belt 352. Belt 352 extends through hollow interior 164 of track 158 and loops around a gear assembly 350 positioned at each end 152 of fascia 150. As belt 352 moves through the hollow interior 164 of track 158, belt 352 engages carriers 168 and moves them along the length of track 158 between a fully opened and a fully closed position, depending on the direction of rotation of motor assembly 346.

Motor assembly 346 of motorized drapery assembly 344 is formed of any suitable size, shape and design and is configured to open and close drapery shade material 176 in a motorized manner. In the arrangement shown, as one example, motor assembly 346 is an electric motor that connects to head 348 at an end 152 of fascia and extends in a generally vertical manner. Motor assembly 346 includes an output shaft that connects to gear assembly 350 such that when motor assembly 346 operates the output shaft rotates which rotates gear assembly 350 which moves belt 352 through the hollow interior 164 of track 158 thereby opening and closing drapery shade material 176.

Head 348 of motorized drapery assembly 344 is formed of any suitable size, shape and design and is configured facilitate connection of motor assembly 346 to fascia 150 while facilitating motorized movement of belt 352. In the arrangement shown, as one example, head 348 is connected to an end 152 of fascia 150 and serves to engage and hold bot motor assembly 346 as well as a gear assembly 350. When motor assembly 346 is connected to head 348 and operates, a portion of gear assembly 350 rotates within head 348 which moves belt 352 through the hollow interior 164 of track 158 thereby opening and closing drapery shade material 176. In the arrangement shown, as one example, head 348 is positioned slightly behind track 158 so as to hide motor assembly 346 and head 348 behind a stack of drapery shade material 176 positioned at the outward end of track 158 and/or fascia 150.

Gear assembly 350 of motorized drapery assembly 344 is formed of any suitable size, shape and design and is configured to facilitate the movement of belt 352 through the hollow interior 164 of track 158. In the arrangement shown, as one example, gear assembly 350 includes a gear that is positioned within a loop of belt 352 at each end of track 158 and serves to return belt 352 to track 158 as belt 350 exits an end 152 of fascia 150.

Belt 352 of motorized drapery assembly 344 is formed of any suitable size, shape and design and is configured to move through hollow interior 164 of track 158 and as the belt 352 moves the belt 352 carries with it carriers 168 thereby opening or closing drapery shade material 176. In the arrangement shown, as one example, belt 352 is a flexible plastic and/or rubber belt with a smooth exterior surface and a toothed interior surface that meshes with gear teeth of gear assembly 350 at each end 152 of fascia 150.

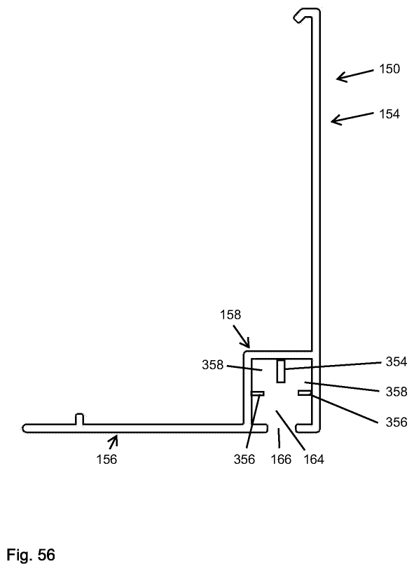

In the arrangement shown, as one example, with reference to FIG. 56, to facilitate the usage of belt 352, the hollow interior 164 of track 158 includes a center divider 354 that extends downward from the lower surface of top wall 160 a distance, and a pair of horizontal dividers 356 that extend inward into the hollow interior 164 of track 158 from the interior surface of the front plate 154 and rear wall 162 a distance. The inward ends of horizontal dividers 356 terminate a distance apart from one another in symmetric fashion when viewed from an end 152 of fascia 150. The presence of center divider 354 and horizontal dividers 356 has the effect of dividing the upper portion of the hollow interior 164 of track 158 into two chambers 358 that each receive a portion of belt 525. As motor assembly 346 operates, the portion of belt 352 the forward-positioned chamber 358 moves in an opposite direction to the portion of belt 352 in the rearward-positioned chamber 358. The presence of center divider 354 separates these oppositely moving portions of belt 352 from engaging one another. The presence of horizontal dividers 356 holds belt 352 in the upper portion of track 158.

Any other configuration or arrangement is hereby contemplated for use as s motorized drapery assembly 344.

In one arrangement, motorized drapery assembly 344 is electrically connected to and controlled by control assembly 330, which allows a single controller to control multiple components thereby eliminating duplication of parts. That is, in this arrangement, control assembly 330 is electrically connected to and controls operation of motorized drapery assembly 344 as well as light assembly 302 and/or roller shade assembly 114. This arrangement allows multiple electronic components to be controlled using the same switch 340 and/or wireless control 342. This arrangement also allows for the use of only a single control assembly 330 for controlling multiple electronic components which eliminates the need to have multiple control assemblies 330 where one control assembly 330 is associated with each electronic component.

In one arrangement, motorized drapery assembly 344 is electrically connected to and powered by power source 320, which allows a single power source to power multiple electronic components thereby eliminating duplication of parts. That is, in this arrangement, power source 320 is electrically connected to and powers motorized drapery assembly 344 as well as light assembly 302 and/or roller shade assembly 114. This arrangement allows multiple electronic components to be powered using the same power source 320. This arrangement also allows for the use of only a single power source 320 for powering multiple electronic components which eliminates the need to have multiple power sources 320 where one power source 320 is associated with each electronic component.

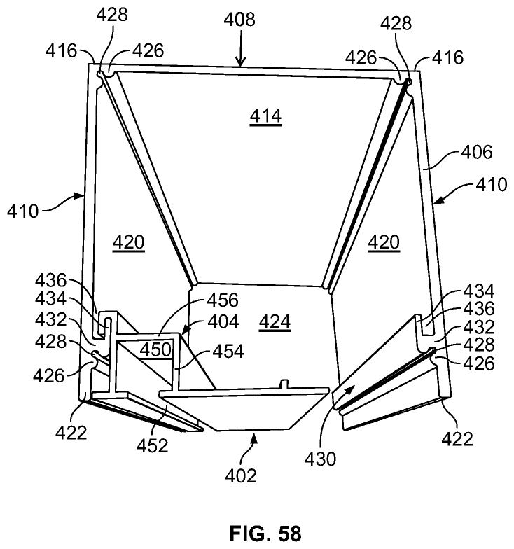

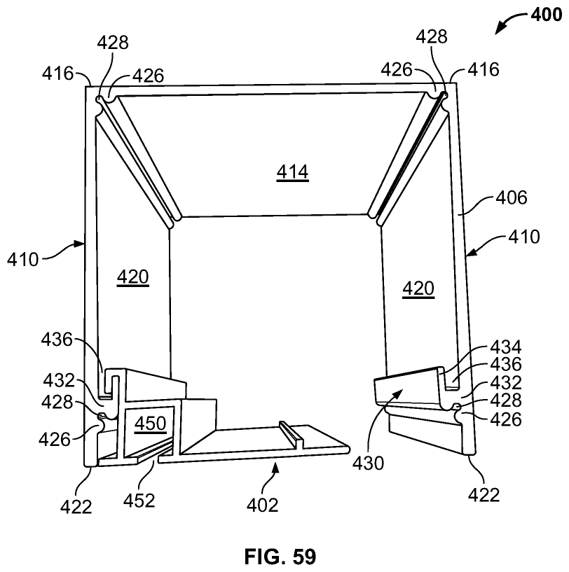

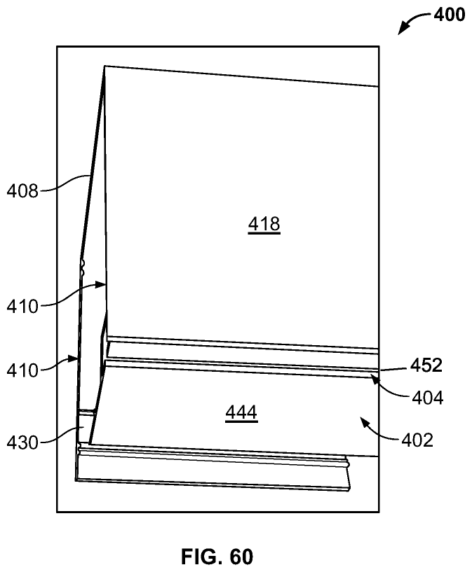

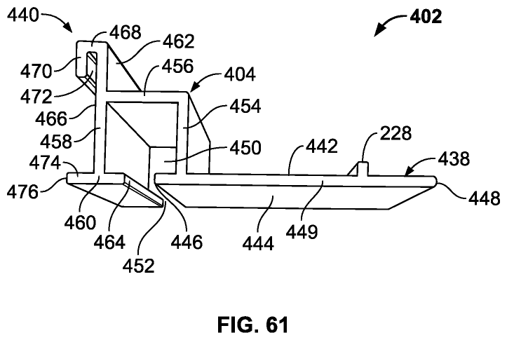

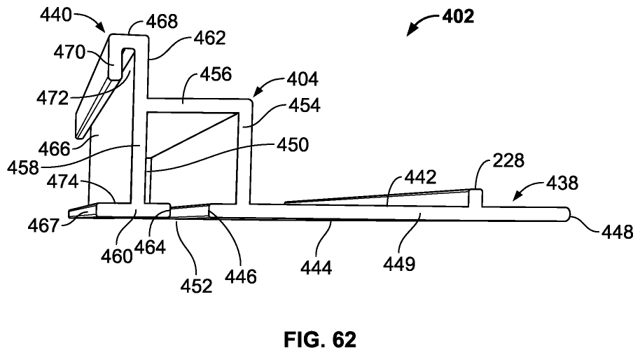

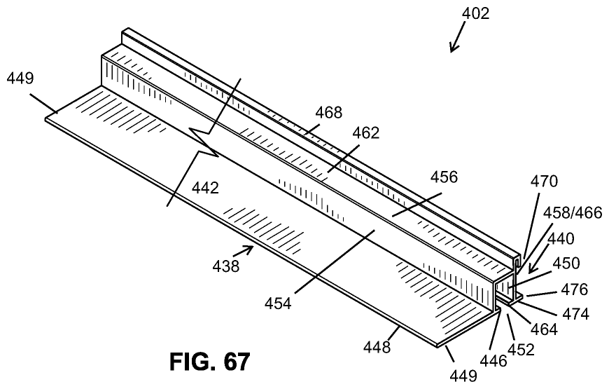

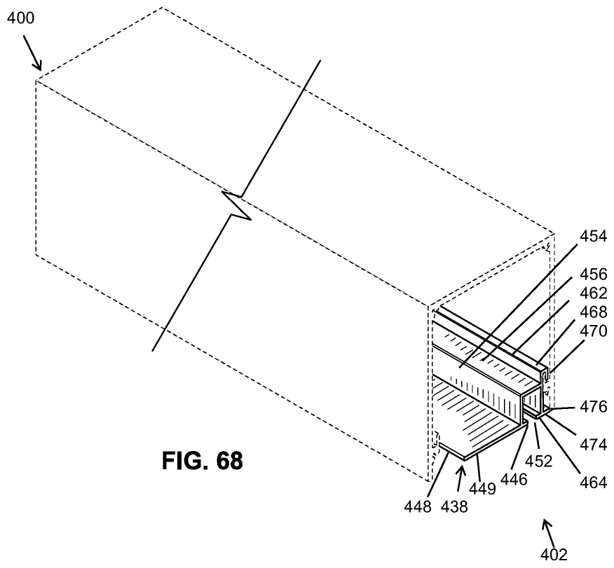

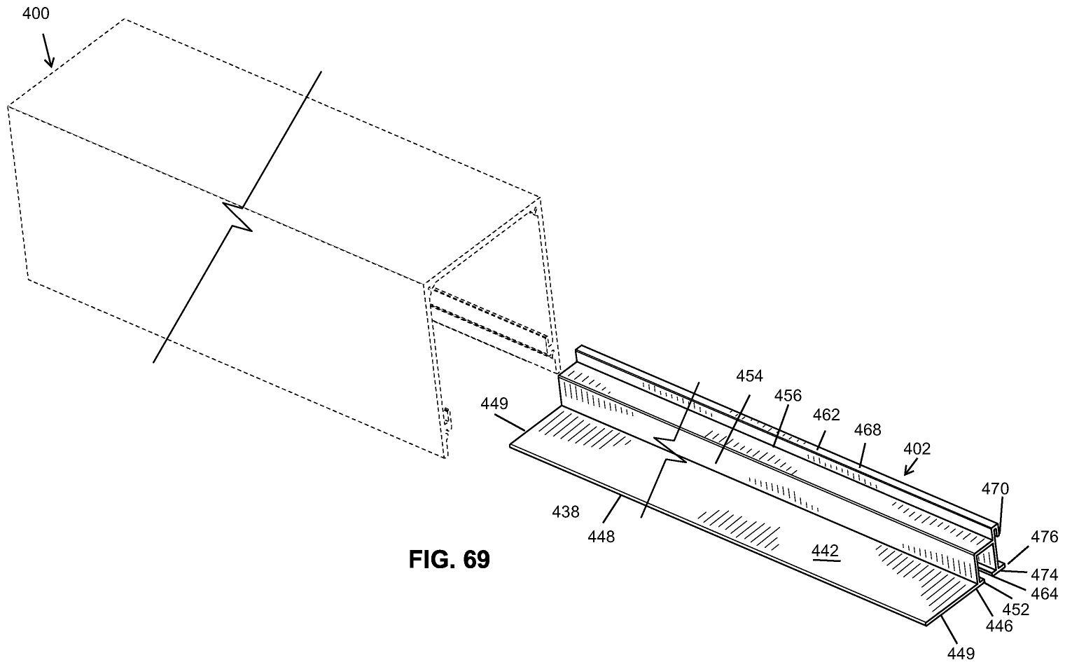

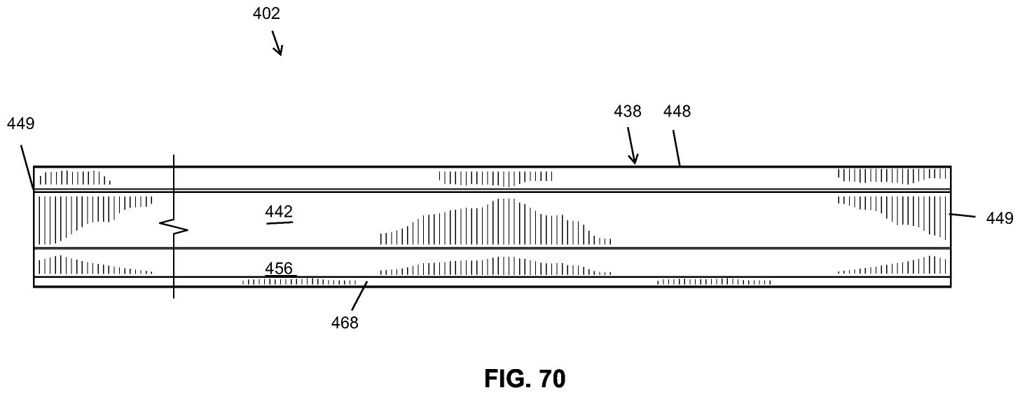

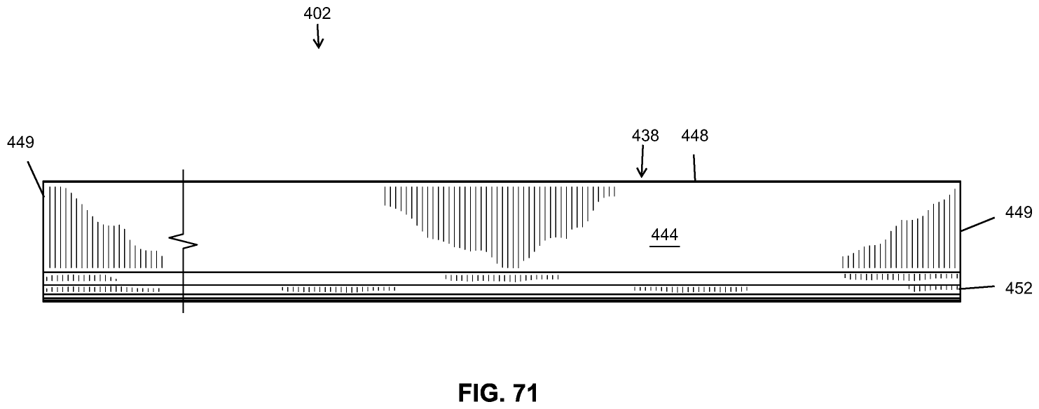

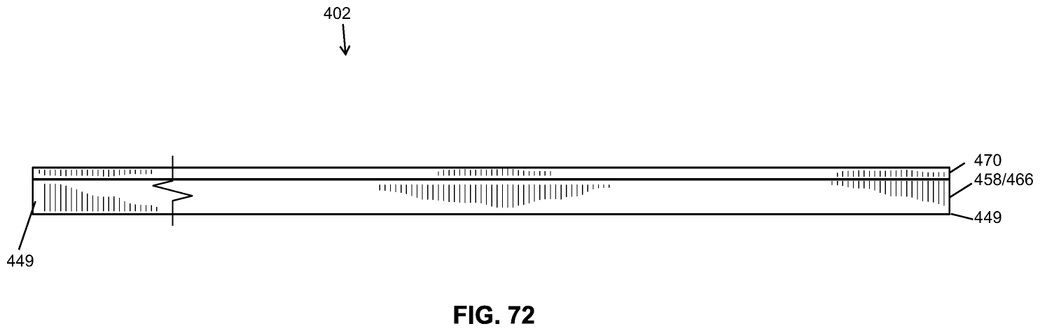

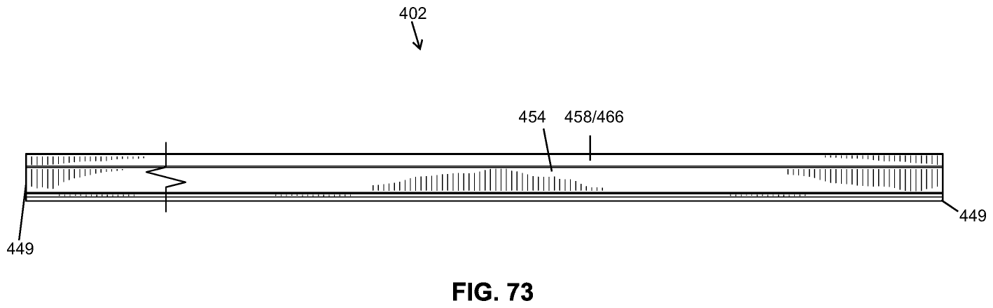

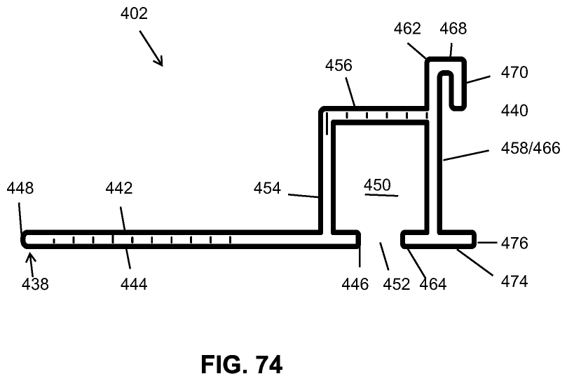

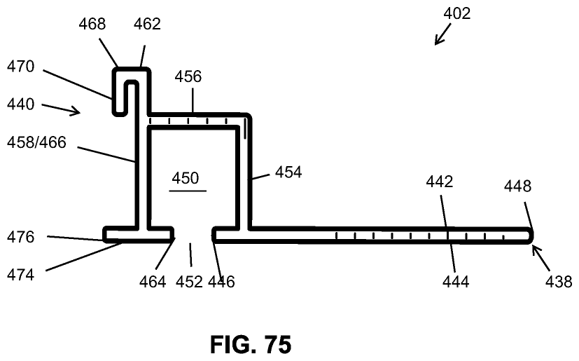

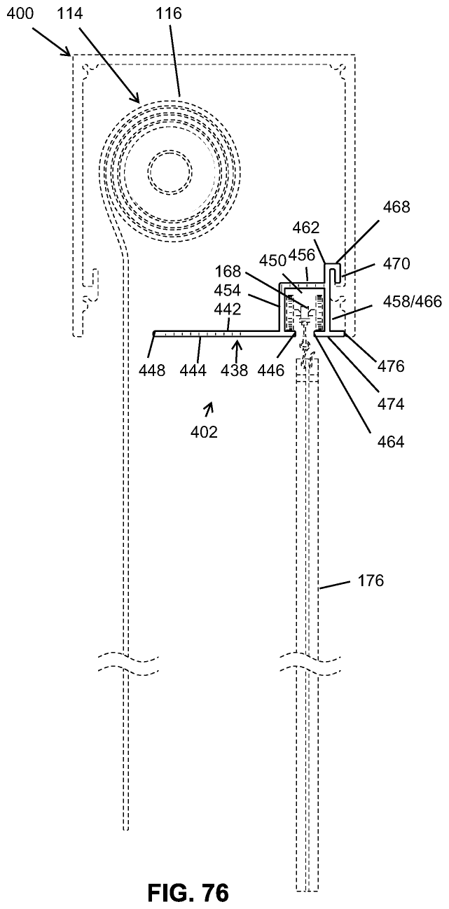

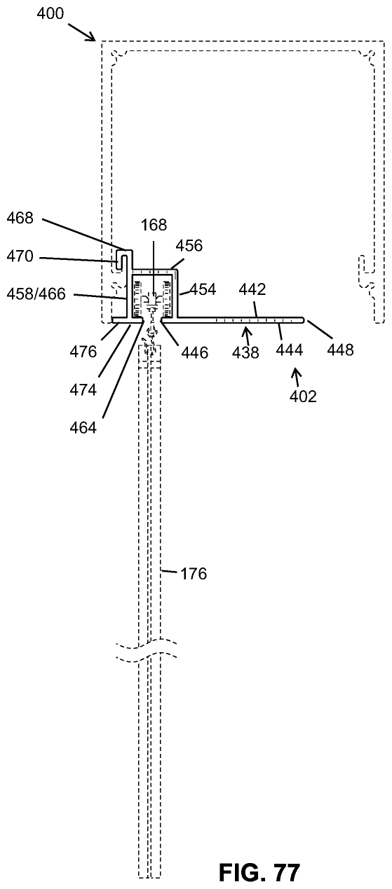

Alternative Arrangement—Headbox Arrangement: With reference to FIGS. 58-63 an alternative arrangement of the roller shade and drapery window shade system 100 presented that is configured to be used with a headbox 400 and a bottom plate assembly 402 having a track 404 therein. An alternative embodiment of a bottom plate assembly 402 is presented in FIGS. 67-77, which includes slight revisions to the configuration presented in FIGS. 58-63 including the removal of lower connection member 228.

Headbox: Headbox 400 is formed of any suitable size, shape and design and is configured to be easily installed into a pocket in a ceiling adjacent a window during the construction process. Then, once construction is completed, the roller shade assembly 114 is quickly and easily installed into the headbox 400.

That is, headbox 400 serves many purposes. That is, headbox 400 is quickly and easily installed in a partially or fully constructed building by passing screws or bolts through any of the top wall 408 or sidewalls 410. The dimensions of headbox 400 are controlled by the manufacturer and therefore the tolerances are tight, which eliminates the window shade installer having to deal with construction variance in the building. The headbox 400 tends to be constructed in a rigid, durable and strong manner. As such, the use of a headbox 400 solves or eliminates many of the problems that installers face. The result is the use of a headbox 400 speeds the installation process and provides a more-secure installation with less headaches. In addition, the installation of roller shade assembly 114 is aesthetically pleasing as well as mechanically sound.

In the arrangement shown, as one example, headbox 400 is a generally square or rectangular member that extends a length between opposing ends 406. In the arrangement shown, as one example, headbox 400 has a top wall 408 that connects to a pair of opposing sidewalls 410. In the arrangement shown, as one example, the features of headbox 400, as are described herein, extend the length of headbox 400 from end 406 to end 406 and in this way headbox 400 is an extruded member. Headbox 400 may be formed of a metallic material, such as aluminum or an aluminum alloy, so as to provide optimum strength while still being light. Alternatively, headbox 400 may be formed of a non-metallic material, such as plastic, composite, an UMW material, a nylon, a fiber glass material, or any other non-metallic material.

In the arrangement shown, as one example, top wall 408 is a generally flat and planar member having a generally flat upper surface 412 that extend a length in approximate parallel spaced relation to a generally flat lower surface 414. The outward edges of top wall 408 connect to the upper edges 416 of sidewalls 410.

In the arrangement shown, as one example, sidewalls 410 are generally flat and planar members having a generally flat exterior surface 418 that extend a length in approximate parallel spaced relation to a generally flat interior surface 420. The upper edges 416 of sidewalls 410 connect to the outward edges of top wall 408. Sidewalls 410 extend downward from upper edges 416 in a generally straight manner before terminating in a free end at lower edge 422.

In the arrangement shown, as one example, the plane formed by top wall 408 extends in approximate perpendicular alignment to the planes formed by sidewalls 410. In the arrangement shown, as one example, the planes formed by opposing sidewalls 410 extend in approximate parallel spaced alignment to one another. In this way the connection of top wall 408 to sidewalls 410 form a generally square or rectangular shaped member.

In the arrangement shown, as one example, headbox 400 has an open lower end between opposing lower edges 422 of opposing sidewalls 410 that leads to and provides access to a hollow interior 424. Hollow interior 424 is positioned between the interior surfaces 420 of opposing sidewalls 410 and the lower surface 414 of top wall 408. Roller shade assembly 114 as well as brackets 126 are received within hollow interior 424.

In the arrangement shown, as one example, a screw boss 426 is positioned at the interior corner of the intersection between top wall 408 and sidewalls 410. Screw boss 426 is formed of any suitable size, shape and design and is configured to provide additional strength, rigidity and durability to the intersection of top wall 408 and sidewalls 410, as well as facilitate the attachment of components to headbox 400. In the arrangement shown, as one example, each screw boss 426 extends the length of the headbox 400 and includes an opening 428 at its approximate middle that is sixed and shaped and configured to receive the threaded shaft of a conventional fastener such as a screw or bolt therein so as to facilitate connecting an end-cap or other component to headbox 400.

In the arrangement shown, as one example, a connection member 430 is connected to the interior surface 420 of sidewalls 410. Connection member 430 is formed of any suitable size, shape and design and is configured to facilitate the attachment of bottom plate assembly 402 to the lower end of headbox 400 so as to enclose the lower end of hollow interior 424.

In the arrangement shown, as one example, connection members 430 include a first arm 432 that extends outward from the interior surface 420 of sidewall 410 a distance. In the arrangement shown, as one example, first arm 432 extends outward from the interior surface 420 of sidewall 410 in a generally perpendicular manner to the plane formed by the interior surface 420 of sidewall 410. In the arrangement shown, as one example, a second arm 434 is connected to the outward end of first arm 432, opposite the end connected to interior surface 420 of sidewall 410. In the arrangement shown, as one example, second arm 434 extends upward from first arm 432 in a generally perpendicular manner to the length of first arm 432 and in a generally parallel spaced manner to the plane formed by the interior surface 420 of sidewall 410. The upper end of second arm 434 terminates in a free end that faces upward. In the arrangement shown, as one example, the interior facing surface and exterior facing surface of second arm 434 are generally flat and square and extend in approximate parallel spaced relation to one another. As such a groove 436 is positioned between the exterior facing surface of second arm 434, the upper facing surface of first arm 432 and the interior surface 420 of sidewall 410.

In the arrangement shown, as one example, a screw boss 426 is placed at the intersection of the lower surface of first arm 432 and the interior surface 420 of sidewall 410. This screw boss 426 facilitates the same purposes as is described herein with respect to the screw boss 426 positioned at the intersection of the top wall 408 and sidewalls 410 such as strength as well as facilitating an attachment point for an end cap or other component.

Bottom Plate Assembly: Bottom plate assembly 402 is formed of any suitable size, shape and design and is configured to be easily installed on headbox 400 and serves to enclose a portion of the open lower end of headbox 400.

In the arrangement shown, as one example, bottom plate assembly 402 includes a bottom plate 438 connected to a track 404 and a connection member 440. In the arrangement shown, as one example, bottom plate assembly 402 is essentially the bottom plate 156 and track 158 of fascia 150 presented herein in prior embodiments with the removal of front plate 154 which is replaced by connection member 440 that facilitates connection to headbox 400. As such, all teaching related to fascia 150 is applicable to and incorporated into bottom plate assembly 402 unless specifically stated otherwise.

Specifically, bottom plate assembly 402 includes a bottom plate 438. In the arrangement shown, as one example, bottom plate 438 is a generally flat and square member that includes a generally flat upper surface 442 that extends in a generally parallel spaced manner to a generally flat lower surface 444. Bottom plate 438 extends a length between a forward end 446 and a rearward end 448 as well as between opposing sides 449. In the arrangement shown, as one example, the forward end 446 terminates just below the hollow interior 450 of the groove of track 404 and forms one side of slot 452 that provides access to the hollow interior 450 of track 404.

In one arrangement, as one example, a lower connection member 228 is connected to the upper surface 442 of bottom plate 438 a distance inward from rearward end 448 which is similar to if not identical to lower connection member 288 of fascia 150 in size, shape and placement so as to make bottom plate assembly 402 compatible with the same brackets 126 as fascia 150. In the arrangement shown, as one example, when viewed from the side, lower connection member 228 is a generally square or rectangular shaped member that extends upward a distance from the upper surface 442 of bottom plate 438 in a generally square and perpendicular manner to the plane formed by bottom plate 438. Lower connection member 228 is configured to be received within, snapped into, or engaged with, lower receiver 226 of brackets 126 and/or a center bracket 140. That is, as is shown in the figures, lower connection member 228 is configured to naturally fit upward and into the downward facing groove of lower receiver 226, or a similar feature of a center bracket 140, with close and tight tolerances. In this way, lower connection member 228 secures the rearward end 448 of bottom plate 438 in a quick, easy and secure manner.

In the arrangement shown, as one example, track 404 is positioned adjacent the forward end 446 of bottom plate 438. In the arrangement shown, as one example, when viewed from the side, track 440 includes a rear wall 454, a top wall 456 and a front wall 458 and a front lip 460.

In the arrangement shown, as one example, the lower end of rear wall 454 connects to and extends upward from the upper surface 442 of bottom plate 438 a distance rearward from the forward end 446 of bottom plate. In the arrangement shown, as one example, rear wall 454 is a generally flat and square member with a generally flat rearward facing surface and a generally flat forward facing surface that extend in approximate parallel spaced relation to one another. In the arrangement shown, as one example, the plane of rear wall 454 extends upward from the plane formed by the upper surface 442 of bottom plate 438 in a generally perpendicular manner before connecting to the rearward end of upper wall 456.

In the arrangement shown, as one example, the rearward end of top wall 456 connects to and extends forward from the upper end of rear wall 454 a distance before connecting to the rearward facing surface of front wall 458. In the arrangement shown, as one example, top wall 456 is a generally flat and square member with a generally flat upward facing surface and a generally flat downward facing surface that extend in approximate parallel spaced relation to one another. In the arrangement shown, as one example, the plane formed by top wall 456 extends forward from the plane formed by rear wall 454 in a generally perpendicular manner before connecting to the rearward side of front wall 458. In the arrangement shown, as one example, the plane formed by top wall 456 extends in a generally parallel spaced manner to the plane formed by the upper surface 442 of bottom plate 438 before connecting to the rearward facing surface of front wall 458.

In the arrangement shown, as one example, the rearward facing surface of front wall 458 connects to the forward end of top wall 456. In the arrangement shown, as one example, front wall 458 is a generally flat and square member with a generally flat forward facing surface and a generally flat rearward facing surface that extend in approximate parallel spaced relation to one another. In the arrangement shown, as one example, the plane formed by front wall 458 extends vertically, and both upward and downward, from its connection point to top wall 456. In the arrangement shown, as one example, the plane formed by front wall 458 extends in a generally perpendicular manner to the plane formed by top wall 456 as well as the plane formed by bottom plate 438. In the arrangement shown, as one example, the plane formed by front wall 458 extends in a generally parallel spaced manner to the plane formed by the rear wall 454. In the arrangement shown, as one example, the upper end 462 of front wall 458 connects to a free end that is configured to connect to a connection member 430- of headbox 400. In the arrangement shown, as one example, the lower end of front wall 458 connects to front lip 460.

In the arrangement shown, as one example, the upper surface of front lip 460 connects to the lower end of front wall 458. In the arrangement shown, as one example, front lip 460 is a generally flat and square member with a generally flat upward facing surface and a generally flat downward facing surface that extend in approximate parallel spaced relation to one another. In the arrangement shown, as one example, the plane formed by front lip 460 extends rearward from its connection point to the bottom end of front wall 458 a distance before terminating at slot 452. In the arrangement shown, as one example, the plane formed by front lip 460 extends forward from its connection point to the bottom end of front wall 458 a distance before terminating at its forward end 476. In the arrangement shown, as one example, the plane formed by front lip 460 extends in a generally perpendicular manner to the plane formed by front wall 458 as well as the plane formed by rear wall 454. In the arrangement shown, as one example, the plane formed by front lip 460 extends in a generally parallel spaced manner to the plane formed by the top wall 456. In the arrangement shown, as one example, the plane formed by front lip 460 extends in a generally parallel planar alignment to the plane formed by bottom plate 438. In the arrangement shown, as one example, the rearward end 464 terminates just below the hollow interior 450 of the groove of track 404 and forms one side of slot 452 that provides access to the hollow interior 450 of track 404.

In the arrangement shown, as one example, a connection member 440 is connected to bottom plate assembly 438. Connection member 440 is formed of any suitable size, shape and design and is configured to engage and hold onto one of the two connection members 430 of headbox 400 while facilitating quick and easy installation and removal as well as providing substantial strength of connection so as to facilitate supporting bottom plate assembly 438 as well as any attached drapery shade material 176 and/or light assembly 302.

In the arrangement shown, as one example, connection member 440 includes a center wall 466. In the arrangement shown, as one example, center wall 466 is a generally flat and square member that includes a generally flat rearward facing surface and a generally flat forward facing surface that extend in approximate parallel spaced relation to one another. In the arrangement shown, as one example, the rearward facing surface of center wall 466 of connection members 440 is connected to the forward facing surface of front wall 458 by any manner, method or means such as by screwing, bolting, pinning, riveting, welding, adhering, gluing, or bay any other manner, method or means.

In an alternative arrangement, connection member 440 is formed as an integral part of bottom plate assembly 402 and is not a separate part that must be attached to bottom plate 438 and track 404. In this arrangement front wall 458 and center wall 466 are formed of one and the same piece or component that may be extruded or formed as a single piece.

In the arrangement shown, as one example, connection members 440 includes a first arm 468 that extends outward from the forward facing surface of center wall 466/front wall 458 adjacent its upper end. First arm 468 extends forward from the forward surface of center wall 466/front wall 458 a distance before connecting to second arm 470. In the arrangement shown, as one example, first arm 468 extends outward from the forward surface of center wall 466 in a generally perpendicular manner to the plane formed by the center wall 466. In the arrangement shown, as one example, second arm 470 is connected to the outward end of first arm 468, opposite the end connected to center wall 466. In the arrangement shown, as one example, second arm 470 extends downward from first arm 468 in a generally perpendicular manner to the length of first arm 468 and in a generally parallel spaced manner to the plane formed by the forward surface of center wall 466. The lower end of second arm 470 terminates in a free end that faces or points downward. In the arrangement shown, as one example, the interior facing surface and exterior facing surface of second arm 470 are generally flat and square and extend in approximate parallel spaced relation to one another. As such a groove 472 is positioned between the rearward facing surface of second arm 470, the downward facing surface of first arm 468 and the forward facing surface of center wall 466/front wall 458.

In the arrangement shown, as one example, the lower end of center wall 466/front wall 458 includes a lower flange 474. Lower flange 474 connects to the forward facing surface of center wall 466/front wall 458 at its lower end and extends forward therefrom a distance before terminating in a free end 476. In the arrangement shown, as one example, lower flange 474 is a generally flat and square member that has a generally flat upper surface and a generally flat lower surface that extend in approximate parallel spaced relation to one another. The end 476 of lower flange 474 is configured to engage the interior surface 420 of a sidewall 410 of headbox 400 when the connection member 440 of bottom plate assembly 402 is engaged with a connection member 430 of headbox 400 when bottom plate assembly 402 is fully locked onto headbox 400. In this way, the combination of connection member 440 of bottom plate assembly 402 engaging the connection member 430 of headbox 400 and the free end 476 of lower flange 474 engaging the sidewall 410 of headbox 400 serves to securely lock bottom plate assembly 402 onto headbox 400 in a strong, accurate and durable manner.

Installation and Operation:

In one arrangement, as one example, headbox 400 is installed in a pocket in the ceiling adjacent one or more windows. Headbox 400 is typically installed by passing fasteners, such as screws or bolts or the like, through top wall 408 and/or one of the sidewalls 410 and into the structure thereby securing the headbox 400 in place. This arrangement is fast, easy and efficient to install as headbox 400 includes ample area to receive the installation of screws or bolts or other fasteners.

Once headbox 400 is installed roller shade assembly 114 may be quickly and easily installed into the hollow interior 424 of headbox 400 by conventional means. In one arrangement, installation of roller shade assembly 114 (or for that matter any form of a shade assembly) may be quickly and easily installed within headbox 400 as the shape and dimensions of headbox 400 are tightly controlled by the manufacturer and are specifically suited for a quick, easy and secure installation of roller shade assembly 114 (or other shade systems). In one arrangement, brackets 126 are installed within headbox 400 which then receive and hold roller shade assembly 114 within headbox 400. Once roller shade assembly 114 is installed within headbox 400, bottom plate assembly 402 is installed onto the lower end of headbox 400.

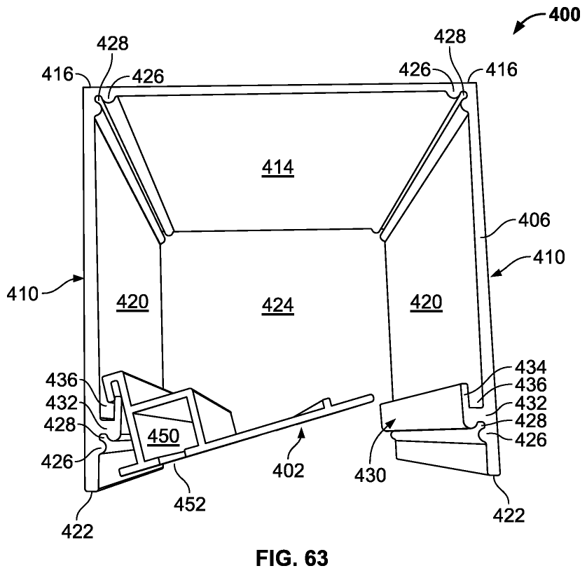

In one arrangement, to install bottom plate assembly 402 on headbox 400 the bottom plate assembly 402 is aligned with the open bottom end of headbox 400 in the proper orientation (either standard mount or reverse mount). Once bottom plate assembly 402 is aligned with the lower end of headbox 400 the second arm 470 of the connection member 440 of bottom plate assembly 402 is slid up and over the second arm 434 of the connection member 430 of headbox 400. In doing so, the upper end of the second arm 434 of the connection member 430 of headbox 400 is received within the groove 472 positioned between the rearward facing surface of second arm 470, the downward facing surface of first arm 468 and the forward facing surface of center wall 466 of connection member 440 of bottom plate assembly 402. Similarly, in doing so, the lower end of the second arm 470 of the connection member 440 of bottom plate assembly 402 is received within the groove 436 positioned between the exterior facing surface of second arm 434, the upper facing surface of first arm 432 and the interior surface 420 of sidewall 410 of headbox 400. To facilitate this insertion, in one arrangement, as is shown in FIG. 63, the rearward end 448 of bottom plate assembly 402 is raised upward or tilted upward slightly. This helps the second arm 470 fit within the groove 436 as well as help the second arm 434 fit within the groove 472.

Once second arm 470 of bottom plate assembly 402 is received within the groove 436 of headbox 400, and the second arm 434 of headbox 400 is received within the groove 472 of bottom plate assembly 402, the rearward end 448 of bottom plate assembly 402 is lowered or allowed to pivot upon the connection between the connection member 430 of headbox 400 with the connection member 440 of bottom plate assembly 402.

This downward rotation of the rearward end 448 of bottom plate assembly 402 is allowed to continue until the forward end 476 of the lower flange 474 of connection member 440 of bottom plate assembly 402 engages the interior surface 420 of sidewall 410 of headbox 400 adjacent its lower end. At this point the connection member 430 of headbox 400 is in full mating, locking and secure engagement with the connection member 440 of bottom plate assembly 402. This arrangement is shown in FIG. 58, as one example.

In this fully installed arrangement, the connection between headbox 400 and bottom plate assembly 402 is strong and durable due to the mechanical engagement between the connection member 430 of headbox 400 with the connection member 440 of bottom plate assembly 402. This engagement may be further strengthened by the addition of fasteners or other locking members that prevent the unintentional separation of the headbox 400 and bottom plate assembly 402.

In this fully installed arrangement, the plane formed by the lower surface 444 of bottom plate 438 as well as the lower surface of front lip 460 are in generally flat and flush and planar alignment with the lower edge 422 of sidewalls 410 of headbox 400. In many applications, the lower surface 444 of bottom plate 438 as well as the lower surface of front lip 460 are also positioned in a flat and flush and planar alignment with the lower surface of the ceiling or ceiling tile. In this way, the configuration of the headbox 400 with installed bottom plate assembly 402 provides a slick, low profile, barely noticeable and aesthetically pleasing arrangement that is strong, durable and easily to install and that can be additionally secured by the addition of locking members (such as screws or bolts) or the addition of end caps or the like. This arrangement also places the track 404 at the lower end of headbox 400.

Once bottom plate assembly 402 is installed on headbox 400, the track 404 may be used for the installation of drapery shade material 176 and/or a light assembly 302 as is described herein. That is, the teachings presented herein with respect to the installation and use of a drapery shade material 176 within a track apply equally to the disclosure of bottom plate assembly 402 having a track 404 therein. Similarly, the teachings presented herein with respect to the installation and use of a light assembly 302 within a track apply equally to the disclosure of bottom plate assembly 402 having a track 404 therein.

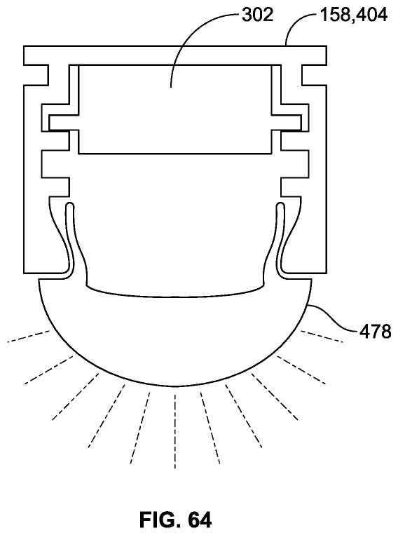

Lens: With reference to FIGS. 64-66 various embodiments of a track 158, 404 are presented that have a light assembly 302 therein and a lens 478 that is configured to direct the manner in which the light generated by the light assembly 302 exits the track 158, 404 and interacts with the surrounding environment. In one arrangement, when a light assembly 302 is used in track 158, 404, it may be desirable to focus the light generated from the light assembly 302 in various ways. To accomplish this, a lens 478 is used in association with light assembly 302 and track 158, 404.

In one arrangement, it may be desirable to have light generated from light assembly 302 focused or directed by lens 478 directly downward and onto the floor. In one arrangement, it may be desirable to have light generated from light assembly 302 focused or directed by lens 478 such that the light illuminates the roller shade material 114. In one arrangement, it may be desirable to have light generated from light assembly 302 focused or directed by lens 478 such that the light relatively evenly illuminates the length of the roller shade material 114. In one arrangement, it may be desirable to have light generated from light assembly 302 to be diffused by lens 478 such that the light illuminates the room in a non-focused manner. In one arrangement, it may be desirable to have light generated from light assembly 302 to be diffused by lens 478 such that the light illuminates the track 158, 404 and simply provides accent lighting.

In one arrangement, lens 478 is a separate component from light assembly 302 and is installed in slot 166, 452 of track 158, 404. In this arrangement, lens 478 is installed independently into track 158, 404 separate and apart from light assembly 302. In this arrangement, light assembly 302 may be slid into track 158, 404 from an open end of track 158, 404 and in this arrangement, lens 478 has a portion that is wider than slot 166, 452 and thereby is prevented from falling through slot 166, 452. In one arrangement, lens 478 may be fished through slot 166, 452 by turning lens 478 sideways at an angle and then inserting lens 478 into the hollow interior of track 158, 404 and then returning lens 478 to a horizontal alignment where the width of lens 478 is wider than slot 166, 452 and therefor lens 478 is retained within the hollow interior of track 158, 404. In one arrangement, lens 478 includes a feature that is sized and shaped to fit with close tolerances within slot 166, 452 with wider flanges positioned above slot 166, 452 which helps lock lens 478 into slot 166, 452 through the engagement of these mating features which provides a more-secure installation and precise alignment. In an alternative arrangement, lens 478 is snap-fitted and/or friction fitted into slot 166, 452 from below. In one arrangement, lens 478 is adhered, screwed, bolted, snapped or attached to slot 166, 452 and/or track 158, 404 by any other manner, method or means. In one arrangement, lens 478 extends all or a part of the length of track 158, 404 in a single continuous manner thereby providing an elegant, smooth and seamless aesthetically pleasing appearance.

In one arrangement, lens 478 is an integrated component with light assembly 302 and is installed in slot 166, 452 and/or track 158, 404 along with light assembly 302.

As one example, with reference to FIG. 64, one form of a lens 478 is presented. In this arrangement, lens 478 is installed within the slot 166, 452 of track 158, 404 below light assembly 302 and has a rounded exterior facing surface that protrudes outward and downward from slot 166, 452 in a generally semi-circular shape. When this lens 478 is clear, this lens 478 may be used to project light outward in all directions from track 158, 404 and providing partial illumination to the room. When this lens 478 is frosted, this lens 478 may be used to project diffused light outward as an accent light illuminating the track 158, 404 and providing partial illumination to the room.

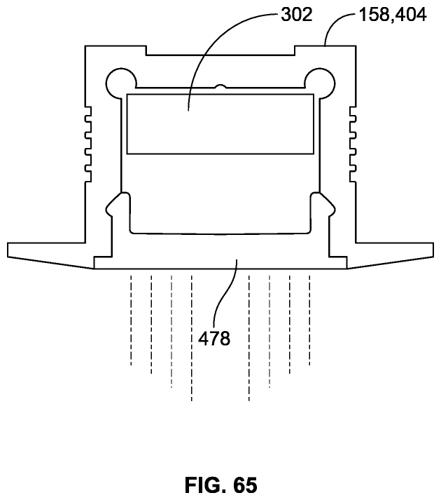

As one example, with reference to FIG. 65, one form of a lens 478 is presented. In this arrangement, lens 478 is installed within the slot 166, 452 of track 158, 404 below light assembly 302 and has a generally flat exterior facing surface that is generally flush with slot 166, 452. When this lens 478 is clear, this lens 478 may be used to project light downward from track 158, 404 and providing partial illumination to the floor below the track 158, 404. When this lens 478 is frosted, this lens 478 may be used to project diffused light downward as an accent light illuminating the track 158, 404 and providing partial illumination to the room. This arrangement may prevent glare that may be created by using the lens 478 presented in FIG. 64.

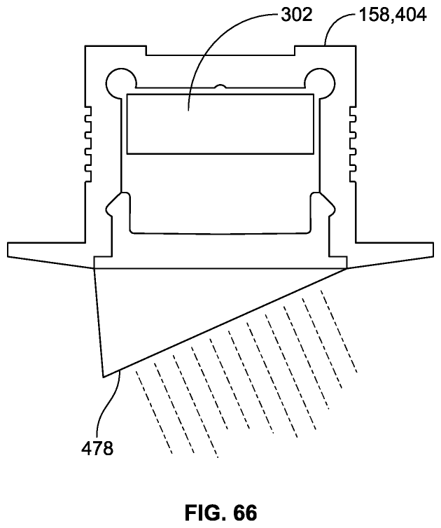

As one example, with reference to FIG. 66, one form of a lens 478 is presented. In this arrangement, lens 478 is installed within the slot 166, 452 of track 158, 404 below light assembly 302 and has a generally flat exterior facing surface that is directed toward the shade material 122. That is, in the arrangement shown, as one example, the lens 478 leans or angles or directs light toward one side. When this lens 478 is clear, this lens 478 may be used to project light downward and at an angle from track 158, 404 toward shade material 122 thereby illuminating the shade material 122. In some arrangements it may be desirable to have the exterior surface of lens 478 be curved, instead of straight, while still directing the light toward one side. In one arrangement, lens 478 is configured to generally evenly distribute light along the length and vertical height of shade material 122.

This arrangement, wherein lens 478 illuminates shade material 122 provides the benefit of providing an aesthetically pleasing look. This arrangement also provides the functional advantage of making it harder to see into a building or room when the room is illuminated. That is, many shade materials 122 are what are known as “solar screens” that allow some amount of light to pass through the shade material 122. This is desirable during the day as the shade material 122 allows some natural light into the room. However, this is undesirable at night because when the room is illuminated people outside the room can see through the shade material 122 and into the room.

Illuminating the shade material 122 using light assembly 302 as well as lens 478 helps reduce the ability to see into the room through the shade material 122 when the room is illuminated at night. This benefit occurs whether the shade material 122 is illuminated on the interior facing surface (which is the surface facing the room) or the exterior facing surface (which is the surface facing the window).

As such, illuminating the shade material 122 with a light assembly 302 and/or lens 478 provides both aesthetic benefits (it is beautiful), functional benefits (it provides illumination to a dark room), and safety and privacy benefits (it can help prevent others from seeing into the room from outside.

In one arrangement, lens 478 is smooth and clear and therefor transmits light in a relatively direct manner. In another arrangement, lens 478 is frosted, textured or otherwise modified such that lens 478 transmits light generated from light assembly 302 in a diffused manner. Whether smooth or diffused, lens 478 may be clear or white and in this arrangement lens 478 transmits the color of light generated by light assembly 302. Alternatively, lens 478 may be a color or pigment, such as, for example, red, orange, yellow, green, blue, indigo, violet or any other color or combination of colors and in this arrangement lens 478 provides a color to light generated from light assembly 302.

Reversible: One of the substantial benefits of headbox 400 and bottom plate assembly 402 is that the roller shade assembly 114 may be installed within headbox 400 in a standard mount configuration or a reverse mount configuration. Similarly, bottom plate assembly 402 may be installed onto headbox 400 in a standard mount configuration or a reverse mount configuration. This is accomplished as headbox 400 includes a connection member 430 on each sidewall 410, and as such headbox 400 is ambidextrous.

Standard mount configuration means that the shade material 122 rolls off of the roller tube 116 on the window side of the roller tube 116. This arrangement provides the advantage that there is minimal space between the shade material 122 and the window.

Reverse mount configuration means that the shade material 122 rolls off of the roller tube 116 on the room side of the roller tube 116. This arrangement provides the advantage of providing additional space between the shade material 122 and the window.

Bottom plate assembly 402 may be installed in either arrangement, standard mount configuration or a reverse mount configuration depending on how the roller shade assembly 114 is installed. This allows the illumination of the room-side of the shade material 122 in a standard mount configuration. This allows the illumination of the window-side of the shade material 122 in a reverse mount configuration.

Illuminating the window-side of the shade material 122 in a reverse mount configuration provides enhanced privacy and safety benefits as illuminating the exterior of the shade material 122 prevents or reduces the ability of persons from outside the room to look into the room from outside. This also provides an aesthetically pleasing and unique look to the house or building from outside. This also provides an aesthetically pleasing and unique look to occupants within the room as the shade material 122 is indeed illuminated, however as the exterior of the shade material 122 is illuminated the illumination within the room is somewhat attenuated, but it still provides a unique aesthetic appearance.

Illuminating the room-side of the shade material 122 in a standard mount configuration provides also provides enhanced privacy and safety benefits as illuminating the interior of the shade material 122 prevents or reduces the ability of persons from outside the room to look into the room from outside. This also provides an aesthetically pleasing and unique look to the room from the inside of the room. This also provides an aesthetically pleasing and unique look to persons outside the room as the shade material 122 is indeed illuminated, however as the interior of the shade material 122 is illuminated the illumination outside the room is somewhat attenuated, but it still provides a unique aesthetic appearance and can help to prevent seeing into the room through the shade material 122.

From the above discussion it will be appreciated that the roller shade and drapery window shade system 10, 100 and related method of use, presented herein improves upon the state of the art.

Specifically, the roller shade and drapery window shade system presented: provides improved functionality over prior art systems; provides improved features over prior art systems; improves upon the prior art; provides the benefits of a roller shade; provide a window shade system that does not suffer from the disadvantages of a roller shade; provides the benefits of a drapery; provide a window shade system that does not suffer from the disadvantages of a drapery; combines the benefits of a roller shade and a drapery; that eliminates the deficiencies of roller shades and draperies; that is easy to install; that is easy to use; that that is simple to install; that is simple to use; that is relatively inexpensive; that can be used with practically any roller shade; that can be used with practically any brackets; that can be used with practically any window; that is aesthetically pleasing; that provides improved functionality; that facilitates the selection of optimum shade material for use with the window shade system; that has a small and unobtrusive stature when installed; that has a sleek appearance; that is safe to use; that allows for use of a drapery with a roller shade but does not require use of a drapery with a roller shade; that allows for use of a roller shade with a drapery but does not require use of a roller shade with a drapery;

that can be used to modify existing roller shades to include add a drapery; that efficiently allows for the use of a sheer material as well as an opaque material in a single window shade system; that is intuitive to use; that strong and robust; that can be used in many applications; that provides unique functionality; that saves time; that is pleasing to use; that has a compact size; that can be used in any length; that can be used in any height; that has a long useful life; that is high quality; that can be used with practically any shade material; that eliminates the need to install two separate window shades, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A window shade system, comprising:
a first roller shade assembly;
the first roller shade assembly comprising:
a tube;
the tube extending a length between a first end and a second end;
the tube having a generally cylindrical cross sectional shape;
roller shade material operatively connected to the tube;
a fascia;
the first roller shade assembly operably connected to the fascia;
the fascia extending a length between a first end and a second end;
the fascia having a front plate and a bottom plate;
a track;
the track having a hollow interior positioned in the fascia and extending a length of the fascia from the first end to the second end;
a slot positioned in a lower side of the track;
a first plurality of carriers;
the first plurality of carriers positioned in the track of the fascia;
a first drapery shade material operatively connected to the first plurality of carriers;
wherein when the tube of the first roller shade assembly is rotated in a first rotational direction the roller shade material of the first roller shade assembly wraps around the tube thereby opening the roller shade material;
wherein when the tube of the first roller shade assembly is rotated in a second rotational direction, which is opposite the first rotational direction, the roller shade material of the first roller shade assembly unwraps around the tube thereby closing the roller shade material;
wherein the first drapery shade material is closed by sliding the plurality of carriers in the track in a first lateral direction along a length of the fascia;
wherein the first drapery shade material is opened by sliding the plurality of couplers in the track in a second lateral direction, opposite the first lateral direction, along a length of the fascia.

2. The system of claim 1, wherein the track extends the entire length of the fascia from the first end to the second end in a continuous and uninterrupted manner.

3. The system of claim 1, wherein when viewed from the side, the track has a generally square or rectangular shape with the slot positioned approximately in the middle of the lower side of the track.

4. The system of claim 1, wherein the first plurality of carriers include:
a roller assembly;
an arm; and
a connector;
wherein the roller assembly of the plurality of carriers are positioned within the track of the fascia;
wherein the arm of the plurality of carriers extend through the slot positioned in the lower side of the track of the fascia;
wherein the connector of the plurality of carriers operatively connects to the drapery shade material.

5. The system of claim 1, further comprising a second drapery shade material operatively connected a second plurality of carriers positioned in the track.

6. The system of claim 1, wherein the front plate and the bottom plate are approximately perpendicularly aligned to one another.

7. The system of claim 1, wherein the front plate has a generally flat front surface and the bottom plate has a generally flat bottom surface.

8. The system of claim 1, wherein the front plate and bottom plate are joined together at the track which is positioned at the intersection of the front plate and the bottom plate.

9. The system of claim 1, wherein the track is positioned at a lower end of the front plate and at a forward end of the bottom plate.

10. The system of claim 1, further comprising a second roller shade assembly operatively connected to the fascia.

11. A window shade system, comprising:
a first roller shade assembly;
the first roller shade assembly having a tube and roller shade material operatively connected to the tube;
a first bracket;
a second bracket;
a fascia;
wherein the first roller shade assembly operatively connects to the fascia;
the fascia having a front plate and a bottom plate;
a track;
the track positioned in the fascia adjacent a forward lower section of the fascia;
wherein the fascia operatively connects to the first bracket and the second bracket;
a first drapery shade material operatively connected to the track;
wherein the roller shade material of the first roller shade assembly is opened by rotating the tube in a first rotational direction and is closed by rotating the tube in a second rotational direction, opposite the first rotational direction;
wherein the first drapery shade material is opened by sliding the first drapery shade material in a first lateral direction along the track and is closed by sliding first drapery shade material in a second lateral direction along the track, opposite to the first lateral direction.

12. The system of claim 11, wherein the track extends the entire length of the fascia from a first end to a second end in a continuous and uninterrupted manner.

13. The system of claim 11, wherein when viewed from the side, the track has a generally square or rectangular shape with a slot positioned approximately in the middle of a lower side of the track.

14. The system of claim 11, wherein the first drapery shade material is operably connected to a first plurality of carriers positioned in the track.

15. The system of claim 11, wherein the fascia is operatively connected at its first end to the first bracket.

16. The system of claim 11, wherein the fascia is operatively connected at its second end to the second bracket.

17. The system of claim 11, further comprising a second drapery shade material operatively connected a second plurality of carriers positioned in the track.

18. The system of claim 11, wherein the front plate and the bottom plate of the fascia are approximately perpendicularly aligned to one another.

19. The system of claim 11, wherein the front plate has a generally flat front surface and the bottom plate has a generally flat bottom surface.

20. The system of claim 11, wherein the front plate and bottom plate are joined together at an intersection, wherein the track is positioned at the intersection of the front plate and the bottom plate.

21. The system of claim 11, herein the fascia has a front plate and a bottom plate, wherein the track is positioned at a lower end of the front plate and at a forward end of the bottom plate.

22. An illuminating fascia system, comprising:
a fascia;
the fascia extending a length between a first end and a second end;
a track positioned in the fascia;
the track extending a length between a first end and a second end;
the track having a hollow interior;
the track having a slot positioned in a lower side of the track;
wherein the slot provides access to the hollow interior of the track;
a light assembly positioned within the hollow interior of the track;
a power source electrically connected to the light assembly;
wherein when power from the power source is applied to the light assembly positioned within the track, light generated by the light assembly shines through the slot in the track and out of the fascia thereby illuminating an area below the fascia.

23. The system of claim 22, wherein the light assembly is formed of a plurality of lights.

24. The system of claim 22, wherein the light assembly is formed of a strip of lights.

25. The system of claim 22, wherein the light assembly is formed of a strip of lights that is adhered to the fascia within the hollow interior of the track.

26. The system of claim 22, the fascia having a front plate, wherein the front plate extends in a generally vertical manner.

27. The system of claim 22, the fascia having a bottom plate, wherein the bottom plate extends in a generally horizontal manner.

28. The system of claim 22, the fascia having a front plate, wherein the front plate extends in a generally vertical manner, wherein the track is positioned adjacent a lower end of the front plate.

29. The system of claim 22, the fascia having a bottom plate, wherein the bottom plate extends in a generally horizontal manner, wherein the track is positioned adjacent a forward end of bottom plate.

30. The system of claim 22, the fascia having a front plate and a bottom plate, wherein the front plate extends in a generally vertical manner, wherein the bottom plate extends in a generally horizontal manner.

31. The system of claim 22, the fascia having a front plate and a bottom plate, wherein the front plate extends in a generally vertical manner, wherein the bottom plate extends in a generally horizontal manner, wherein the front plate and the bottom plate connect to one another at an intersection , wherein the track is positioned at the intersection of the front plate and the bottom plate.

32. The system of claim 22, the fascia having a front plate and a bottom plate, wherein the front plate extends in a generally vertical manner, wherein the bottom plate extends in a generally horizontal manner, wherein the track is positioned at an intersection of the front plate and the bottom plate, wherein the front plate is generally flat, wherein the bottom plate is generally flat, wherein the front plate and the bottom plate extend in approximate perpendicular alignment to one another.

33. The system of claim 22, further comprising a pair of brackets connected to the fascia.

34. The system of claim 22, further comprising a pair of brackets connected to the fascia and a shade assembly connected to the brackets.

35. The system of claim 22, further comprising a pair of brackets connected to the fascia and a roller shade assembly connected to the brackets.

36. The system of claim 22, further comprising a first plurality of carriers positioned at least partially within the hollow interior of the track.

37. The system of claim 22, further comprising a first plurality of carriers positioned at least partially within the hollow interior of the track, wherein the first plurality of carriers are positioned below the light assembly such that the light shines down through the first plurality of carriers.

38. The system of claim 22, further comprising a first plurality of carriers positioned at least partially within the hollow interior of the track, a first drapery shade material operatively connected to the first plurality of carriers, wherein the first shade material and the first plurality of carriers are configured to move along a length of the track between an open position and a closed position.

39. The system of claim 22, wherein the track is generally square or rectangular in shape when viewed from the first end or second end of the fascia.

40. The system of claim 22, wherein the track is generally square or rectangular in shape when viewed from the first end or second end of the fascia, and wherein the light assembly is connected to an upper surface of the hollow interior of the track.

41. A fascia system, comprising:
a headbox;
a shade assembly positioned within the headbox;
a bottom plate assembly connected to the headbox;
wherein the bottom plate assembly includes a track therein.

42. The system of claim 41, wherein the bottom plate assembly is connected to the headbox in a removable manner.

43. The system of claim 41, further comprising drapery shade material operably connected to the track.

44. The system of claim 41, further comprising a light assembly positioned within the track.

45. The system of claim 41, further comprising a lens positioned within the track.

46. The system of claim 41, wherein the bottom plate assembly is configured to be used in a standard mount arrangement as well as a reverse mount arrangement.

47. The system of claim 41, wherein the bottom plate assembly includes a connection member that connects to a connection member of the headbox.

48. The system of claim 41, further comprising a roller shade assembly operably connected to the headbox.
